(19) United States
(12) Patent Application Publication
(10) Pub. No.: US 2013/0246650 A1
(43) Pub. Date: Sep. 19, 2013

(54) COMPUTER SYSTEM AND FRAME TRANSFER BANDWIDTH OPTIMIZATION METHOD

(71) Applicants: Masanao Tsuboki, Oiso (JP); Takashi Chikusa, Odawara (JP); Hiroshi Kuwabara, Fujisawa (JP); Youichi Gotoh, Yokohama (JP)

(72) Inventors: Masanao Tsuboki, Oiso (JP); Takashi Chikusa, Odawara (JP); Hiroshi Kuwabara, Fujisawa (JP); Youichi Gotoh, Yokohama (JP)

(73) Assignee: HITACHI, LTD., Tokyo (JP)

(21) Appl. No.: 13/497,384

(22) PCT Filed: Mar. 13, 2012
(86) PCT No.: PCT/JP2012/001745

§ 371 Date: Mar. 21, 2012

(51) Int. Cl. G06F 15/16

(52) U.S. Cl. 709/236

(57) ABSTRACT

A computer system and frame transfer bandwidth optimization method capable of data transfer bandwidth control on a logical unit basis and according to the relevant storage tier in a storage apparatus are suggested.

When encapsulating a first frame, in which transfer target data is stored, in a second frame and sending or receiving it between first and second nodes, the number of frames, that is, the number of a multiplicity of first frames to be stored in one second frame, is determined in advance for each storage tier or logical unit defined within a storage apparatus; and the multiplicity of first frames as many as the number of frames that is set in advance to a logical unit, which is a write destination or read destination of the relevant data, or a storage tier to which the relevant logical unit belongs, are stored in the second frame and sent to the other end of a communication link.

### TECHNICAL FIELD

The present invention relates to a computer system and a method of frame transfer bandwidth optimization and is suited for use in, for example, a computer system for which an FCoE (Fibre Channel over Ethernet (registered trademark)) technique is adopted.

### BACKGROUND ART

In recent years, a communication protocol called the FCoE has been drawing public attention as one of data transfer methods. The FCoE is a data transfer method for encapsulating a frame according to the Fibre Channel standards (hereinafter referred to as the FC [Fibre Channel] frame) and transferring it via the Converged Enhanced Ethernet (CEE) (registered trademark).

According to the Fibre Channel standards, unlike a best effort type such as an IP (Internet Protocol) network, a flow control mechanism that will not cause frame loss is provided and a high-speed and low-delay “lossless” network environment is realized.

The FCoE adopts a communication method called CEE (Converged Enhanced Ethernet) in order to realize such a “lossless” environment on the Ethernet (registered trademark). The CEE is a next-generation network that expands the existing Ethernet (registered trademark) by particularly imagining the use at a data center. And some new technologies such as PFC (Priority-based Flow Control), ETS (Enhanced Transmission Selection), CN (Congestion Notification), DCBX (Data Center Bridging eXchange), and TRILL (TRansparent Interconnection of Lots of Links) are adopted for this CEE.

### CITATION LIST

### Patent Literature

PTL 1: Japanese Patent Application Laid-Open (Kokai) Publication No. 2006-339790
PTL 2: Japanese Patent No. 4629494

### SUMMARY OF INVENTION

### Technical Problem

Meanwhile, for example, data of various protocols such as IP-based iSCSI (internet Small Computer System Interface), VoIP (Voice over Internet Protocol), and NFS (Network File System) are transferred over a physical network and part of such data is read from, and/or written to, a storage apparatus at a data center where fabric is constructed.

On the other hand, in some case, data stored in the storage apparatus is controlled so that the data is appropriately placed in storage tiers which are classified by performance and cost in accordance with, for example, the importance and access frequency of the data. Examples of the storage tiers in descending order starting from a high-level tier include a tier composed of a group of semiconductor disk devices (SSDs [Solid State Drives]), a tier composed of a group of high-speed SAS (Serial Attached SCSI) disk devices, and a tier composed of a group of low-speed, but large-capacity SATA (Serial ATA) disk devices or NL SAS (Near-Line SAS) disk devices. In addition, a tier composed of tape media for the backup or archival use may be sometimes provided.

With the storage apparatus to which the storage tiers are applied in this manner, high-speed and expensive storage media are placed in the high-level tiers and low-speed and inexpensive storage media are placed in the low-level tiers. Such placement of the storage media has a great advantage of enabling an owner of the storage apparatus to minimize deployment cost. Furthermore, data in the high-level tiers needs a broadband for data transfer, but data in the low-level tiers does not need such wide bandwidth.

Since the above-mentioned ETS and PFC only have protocol-based granularity at minimum, the same bandwidth will be allocated to data of logical volumes for high transactions, and data of logical volumes for archival use. That is because both of data access use the same FCoE protocol. As a result, excessive resources (e.g. high bandwidth) are assigned to the logical units for the archival use.

Furthermore, as a result of integration of an IP-SAN according to iSCSI and an FC-SAN, which have conventionally been different networks, by means of the CEE, the data transfer bandwidth will be shared. Regarding the ETS, a maximum of 8+1 (=9) priority groups (PG) can be defined (priority group IDs 0 to 7 and a priority group ID 15 are for exclusive use for the IPC).

However, the absolute number of priority groups for the ETS is small as mentioned above, it is assumed that protocols for the SAN, which are block-access protocols like iSCSI and FCoE, are put together in the same priority group in the actual operation. If both frames have the same weight in the vicinity of an upper limit of a physical bandwidth, they will be sent cyclically (alternately) by a weighted round robin method.

Conventionally, regarding the iSCSI, the size of a packet (for example, 9 [Kbytes]) can be expanded by using a jumbo frame. On the other hand, regarding the FCoE, the size of an FC frame is only 2140 [Bytes] at maximum (2112 [Bytes] excluding, for example, a frame header). So, if the frames are sent alternately, the iSCSI can use the bandwidth four times as wide as the bandwidth for the FCoE. Such unbalance of consumption bandwidth will cause difficulties in system designing.

As a result of the integration of the two SANs, which have been conventionally different, into one new network as described above, a new problem that has not occurred conventionally occurs.

The present invention was devised in consideration of the above-described circumstances and aims at suggesting a computer system and frame transfer bandwidth optimization method capable of data transfer bandwidth control on a logical unit basis and according to the relevant storage tier.

### Solution to Problem

In order to solve the above-described problem, a computer system with first and second nodes connected via a network, for sending and/or receiving data to be read and/or written to a logical unit in a storage apparatus between the first and second nodes is provided according to the present invention. The first and second nodes include: an encapsulation unit for encapsulating a first frame, in which transfer target data is stored, in accordance with a first protocol in a second frame in accordance with a second protocol; a transmitter for sending the second frame, in which the first frame is encapsulated by the encapsulation unit, to the second or first node, which is the other end of a communication link, by a communication method in accordance with the second protocol; and a de-encapsulation unit for extracting the first frame from the second frame sent from the second or first node which is the other end of the communication link. The number of frames, that is, the number of multiple first frames, which should be comprised in one second frame, is determined in advance for each storage tier or logical unit defined in the storage apparatus. The encapsulation unit encapsulates the multiple first frames as many as the number of frames set in advance to the logical unit, which is a write destination or read destination of the data, or the storage tier to which the logical unit belongs, in the second frame. The de-encapsulation unit extracts all the multiple stored first frames from the second frame when the plurality of the first frames are comprised in the received second frame.

Furthermore, a method of frame transfer bandwidth optimization for a computer system with first and second nodes connected via a network, for sending and/or receiving data to be read and/or written to a logical unit in a storage apparatus between the first and second nodes is provided according to the present invention. The frame transfer bandwidth optimization method includes: a first step executed at the first or second node encapsulating a first frame, in which transfer target data is stored, in accordance with a first protocol in a second frame in accordance with a second protocol; a second step executed at the first or second node sending the second frame, in which the first frame is encapsulated, to the second or first node, which is the other end of a communication link, by a communication method in accordance with the second protocol; and a third step executed at the first or second node extracting the first frame from the second frame sent from the second or first node which is the other end of the communication link. The number of frames, that is, the number of multiple first frames, which should be comprised in one second frame, is determined in advance for each storage tier or logical unit defined in the storage apparatus. In the first step, the first or second node encapsulates the multiple first frames as many as the number of frames set in advance to the logical unit, which is a write destination or read destination of the data, or the storage tier to which the logical unit belongs, in the second frame. In the third step, the first or second node extracts all the multiple encapsulated first frames from the second frame when the plurality of the first frames are comprised in the second frame.

### Advantageous Effects of Invention

Since a multiplicity of first frames as many as the number of frames, which is determined in advance for each storage tier or logical unit, are encapsulated and sent in one second frame according to the present invention, the data transfer bandwidth control on a logical unit basis or according to the relevant storage tier can be performed.

### BRIEF DESCRIPTION OF DRAWINGS

FIG. 1 is a block diagram showing an overall configuration of a computer system according to a first embodiment.

FIG. 2 is a block diagram showing a schematic configuration of a host system.

FIG. 3 is a block diagram showing a schematic configuration of a CNA for the host system according to the first embodiment.

FIG. 4A is a front view showing an appearance configuration of a storage apparatus.

FIG. 4B is an exploded perspective view showing a schematic configuration of a basic chassis and an additional chassis.

FIG. 5 is a block diagram showing a logical configuration of the storage apparatus.

FIG. 6 is a conceptual diagram for explaining the ETS.

FIG. 7 is a conceptual diagram for explaining the ETS.

FIG. 8 is a conceptual diagram for explaining multiple frames encapsulation processing according to this embodiment.

FIG. 9(A) is a conceptual diagram showing a frame format of a conventional FCoE frame and FIG. 9(B) is a conceptual diagram showing a frame format of a conventional FC frame.

FIG. 10 is a conceptual diagram showing a frame format of a multiple frames encapsulated FCoE frame according to this embodiment.

FIG. 11 is a conceptual diagram showing the configuration of a logical unit and storage tier association management table.

FIG. 12 is a flowchart illustrating a processing sequence for management table creation processing.

FIG. 13 is a flowchart illustrating a processing sequence for write processing of a SCSI protocol processing unit.

FIG. 14 is a flowchart illustrating a processing sequence for write processing of an FC protocol processing unit.

FIG. 15 is a flowchart illustrating a processing sequence for write processing of a CNA-side FCoE protocol processing unit.

FIG. 16 is a flowchart illustrating a processing sequence for read processing of the SCSI protocol processing unit.

FIG. 17 is a flowchart illustrating a processing sequence for read processing of the FC protocol processing unit.

FIG. 18 is a flowchart illustrating a processing sequence for read processing of the CNA-side FCoE protocol processing unit.

FIG. 19 is a schematic line diagram showing components on a screen example for a DCBX parameter display screen on a storage device management screen.

FIG. 20 is a schematic line diagram showing components on a screen example for a number-of-stacking-frames-setting screen on the storage device management screen.

FIG. 21A is a flowchart illustrating a processing sequence for write processing executed by a channel adapter for the storage apparatus according to the first embodiment.

FIG. 21B is a flowchart illustrating a processing sequence for write processing executed by the channel adapter for the storage apparatus according to the first embodiment.

FIG. 22 is a flowchart illustrating a processing sequence for read processing executed by the channel adapter in the storage apparatus according to the first embodiment.

FIG. 23 is a conceptual diagram for explaining frame transmission order priority control.

FIG. 24 is a conceptual diagram for explaining the frame transmission order priority control.

FIG. 25 is a conceptual diagram for explaining the frame transmission order priority control.

FIG. 26 is a conceptual diagram for explaining the relationship between a multiple frame encapsulation function and a virtual logical unit according to this embodiment.

FIG. 27(A) is a conceptual diagram showing the structure of a target logical unit management table and FIG. 27(B) is a conceptual diagram showing the structure of a logical unit group management table.

FIG. 28 is a conceptual diagram for explaining an application example of the first embodiment.

FIG. 29 is a block diagram showing a schematic configuration of a computer system according to a second embodiment.

FIG. 30 is a block diagram showing the configuration of a storage-side FCoE switch according to the second embodiment.

FIG. 31 is a conceptual diagram showing the structure of a logical unit group management table.

FIG. 32 is a schematic line diagram showing a configuration example for a management table setting screen on a storage device management screen.

FIG. 33(A) is a conceptual diagram showing a schematic configuration of a general FC frame header and FIG. 33(B) is a conceptual diagram showing a schematic configuration of a general FCP command (FCP_CMND) frame payload.

FIG. 34 is a flowchart illustrating a processing sequence for read processing on the host side.

FIG. 35 is a flowchart illustrating a processing sequence for frame reception processing.

FIG. 36 is a flowchart illustrating a processing sequence for reception port monitoring processing.

FIG. 37 is a flowchart illustrating a processing sequence for read processing on the storage apparatus side.

FIG. 38 is a flowchart illustrating a processing sequence for write processing on the switch side.

FIG. 39 is a conceptual diagram for explaining frame transmission order priority control in the computer system according to the second embodiment.

FIG. 40 is a block diagram showing a schematic configuration of a computer system according to a third embodiment.

FIG. 41 is a conceptual diagram for explaining a multiple frame encapsulation function according to the third embodiment.

FIG. 42 is a conceptual diagram showing a schematic configuration of a general FC frame header.

FIG. 43 is a block diagram showing the configuration of a storage-side FCoE switch according to the third embodiment.

FIG. 44 is a flowchart illustrating a processing sequence for multiple frame encapsulation process according to the third embodiment.

FIG. 45 is a block diagram showing a schematic configuration of a computer system according to a fourth embodiment.

FIG. 46 is a block diagram showing a schematic configuration of a CNA for a host system according to the fourth embodiment.

FIG. 47 is a block diagram showing the configuration of a host-side FCoE switch according to the fourth embodiment.

FIG. 48 is a flowchart illustrating a processing sequence for multiple frame encapsulation process according to the fourth embodiment.

FIG. 49 is a conceptual diagram for explaining a congestion control method according to this embodiment.

FIG. 50 is a conceptual diagram showing the structure of a frame control management table.

FIG. 51 is a flowchart illustrating a processing sequence for first frame control processing.

FIG. 52 is a flowchart illustrating a processing sequence for second frame control processing.

FIG. 53 is a characteristic diagram showing simulation results when the first and second frame control processing is executed.

FIG. 54 is a conceptual diagram for explaining a frame protection function.

FIG. 55 is a conceptual diagram showing the structure of frame protection information.

FIG. 56 is a conceptual diagram for explaining the frame protection function.

FIG. 57 is a conceptual diagram for explaining the frame protection function.

FIG. 58 is a conceptual diagram for explaining the frame protection function.

FIG. 59 is a conceptual diagram for explaining an application example for a fifth embodiment.

### DESCRIPTION OF EMBODIMENTS

One embodiment of the present invention will be explained in detail with reference to the attached drawings.

### (1) First Embodiment

### (1-1) Configuration of Computer System According to this Embodiment

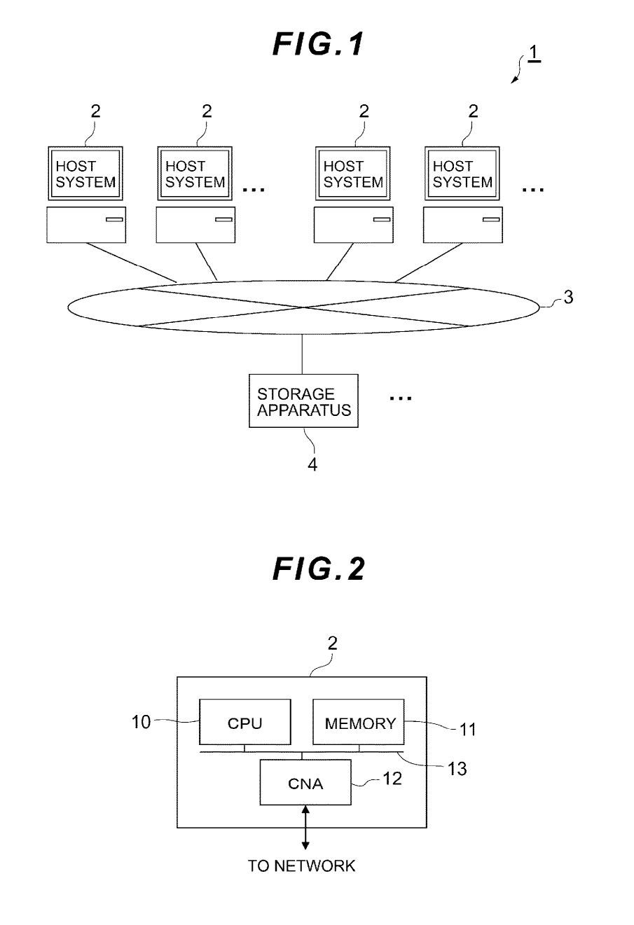

Referring to FIG. 1, the reference numeral 1 represents a computer system according to a first embodiment as generally. This computer system 1 includes nodes such as a plurality of host systems 2 and a storage apparatus 4 that communicate with each other by a communication method in accordance with an FCoE protocol or an iSCSI protocol; and the computer system is configured so that these pluralities of host systems 2 and the storage apparatus 4 are connected via a network 3.

The host system 2 is composed of, for example, a computer device such as a personal computer, workstation, or mainframe and is equipped with information resources such as a CPU (Central Processing Unit) 10, a memory 11, and a CNA (Converged Network Adapter) 12 as shown in FIG. 2 and the respective resources are connected via a system bus 13.

The CPU 10 is a processor for controlling the operation of the entire host system 2. Furthermore, the memory 11 is composed of, for example, a volatile or nonvolatile memory such as a DDR SDRAM (Double-Data-Rate Synchronous Dynamic Random Access Memory) and is used to retain programs and data and is also used as a work memory for the CPU 10. Various processing described later is executed as the entire host system 2 by the CPU 10 executing the programs stored in the memory 11.

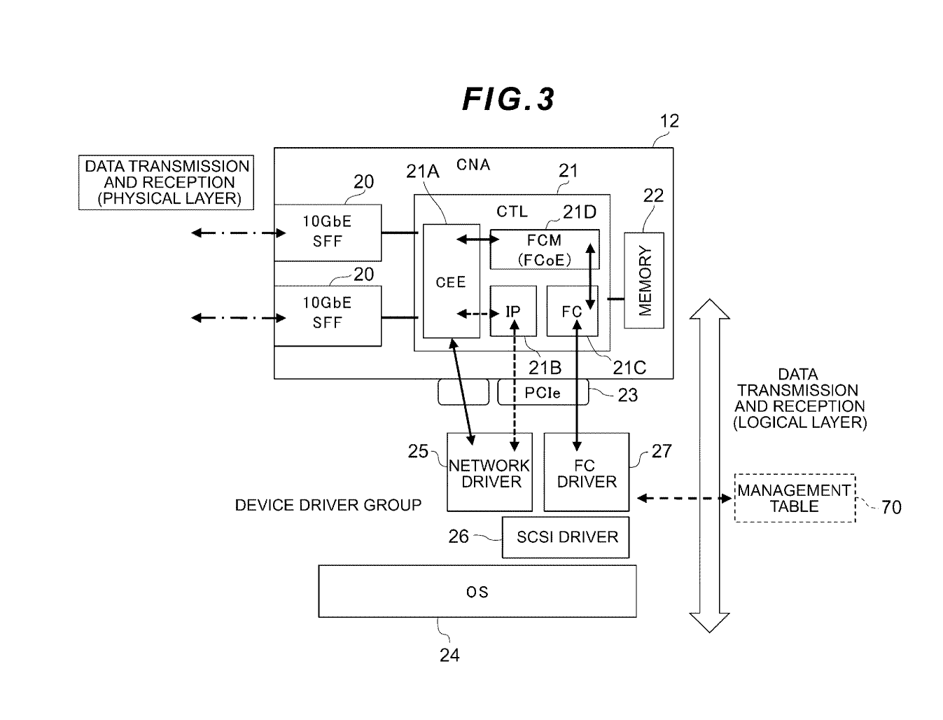

The CNA 12 is a network adapter in conformity with the CEE adopted as the communication method between the host systems 2 and the storage apparatus 4. The CNA 12 includes, as shown in FIG. 3, one or more optical transceivers 20 in conformity with 10 GbE SFF (10 Gigabit Ethernet [registered trademark] Small Form Factor) standards, a CNA controller 21 for controlling the operation of the entire CNA 12, a memory 22 used as a work memory for the CNA controller 21, and a PCIe interface 23 in conformity with PCIe (Peripheral Components Interconnect buss Express) standards. Then, the CNA controller 21 includes a plurality of protocol processing units 21A to 21C, each of which processes a main protocol such as CEE, IP, or FC, and an FCM protocol processing unit (Fibre Channel Mapper) 21D for executing processing for, for example, encapsulating/de-encapsulating an FC frame in/from an Ethernet (registered trademark) frame (FCoE frame).

Each protocol processing unit 21A to 21C has a function communicating with a corresponding device driver among device drives such as a network driver 25, a SCSI driver 26, and an FC driver 27, which are mounted in an OS (Operating System) 24, via the PCIe interface 23 and performing protocol control when communicating with the storage apparatus 4 via the optical transceiver 20 in response to requests from these device drivers.

Furthermore, the FCM protocol processing unit 21D has a multiple frame encapsulation function encapsulating/de-encapsulating not only one FC frame, but also a plurality of FC frames as one FCoE frame as the need arises. Multiple frame encapsulation processing described later is executed by the multiple frame encapsulation function of the FCM protocol processing unit 21D as the CNA controller 21 as a whole.

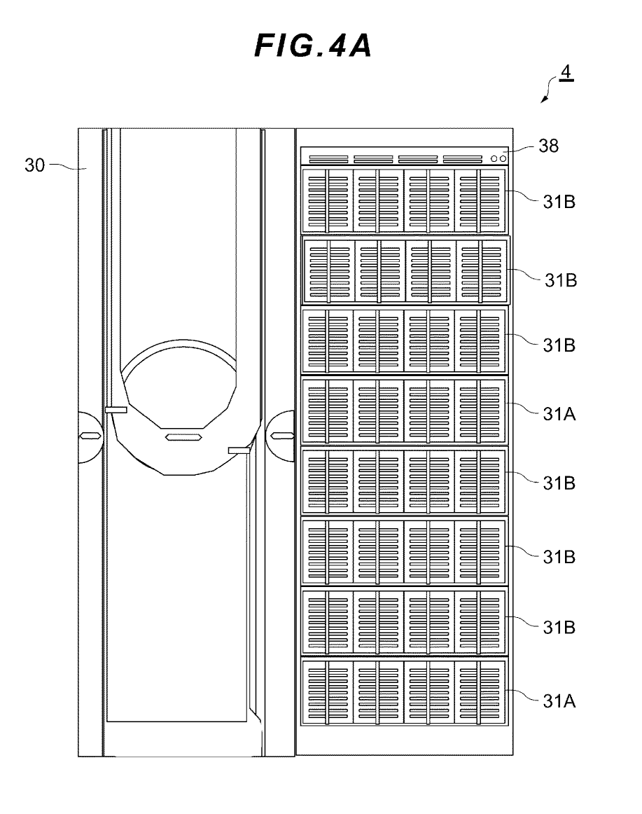

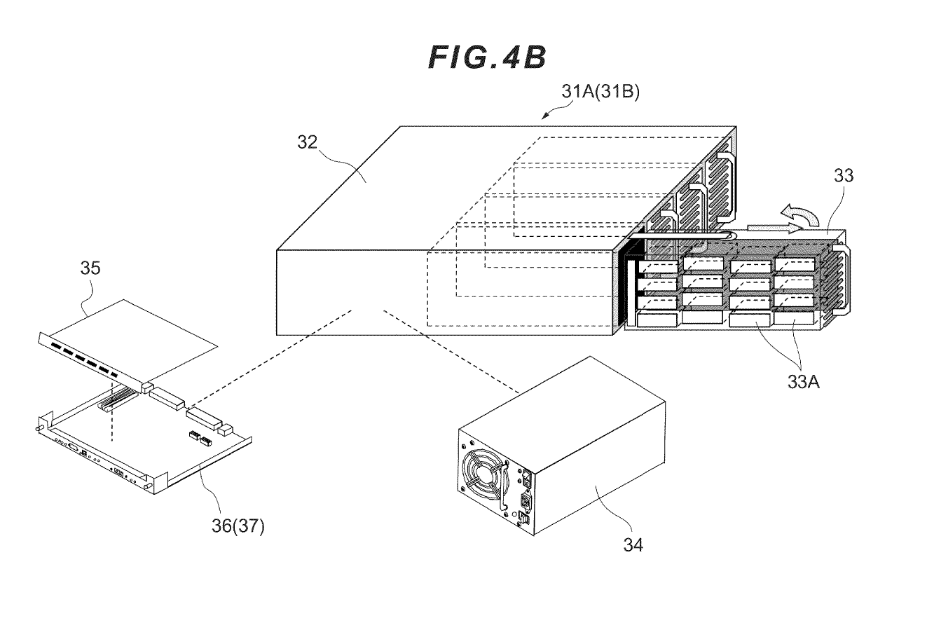

The storage apparatus 4 is configured as shown in FIG. 4A so that two basic chassis 31A and a plurality of additional chassis 31B are placed inside a frame 30 of a specified structure.

Each basic chassis 31A or each additional chassis 31B is configured as shown in FIG. 4B so that a plurality of storage device units 33 are put into a chassis frame 32, which is formed in a tubular and rectangular parallelepiped shape, from its front side; and an AC/DC power supply unit 34, an I/O port card 35 for the front-end and back-end, and a controller module 36 (basic chassis 31A) or an I/O module 37 (additional chassis 31B) are put into the chassis frame 32 from its back side. Inside the chassis frame 32, a midplane board (not shown) on which a plurality of first connects of a specified structure are provided is placed perpendicularly to the depth direction of the chassis frame 32.

Each storage device unit 33 is a unit in which a plurality of expensive storage devices such as SSD or SAS disks or inexpensive storage disks 33A such as SATA (Serial AT Attachment) disks are mounted; and a second connector (not shown) of the storage device unit 33 provided on its back side can be made to engage with the first connector of the midplane board in the chassis frame 32 by fitting the storage device unit 33 into the chassis frame 32 from its front side, so that the storage device unit 33 can be electrically and physically integrated with the midplane board.

Furthermore, the AC/DC power supply unit 34 converts input AC power into DC power of a specified voltage and supplies it via the midplane board to each storage device unit 33, the I/O port card 35, and the controller module 36 (basic chassis 31A) or the I/O module 37 (additional chassis 31B).

The I/O port card 35 is an interface card for providing physical front-end and back-end ports (ports of respective channel adapters 42A, 42B and disk adapters 48A, 48B for controllers 40A, 40B described later). Each port provided by this I/O port card 35 is connected via a cable to an FCoE switch 38 (FIG. 4A) described later.

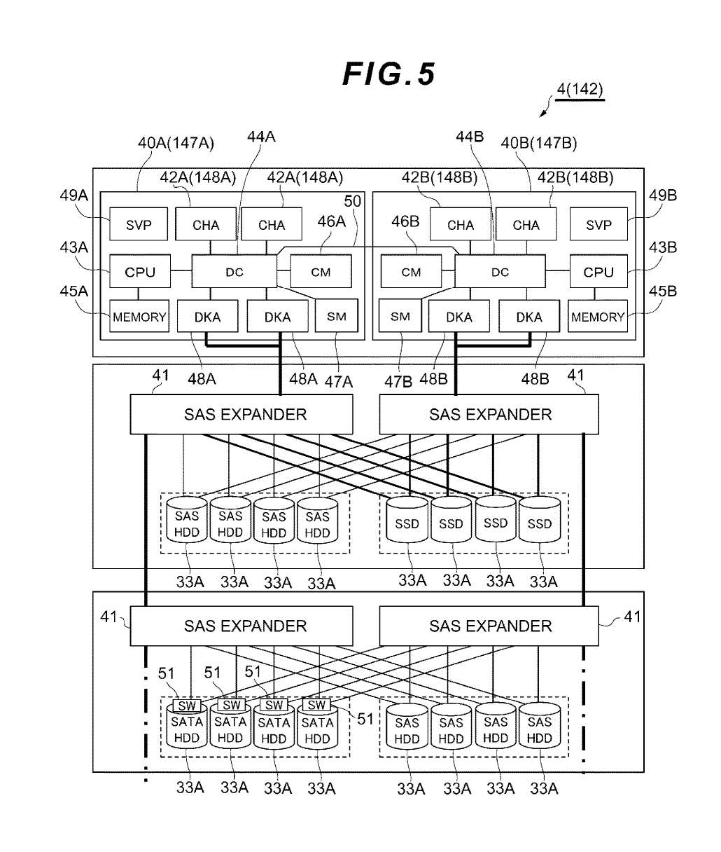

The controller module 36 has a function controlling input/output of data to/from the storage devices 33A in each storage device unit 33 connected via the midplane board. Each basic chassis 31A contains one controller module 36. With each of these controller modules 36, a system-0 controller 40A or system-1 controller 40B described later with reference to FIG. 5 is formed. The details of these controllers 40A, 40B will be explained later. Furthermore, the I/O module 37 is an expander device for destributing write commands and read commands issued from the controller module 36 to the relevant storage device 33A and a SAS expander 41 explained later with reference to FIG. 5 corresponds to the expander.

Incidentally, the FCoE switch 38 is also placed in the frame 30 (FIG. 4A) of the storage apparatus 4. The FCoE switch 38 is a network switch having a switching function and is equipped with a plurality of ports. The FCoE switch 38 transfers, for example, an FCoE frame output from the storage apparatus 4 to the corresponding host system 2 and sends an FCoE frame, which has been sent from the host system 2, to the storage apparatus 4 by switching connections between the ports according to a transmission destination of the received FCoE frame, which is identified in a header of the FCoE frame.

FIG. 5 shows a logical configuration of the storage apparatus 4. As is apparent from FIG. 5, the storage apparatus 4 is configured by including a plurality of storage devices 33A mounted in the basic chassis 31A or the additional chassis 31B, two system-0 controller 40A and system-1 controller 40B for controlling input/output of data to/from these storage devices 33A, and a plurality of SAS expanders 41 connecting the storage devices 33A and the controllers 40A, 40B.

The storage devices 33A are composed of expensive disk devices such as SSD or SAS disks or inexpensive disk devices such as SATA disks as mentioned earlier. These storage devices 33A are operated by each of the system-0 controller 40A and system-1 controller 40B according to a RAID (Redundant Arrays of Inexpensive Disks) method. One or more storage devices 33A of the same type are managed as one parity group and one or more logical volumes (hereinafter referred to as the logical unit(s)) are set in a physical storage area provided by each storage device 33A constituting one parity group. Data is stored in units of blocks, each of which is of a specified size (hereinafter referred to as the logical block(s)) in this logical unit.

Each logical unit is assigned its unique identifier (hereinafter referred to as the LUN [Logical Unit Number]). In the case of this embodiment, data input/output is performed by designating an address that is a combination of this LUN and a unique logical block number assigned to each logical block (hereinafter referred to as the LBA [Logical Block Address]).

Each of the system-0 controller 40A and system-1 controller 40B is configured by including channel adapters 42A, 42B, a CPU 43A, 43B, a data controller 44A, 44B, a local memory 45A, 45B, a cache memory 46A, 46B, a shared memory 47A, 47B, disk adapters 48A, 48B, and a management terminal 49A, 49B.

The channel adapter 42A, 42B is an interface with the network 3 (FIG. 1) and is equipped with one or more ports. Then, the channel adapter 42A, 42B is connected via this port to the aforementioned FCoE switch 38 (FIG. 4A) constituting the network 3 and sends/receives, for example, various commands and write data or read data to/from the host system 2 via the relevant FCoE switch 38. Incidentally, this channel adapter 42A, 42B is also equipped with the same multiple frame encapsulation function as that of the FCM protocol processing unit 21D of the CNA 12 for the host system 2 and the multiple frame encapsulation processing described later is executed by the multiple frame encapsulation function of this channel adapter 42A, 42B as the storage apparatus 4.

The CPU 43A, 43B is a processor for controlling data input/output processing on the storage devices 33A in response to write commands and read commands from the host system 2 and controls the channel adapter 42A, 42B, the data controller 44A, 44B, and the disk adapter 48A, 48B based on microprograms read from the storage devices 33A.

The data controller 44A, 44B has a function switching a data transfer source and a transfer destination between the channel adapter 42A, 42B, the cache memory 46A, 46B, and the disk adapter 48A, 48B and a function, for example, generating/adding/verifying/deleting parity, check codes, and so on and is composed of, for example, ASIC.

Furthermore, the data controller 44A, 44B is connected to the data controller 44B, 44A of the other system (system 1 or system 0) via a bus 50, so that the data controller 44A, 44B can send/receive commands and data to/from the data controller 44B, 44A of the other system via this bus 50.

The local memory 45A, 45B is used as a work memory for the CPU 43A, 43B. This local memory 45A, 45B stores the aforementioned micrograms read from a specified storage device 33A at the time of activation of the storage apparatus 4, as well as system information.

The cache memory 46A, 46B is used to temporarily store data transferred between the channel adapter 42A, 42B and the disk adapter 48A, 48B. Furthermore, the shared memory 47A, 47B is used to store configuration information of the storage apparatus 4. Incidentally, the configuration information stored and retained in the shared memory 47A, 47B includes various information necessary for the multiple frames encapsulation processing described later.

The disk adapter 48A, 48B is an interface with the storage devices 33A. This disk adapter 48A, 48B controls the corresponding storage device 33A via the SAS expander 41 in response to a write command or read command, which is given by the channel adapter 42A, 42B, from the host system 2, thereby writing write data or reading read data at an address position designated by the write command or the read command in a logical unit designated by the write command or the read command.

The management terminal 49A, 49B is composed of, for example, a notebook personal computer device. The management terminal 49A, 49B is connected via a LAN (not shown in the drawing) to each channel adapter 42A, 42B, the CPU 43A, 43B, the data controller 44A, 44B, the cache memory 46A, 46B, the shared memory 47A, 47B, and each disk adapter 48A, 48B, obtains necessary information from the CPU 43A, 43B, the data controller 44A, 44B, the cache memory 46A, 46B, the shared memory 47A, 47B, and each disk adapter 48A, 48B and displays it, and makes necessary settings to the CPU 43A, 43B, the data controller 44A, 44B, the cache memory 46A, 46B, the shared memory 47A, 47B, and each disk adapter 48A, 48B.

Two SAS expanders 41 are provided in each of the basic chassis 31A and the additional chassis 31B so that they correspond to the system-0 controller 40A and system-1 controller 40B, respectively; and each of the two SAS expanders 41 in each basic chassis 31A or additional chassis 31B is connected in series with the disk adapter 48A, 48B of its corresponding system-0 controller 40A or system-1 controller 40B. This SAS expander 41 is connected to all the storage devices 33A within the same basic chassis 31A or additional chassis 31B, transfers various commands and write target data, which are output from the disk adapter 48A, 48B for the controller 40A, 40B, to their transmission destination storage device 33A, and sends read data and status information, which are output from the storage devices 33A, to the disk adapter 48A, 48B.

Incidentally, for example, some storage devices 33A such as SATA disks are provided with a switch 51 having a protocol conversion function; and as this switch 51 performs protocol conversion between the SAS protocol and a protocol which the relevant storage devices 33A comply with (SATA protocol), the disk adapter 48A, 48B can read or write data to the storage devices 33A (SATA disks) which comply with the protocol other than the SAS protocol.

### (1-2) Multiple Frame Encapsulation Function

### (1-2-1) Outline of Multiple Frame Encapsulation Function According to this Embodiment

Next, the multiple frame encapsulation function of the host system 2 and the storage apparatus 4 will be explained. Firstly, an ETS function of a conventional FCoE switch will be explained.

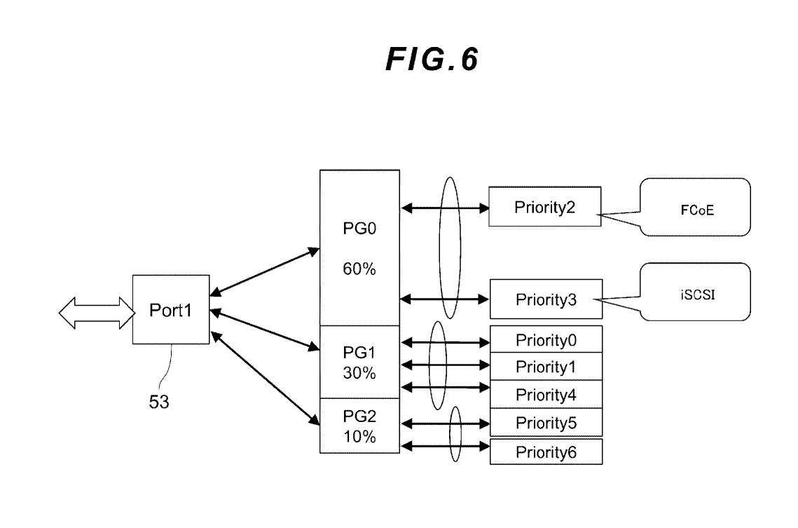

The ETS which is adopted by the CEE is a protocol that enables bandwidth control for each priority based on priority defined for each traffic. According to the ETS, as shown in FIG. 6, each of other priorities (priority whose priority number is“0” to “6”) excluding a specific priority that is not subject to the bandwidth control (priority whose priority number is “7” [not shown] and which will be hereinafter referred to as the specific priority) is assigned to any of priority groups PG. Then, the remaining bandwidth other than the bandwidth used by the specific priority are shared by each priority group PG.

Under this circumstance, an available bandwidth rate is defined for each priority group PG. Therefore, the FCoE switch controls the traffic of the individual priorities with respect to each priority group to use only the bandwidth of a rate assigned to that priority group among the available bandwidth at that time (the remaining bandwidth other than the bandwidth used by the specific priority). Incidentally, the ETS is designed so that if the bandwidth assigned to a certain priority group PG is not used, other priority groups PG can use the unused bandwidth and, therefore, a link shared by the plurality of priority groups PG can be used efficiently.

For example, in an example shown in FIG. 6, each priority whose priority number is “2 (Priority2)” or “3 (Priority3)” is assigned to a priority group PG whose priority group number is “0 (PG0)”; each priority whose priority number is “0 (Priority0),” “1 (Priority1),” or “4 (Priority4)” is assigned to a priority group PG whose priority group number is “1 (PG1)”; each priority whose priority number is “5 (Priority5)” or “6 (Priority6)” is assigned to a priority group PG whose priority group number is “2 (PG2).”

FIG. 6 also shows that “60%” bandwidth rate is assigned to the priority group PG whose priority group number is “0”; “30%” bandwidth rate is assigned to the priority group PG whose priority group number is “1”; and “10%” bandwidth rate is assigned to the priority group PG whose priority group number is “2.”

Therefore, in the example shown in FIG. 6, the bandwidth control of each priority whose the priority number is “2” or “3” is performed by the FCoE switch connected to the storage apparatus so that a total of the bandwidth used by these two priorities become “60%” of the entire remaining bandwidth excluding the bandwidth used by the specific priority at that time.

Now, referring to the example shown in FIG. 6, a case where the traffic of the FCoE protocol is assigned to the priority whose priority number is “2” and the traffic of the iSCSI protocol is assigned to the priority whose priority number is “3” will be examined.

In this case, the traffic of both the protocols is assigned to the priority group PG whose priority group number is “0.” So, if accesses according to the FCoE protocol and the iSCSI protocol to the same port (port whose port number is “1 (Port1)”) 53 are made at the same time, the FCoE switch 54 connected to the storage apparatus 4 output FCoE frames (“LU0 Fr1,” “LU2 Fr1,” “LU0 Fr2,” “LU2 Fr2,” and so on) and iSCSI frames (“LU1i Fr1,” “LU3i Fr1,” and so on) alternately.

This is because their priority number is different and a buffer 54A for the priority whose priority number is “2” is different from a buffer 54B for the priority whose priority number is “3,” so that frames are sequentially and alternately output from the buffers 54A, 54B for the respective priorities by means of the ETS function. Incidentally, there is no need to consider other priority groups PG in this situation.

If there are two accesses to a logical unit called “LU0” of a first tier (Tier1) with the traffic of the FCoE protocol and a logical unit called “LU2” of a third tier (Tier3) in this case, since the FCoE frames are stored in the same buffer 54A, the frames are output from the port 53 of the FCoE switch 54 in the order received by that port 53.

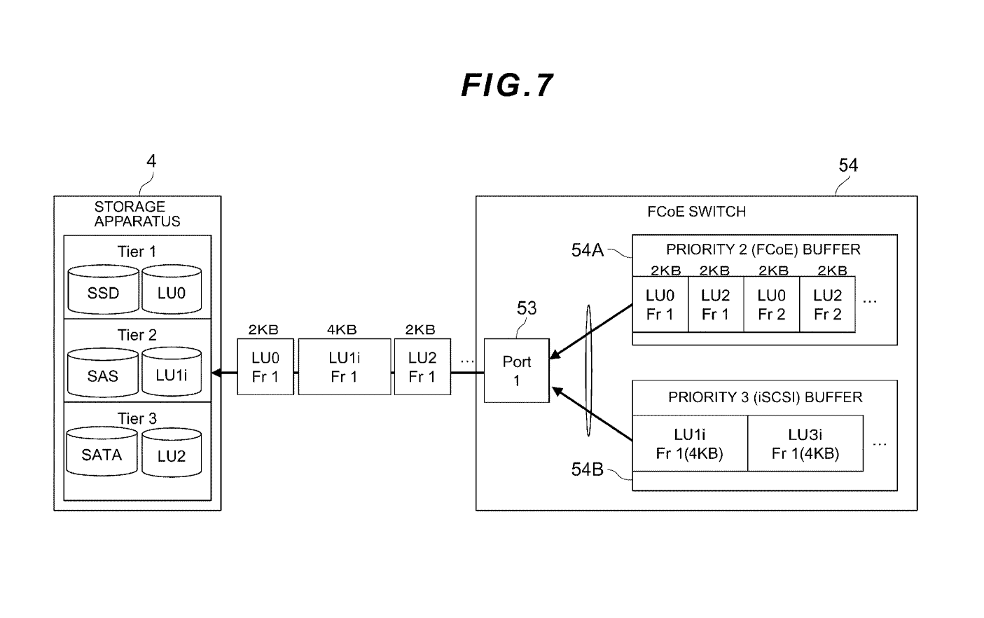

As a result, for example, assuming that data stored in one FCoE frame is 2 [KB] and data stored in one jumbo frame of the iSCSI protocol is 4 [KB], a transfer amount of write data to the logical unit called “LU0” belonging to the highest-level storage tier (Tier 1) becomes the same (on 2 [KB] basis) as a transfer amount of write data to the logical unit LU2 called “LU2” belonging to the lowest-level storage tier (Tier 3) as shown in FIG. 7; and if an iSCSI frame targeted at a logical unit LU1i is a jumbo frame, the amount of data twice as much as the data input to, or output from, the logical unit LU0 will be transferred to that logical unit LU1i. Specifically speaking, although data is stored on the storage apparatus side by distinguishing the storage tiers according to data characteristics such as required performance and data, the granularity of bandwidth control in data transfer is based on the traffic according to the conventional ETS method and, therefore, the problem is that the traffic control cannot be performed based on the granularity required and suited for the performance of each storage tier and logical unit, that is, on a storage tier basis or on a logical unit basis.

So, in the case of this computer system 1, the CNA 12 (FIG. 3) of the host system 2 and the channel adapter 42A, 42B (FIG. 5) of the storage apparatus 4 are equipped with a multiple frame encapsulation function making it possible to change the number of frames, that is, the number of FC frames to be encapsulated in one frame according to the FCoE protocol (the FCoE frame) on the storage tier basis or the logical unit basis. This multiple frame encapsulation function is a function making a plurality of FC frames in one FCoE frame and sending it with respect to a high-level tier logical unit which requires a wide bandwidth.

In fact, when sending write data to the high-level tier logical unit, the CNA 12 for the host system 2 divides the write data into a size according to the FC protocol as necessary and sequentially stores the divided pieces of the write data into FC frames respectively. Furthermore, that CNA 12 stores the thus-obtained FC frames as many as the maximum number of frames that can be comprised as one FCoE frame and are determined in advance for a storage tier to which a logical unit, a write destination, belongs (hereinafter referred to as the number of stacking frames), in an FCoE frame and sends it to the storage apparatus 4.

Incidentally, when the FCoE frame (hereinafter referred to as the stacked FCoE frame) in which a plurality of FC frames are comprised is sent to the CEE network, the FCoE switch on the path interprets a CEE header and header information of the FC frames comprised at the top and transfers the frame to a target node. Since the format of the top part of a stacked FCoE frame is the same as that of a normal FCoE frame (including an FC frame header), that will not have any effect on processing of the FCoE switch. Furthermore, since the destinations of the remaining stacked FC frames are the same, there will be no problem in frame delivery.

Furthermore, when the channel adapter 42A, 42B of the storage apparatus 4 receives the relevant (stacked) FCoE frame, it extracts all the FC frames comprised in this FCoE frame. Then, the channel adapter 42A stores write data, which is comprised in the thus-obtained FC frames, in a logical block designated by a write command, which was sent from the host system 2 before the relevant write data, in a logical unit designated by that write command.

On the other hand, when the channel adapter 42A, 42B of the storage apparatus 4 receives a read command from the host system 2, it reads corresponding data (read data) from a logical block designated by the read command in a logical unit designated by that read command. Then, the channel adapter 42A, 42B divides the thus-obtained read data into a size according to the FC protocol as necessary and sequentially sets the divided pieces of the read data in the FC frames. Also, the channel adapter 42A, 42B stores a multiplicity of the thus-obtained FC frames as many as the number of stacking frames determined in advance for a storage tier, to which a read destination logical unit belongs, in the stacked FCoE frame and sends them to the host system 2.

Then, when the CNA 12 for the host system 2 receives that stacked FCoE frame, it extracts all the FC frames comprised in this FCoE frame and also extracts the read data comprised in these FC frames.

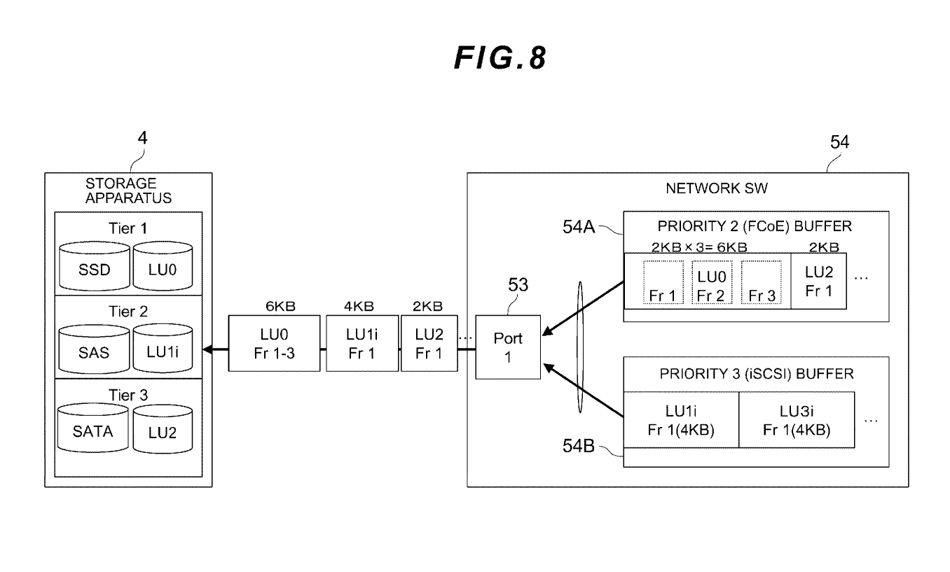

In this case, the number of stacking frames is set to a larger value for a higher-level storage tier. As a result, as shown in FIG. 8, a larger number of FC frames are encapsulated in one FCoE frame and transferred between the host system 2 and the storage apparatus 4 when data read from, or to be written to, a logical unit belonging to a higher-level storage tier.

For example, FIG. 8 shows an example in which three FC frames are comprised in an FCoE frame whose write destination is the logical unit called “LU0” belonging to the highest-level storage tier (Tier 1); and one FC frame is comprised as usual in an FCoE frame whose write destination is the logical unit called “LU2” belonging to the lowest-level storage tier (Tier 3). As is apparent from this FIG. 8, data transfer to the logical unit called “LU0” is performed on 6 [KB] basis within the FCoE protocol, but data transfer to the logical unit called “LU2” is performed on 2 [KB] basis; and data transfer to the logical unit called “LU1i” belonging to the medium-level storage tier (Tier 2) is performed on 4 [KB] basis according to the iSCSI frame.

With this computer system 1, a wide bandwidth can be secured as a data transfer bandwidth as described above by encapsulating a plurality of FC frames in one FCoE frame and sending them to the logical unit in the high-level tier. Furthermore, the bandwidth can be controlled on a storage tier basis by setting a different number of stacking frames for each storage tier.

### (1-2-2) Frame Format of Multiple Storage FCoE Frame

Next, the frame format used when encapsulating a plurality of FC frames in one FCoE frame by means of the multiple frame encapsulation function will be explained. Firstly, the frame format of a conventional FCoE frame will be explained.

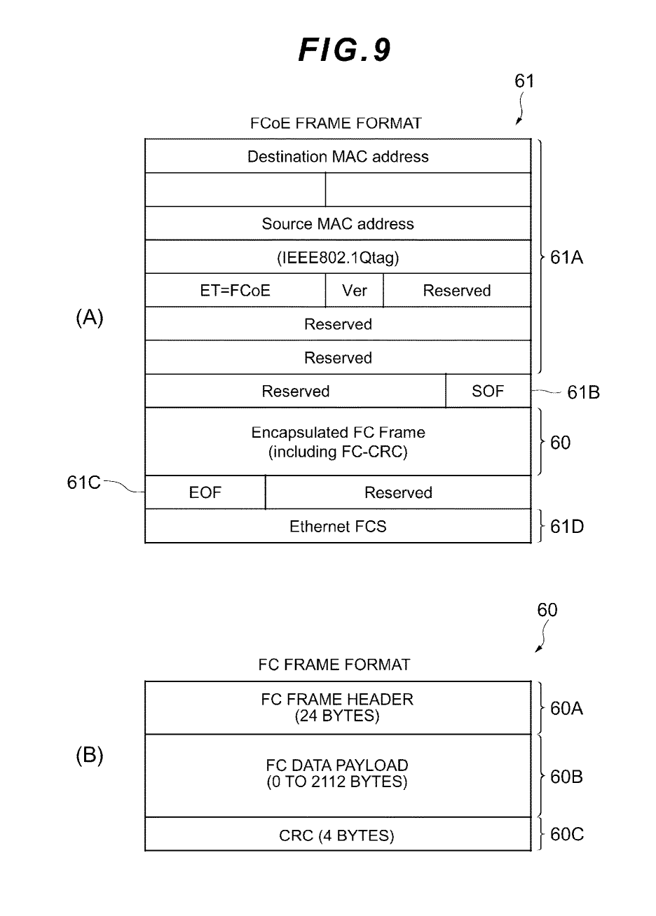

FIG. 9(A) shows the frame format of a conventional FCoE frame 61 and FIG. 9(B) shows the frame format of a conventional FC frame 60. As shown in FIG. 9(B), the FC frame 60 is formed by adding a 24 [Byte] FC frame header 60A to the top of 0 to 2112 [Byte] data 60B and adding a 4 [Byte] CRC (Cyclic Redundancy Check) 60C to the end of that data 60B.

Then, the FCoE frame 61 is formed as shown in FIG. 9(A) by adding an FCoE frame header 61A, including information such a MAC address of a transmission destination (“Destination MAC address”), a MAC address of a transmission source (“Source MAC address”), an IEEE802.1Q tag (“IEEE802.1Qtag”), and a version (“Ver”), before this FC frame 60 and adding an FCS (Frame Check Sequence) 61D for the Ethernet (registered trademark) after the relevant FC frame 60. Under this circumstance, an SOF (Start Of Frame) 61B and an EOF (End Of Frame) 61C are added immediately before or immediately after the FC frame 60, respectively.

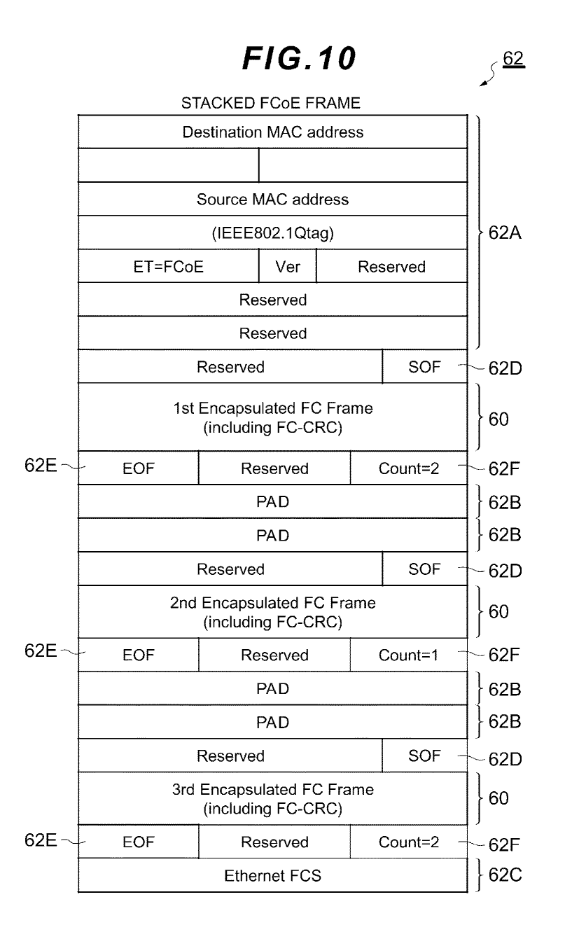

On the other hand, FIG. 10 shows the frame format of an FCoE frame (hereinafter referred to as the stacked FCoE frame as appropriate) 62 that encapsulates a plurality of FC frames 60 according to this embodiment. The stacked FCoE frame 62 is configured as shown in FIG. 10 so that the FC frames 60 as many as the number of frames to be connected are arranged and located in order via two-word pad data 62B; and an FCoE frame header 62A of the same structure as shown in FIG. 9(A) is added to the top of the plurality of FC frames 60; and an FCS 62C for the Ethernet (registered trademark) is added at the bottom of the plurality of FC frames 60.

Under this circumstance, an SOF 62D and an EOF 62E are added immediately before or immediately after each FC frame 60, respectively. Furthermore, within a word (reserved field) including the EOF 62E, part of that word is defined as a frame counter field 62F; and a counter value representing how many more FC frames 60 are encapsulated in the relevant FCoE frame 62 (hereinafter referred to as the remaining frame counter value) is stored in this frame counter field 62F.

For example, since three FC frames 60 are stored in one stacked FCoE frame 62 in the example shown in FIG. 10, the frame counter field 62F of the first FC frame (“1st Encapsulated FC Frame”) 60 stores “2” as the remaining frame counter value (“Count=2” in FIG. 10), the frame counter field 62F of the second FC frame (“2nd Encapsulated FC Frame”) 60 stores “1” as the remaining frame counter value (“Count=1” in FIG. 10), and the frame counter field 62F of the third FC frame (“3rd Encapsulated FC Frame”) 60 stores “0” as the remaining frame counter value (“Count=0” in FIG. 10).

Now, the frame size of the FC frame 60 which is encapsulated in the conventional FCoE frame 61 (FIG. 9(A)) is 2140 [Bytes] at maximum and the frame size of the entire FCoE frame 61 is 2180 [Bytes] at maximum. So, if an MTU (Maximum Transmission Unit) is 9 [KBytes], a maximum of four frames can be encapsulated; and if the MTU is 15 [KBytes], a maximum of 6 or 7 frames can be encapsulated.

Therefore, the maximum frame length FCoEMaxLen(B) of a stacked FCoE frame by means of this multiple frame encapsulation function can be represented by the following formula, where FCLen represents the frame length of one FC frame 60, SOFEOF represents a total data amount of the SOF 62D and the EOF 62E, MaxFrameN represents a maximum value of the number of frames which is the number of the FC frames 60 stored in one multiple storage FCoE frame 62, HeaderFCS represents a total data amount of the FCoE frame header 62A and the FCS 62C, and PADLen represents the data length of two pieces of pad data 62B:

[Math.1]

FCoEMaxLen={FCLen+(SOFEOF)}×MaxFrameN+HeaderFCS+PADLen×(Max.FrameN−1) (1)

Incidentally, regarding Formula (1), the maximum value of the frame length FClen of the FC frame 60 is 2140 [Bytes] as described above; the total data amount SOFEOF of the SOF 62D and the EOF 62E is 8 [Bytes]; the maximum value MaxFrameN of the number of frames which is the number of the FC frames 60 stored in one multiple storage FCoE frame 62 is 4 to 7 frames; the total data amount HeaderFCS of the FCoE frame header 62A and the FCS 62C is 32 [Bytes]; and the data length PADLen of two pieces of pad data 62B is 8 [Bytes].

Incidentally, a jumbo frame which is already used for the IP network can be extended to the degree of 9 [KBytes] to 15 [KBytes].

### (1-2-3) Processing of Host System in relation to Multiple Frame Encapsulation Function

Next, the processing content of various processing executed by the host system 2 in relation to the multiple frame encapsulation function according to this embodiment will be explained.

### (1-2-3-1) Management Table Creation Processing

In order to implement the multiple frame encapsulation function according to this embodiment as described above, it is necessary for the CNA 12 for the host system 2 to obtain in advance information about which storage tier each logical unit belongs to, and information about how many FC frames should be encapsulated in one FCoE frame at the time of read/write processing targeted at a logical unit belonging to which storage tier (these pieces of information will be hereinafter collectively referred to as the logical unit and tier association information).

Now, regarding a method for enabling the CNAs 12 for the host systems 2 to obtain the logical unit and tier association information, there is a possible method of letting a user or system administrator set the logical unit and tier association information to the CNAs 12 for the individual host systems 2. However, if this method is used, there is a problem of complicated work to be done in order to make such settings to the CNAs 12 for all the host systems 2.

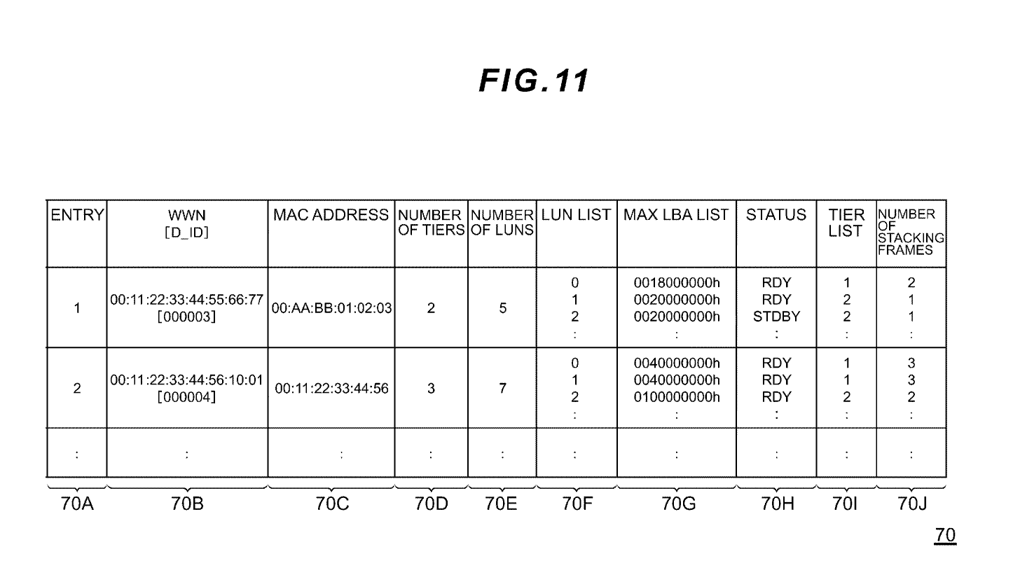

So, the computer system 1 according to this embodiment has one characteristic that the host system 2 obtains configuration information of the relevant storage apparatus 4, including the logical unit and tier association information, from each storage apparatus 4, creates a logical unit and tier association management table 70 shown in FIG. 11 based on the obtained configuration information, and manages such logical unit and tier association information based on this logical unit and tier association management table 70.

The logical unit and tier association management table 70 is a table used to manage various information obtained from each storage apparatus 4 and is constituted from an entry number column 70A, a WWN column 70B, a MAC address column 70C, a number-of-tiers column 70D, a number-of-LUNs column 70E, an LUN list column 70F, a MAX LBA list column 70G, a status column 70H, a tier list column 70I, and a number-of-FC-frames column 70J as shown in FIG. 11.

Then, the entry number column 70A stores the entry number assigned to each storage apparatus 4 recognized by the host system 2 retained in the logical unit and tier association management table 70; the WWN column 70B stores the WWN of the relevant storage apparatus 4; and the MAC address column 70C stores the MAC address of the relevant storage apparatus 4.

Furthermore, the number-of-tiers column 70D stores the number of storage tiers set to the relevant storage apparatus 4 (the number of storage tiers); and the number-of-LUNs column 70E stores the number of logical units created in the relevant storage apparatus 4 (the number of logical units). Furthermore, the LUN list column 70F stores an LUN list in which LUNs of each logical unit created in the relevant storage apparatus 4 are listed; and the MAX LBA list column 70G stores a MAX LBA list, that is, a list of maximum LBA values of the individual logical units whose LUNs are registered in the LUN list.

Furthermore, the status column 70H stores the current status of the individual logical units registered in the LUN list; and the tier list column 70I stores a list of tiers, that is, the storage tiers to which the individual logical units belong. Furthermore, the number-of-FC-frames column 70J stores the aforementioned number of stacking frames at the time of read/write processing targeted at the individual logical units.

Therefore, for example, in the case of the example shown in FIG. 11, it is shown that the WWN of the storage apparatus 4 to which the entry number “1” is assigned is “00:11:22:33:44:55:66:77,” its MAC address is “00:AA:BB:01:02:03,” the number of storage tiers in that storage apparatus 4 is “2,” and the number of the logical units is “5.” This example also shows that among the “five” logical units, the maximum LBA of the logical unit whose LUN is “0” is “0018000000h,” the current status is “ready (RDY)” state capable of reading/writing data, that logical unit belongs to the storage tier “1,” and the number of stacking frames is “2” when reading/writing data from/to this logical unit.

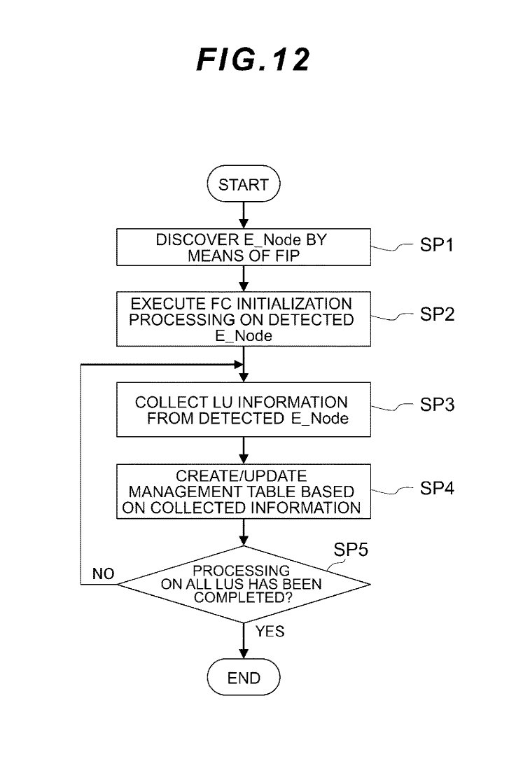

FIG. 12 shows a processing sequence for management table creation processing executed by the CPU 10 (FIG. 2) for the host system 2 in order to create the logical unit and tier association management table 70.

When the storage apparatus is powered on, the CPU 10 starts the management table creation processing shown in FIG. 12; and firstly detects the storage apparatuses 4 (E_Node) over the network 3 (FIG. 1) by means of an FIP (FCoE Initialization Protocol) which is a conventional technique (SP1) and executes Fibre Channel Protocol initialization processing such as port login on each detected storage apparatus 4 (SP2).

Subsequently, the CPU 10 issues a SCSI command to each storage apparatus 4 and thereby collects necessary information to create the logical unit and tier association management table 70 from these storage apparatuses 4 (SP3).

Specifically speaking, the CPU 10 issues an INQUIRY command to each storage apparatus 4 detected in step SP2 and thereby obtains information such as a device type/model name of the relevant storage apparatus 4. Furthermore, the CPU 10 issues a REPORT LUNS command to that storage apparatus 4 and thereby obtains the number of logical units created in the storage apparatus 4 (the number of logical units) and a logical unit list in which those logical units are listed.

Furthermore, the CPU 10 issues an INQUIRY command to each logical unit based on the logical unit list obtained by issuance of the above-mentioned REPORT LUNS command and thereby obtains unique information (page-designating INQUIRY data) of each logical unit whose LUN is listed in the logical unit list. Under this circumstance, the storage apparatus 4 according to this embodiment replies tier information of each logical unit, about which the inquiry was made (information indicating a tier to which the relevant logical unit belongs), and the number of stacking frames which is set in advance to the relevant logical unit or each storage tier.

Furthermore, the CPU 10 issues a READ CAPACITY command to each logical unit, whose LUN is listed in the logical unit list, and thereby obtains a storage capacity (maximum LBA) of these logical units.

Then, the CPU 10 creates the logical unit and tier association management table 70 based on the information collected in step SP3 (SP4). Subsequently, the CPU 10 judges whether the execution of the processing on all the logical units in all the storage apparatuses 4 detected in step SP1 has been completed or not (SP5).

Then, if the CPU 10 obtains a negative judgment result for this judgment, it returns to step SP3 and then repeats the processing from step SP3 to step SP5. Subsequently, if the CPU 10 eventually obtains an affirmative judgment result in step SP5 by completing the processing of step SP3 and step SP4 on all the logical units in all the storage apparatuses 4 detected in step SP1, it terminates this management table creation processing.

Incidentally, when receiving an instruction from management software (not shown) to update the logical unit and tier association management table 70, the CPU 10 updates the content of the logical unit and tier association management table 70 to latest information by executing the processing in step SP3 and subsequent steps.

### (1-2-3-2) Write Processing at Host System

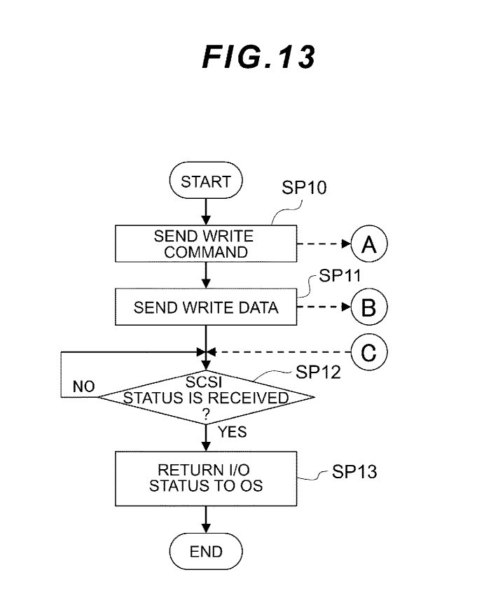

FIG. 13 to FIG. 15 show a processing sequence for write processing executed respectively by the SCSI driver 26, the FC driver 27, and the CNA controller 21 (to be specific, the FCM protocol processing unit 21D) in the host system 2 described earlier with reference to FIG. 3 when the host system 2 writes data to the storage apparatus 4.

Among the above-mentioned drawings, FIG. 13 shows a processing sequence for write processing executed by the SCSI driver 26 (hereinafter referred to as the SCSI-driver-side write processing). After receiving a write request from the OS 24 (FIG. 3), the SCSI driver 26 starts this SCSI-driver-side write processing and firstly sends a SCSI WRITE command to the FC driver 27 in response to the write request (SP10).

Next, the SCSI driver 26 sends write target data (write data) to the FC driver 27 (SP11) and then waits for the execution result (SCSI status) of the write command to be sent from the FC driver 27 (SP12).

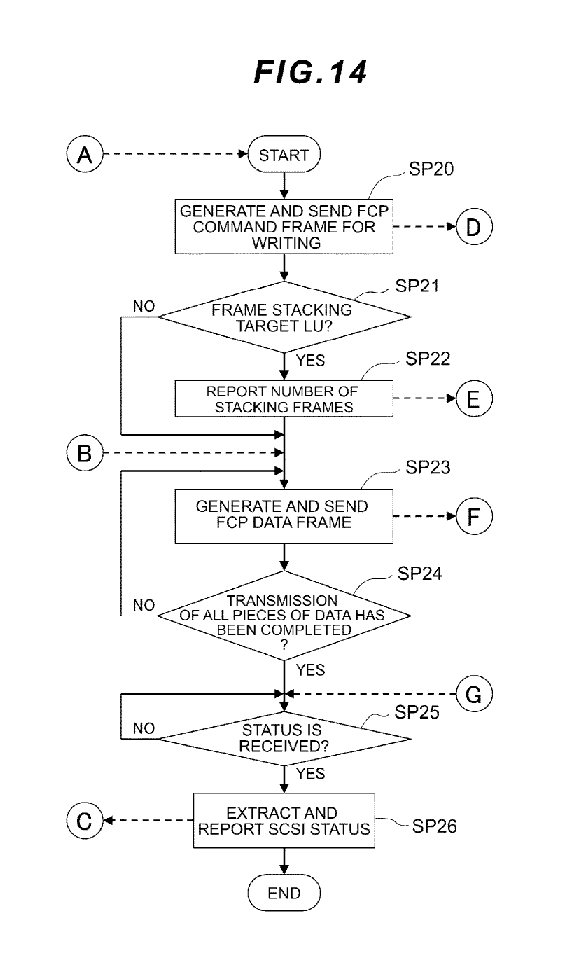

Then, when receiving the execution result of the write command from the FC driver 27 (see step SP26 in FIG. 14), the SCSI driver 26 accordingly sends the execution result (the I/O status) of the aforementioned write request to the OS 24 (SP13) and then terminates this SCSI-driver-side write processing.

On the other hand, FIG. 14 shows a processing sequence for write processing executed by the FC driver 27 (hereinafter referred to as the FC-driver-side write processing). After receiving the SCSI WRITE command which was sent from the SCSI driver 26 in step SP10 in FIG. 13, the FC driver 27 starts this FC-driver-side write processing and firstly generates a command transfer FC frame storing that SCSI WRITE command (hereinafter referred to as the FCP command frame (also known as FCP CMND frame) as appropriate) and sends the generated FCP command frame to the CNA 12 (FIG. 3) (SP20).

Subsequently, the FC driver 27 refers to the logical unit and tier association management table 70 (FIG. 11) and judges whether or not a logical unit, which is a write destination for the write data, is a logical unit for which a plurality of FC frames should be encapsulated in an FCoE frame (hereinafter referred to as the frame-stacking-target logical unit) (SP21).

Then, if the FC driver 27 obtains a negative judgment result for this judgment, it proceeds to step SP23. On the other hand, if the FC driver 27 obtains an affirmative judgment result for this judgment, it obtains the number of stacking frames, which is set for the relevant logical unit, from the logical unit and tier association management table 70 and reports the obtained number of stacking frames to the CNA 12 (SP22).

Subsequently, after receiving the write data sent from the SCSI driver 26 in step SP11 in FIG. 13, the FC driver 27 generates a data transfer FC frame(s) comprising that write data (hereinafter referred to as the FCP data frames (also known as FCP DATA frame) as appropriate) and sends the generated FCP data frames to the CNA 12 (SP23).

Furthermore, the FC driver 27 then judges whether set of all the pieces of the write data in the FCP data frames and transfer of such FCP data frames to the CNA 12 have been completed or not (SP24). Then, if the FC driver obtains a negative judgment result for this judgment, it returns to step SP23 and then repeats a loop from step SP23 to step SP24 and back to step SP23.

If the FC driver 27 eventually obtains an affirmative judgment result in step SP24 by storing all the pieces of the write data given from the SCSI driver 26 in the FCP data frames and finishing transferring these FCP data frames to the CNA 12, it waits for receiving an FCP response frame (FCP RSP frame), in which the SCSI status indicating the result of the write processing is comprised, to be sent from the CNA 12 (SP25).

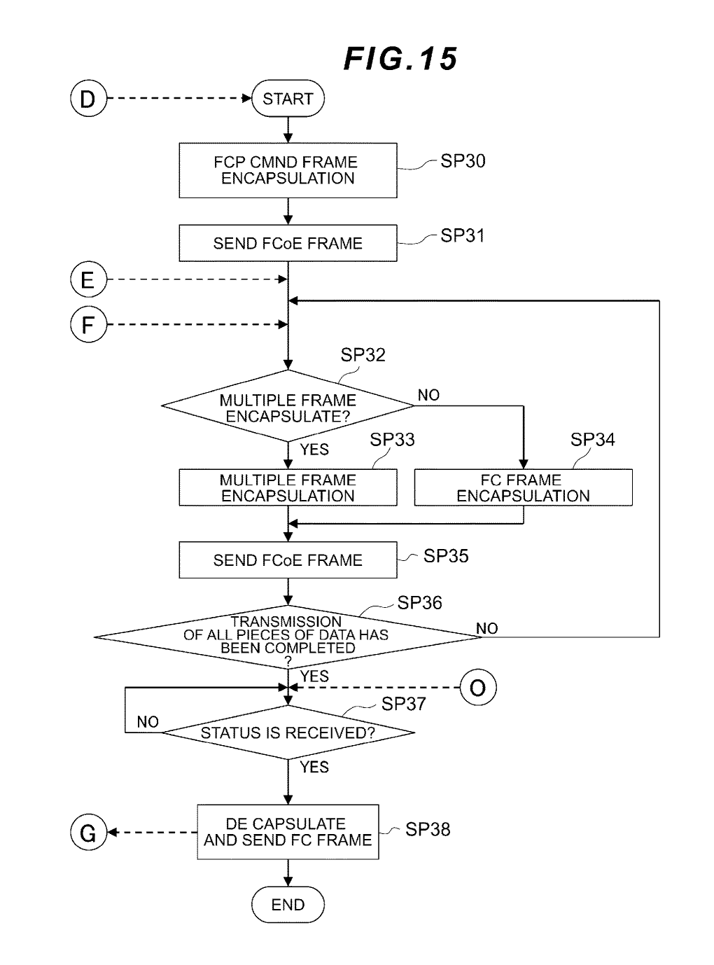

Then, after receiving such an FCP response frame from the CNA 12 (see step SP38 in FIG. 15), the FC driver 27 extracts the SCSI status from this FC frame and transfers the extracted SCSI status to the SCSI driver 26 (SP26). Subsequently, the FC driver 27 terminates this FC-driver-side write processing.

Meanwhile, FIG. 15 shows a processing sequence for write processing executed by the CNA controller 21 (FIG. 3) for the CNA 12 (hereinafter referred to as the CNA-side write processing). After receiving the FCP command frame which was sent from the FC driver 27 in step SP20 in FIG. 14, the CNA controller 21 starts this CNA-side write processing; and the FCM protocol processing unit 21D (FIG. 3) for the CNA controller 21 firstly adds the FCoE frame header to the top of the received FCP command frame and adds the FCS for the Ethernet to its end, thereby encapsulating the relevant FCP command frame in an FCoE frame in the normal format (see FIG. 9) (SP30).

Then, the CEE protocol processing unit 21A for the CNA controller 21 sends the FCoE frame in the normal format, which was obtained by means of encapsulation, to the storage apparatus 4 via the optical transceiver 20 according to the protocol in conformity with the CEE standards (SP31).

Furthermore, the CNA controller 21 then waits to receive the number of stacking frames described earlier with respect to step SP22 in FIG. 14, which will be later reported by the FC driver 27, and the FCP data frames described earlier with respect to step SP23 in FIG. 14. After receiving the number of stacking frames and the FCP data frames, the CNA controller 21 judges whether the logical unit which is the write destination is a frame-stacking-target logical unit or not, based on the received number of stacking frames (SP32).

If the CNA controller 21 obtains an affirmative judgment result for this judgment, it generates a stacked (multiple FC frames encapsulated) FCoE frame (see FIG. 10) in which the FCP data frames as many as the above-mentioned number of stacking frames are encapsulated (SP33). On the other hand, if the CNA controller 21 obtains a negative judgment result in step SP32, it generates a normal FCoE frame (see FIG. 9(A)) wherein only one FCP data frame is encapsulated in one FCoE frame (SP34). Incidentally, the processing of step SP33 or step SP34 is executed by the FCM protocol processing unit 21D in the CNA controller 21 by using the memory 22 (FIG. 3).

Subsequently, the CEE protocol processing unit 21A of the CNA controller 21 sends the stacked FCoE frame or the normal FCoE frame, which was obtained by the processing of step SP33 or step SP34, to the storage apparatus 4 via the optical transceiver 20 according to the protocol in conformity with the CEE standards.

Then, the CNA controller 21 judges whether transfer of all pieces of the write data to the storage apparatus 4 has been completed or not (SP36). If the CNA controller 21 obtains a negative judgment result for this judgment, it returns to step SP32 and then repeats the processing from step SP32 to step SP36.

Then, if the CNA controller 21 eventually obtains an affirmative judgment result in step SP36 by encapsulating all the FCP data frames, which were sent from the FC driver 27, in the FCoE frame and finishing sending them to the storage apparatus 4, it waits for receiving the FCoE frame in which the SCSI status indicating the result of the write processing is comprised (FCP RSP frame) to be sent from the storage apparatus 4 (SP37).

After the CEE protocol processing unit 21A for the CNA controller 21 receives the FCoE frame, in which the SCSI status is comprised, via the optical transceiver 20, the FCM protocol processing unit 21A for the CNA controller 21 extracts the FCP response frame, in which the SCSI status is comprised, from that FCoE frame and transfers the extracted FC frame to the FC driver 27 (SP38). Then, the CNA controller 21 terminates this CNA-side write processing.

Incidentally, regarding the aforementioned processing, the FC driver or the SCSI driver is the device for directly sending data; however, such data transmission may be realized by, for example, delivering/receiving the address in the memory 11 for the host system 2 where commands and data are stored. Also, for example, the FC frame generation processing may be executed by the FC protocol processing unit 21C in the CNA controller 21.

### (1-2-3-3) Read Processing at Host System

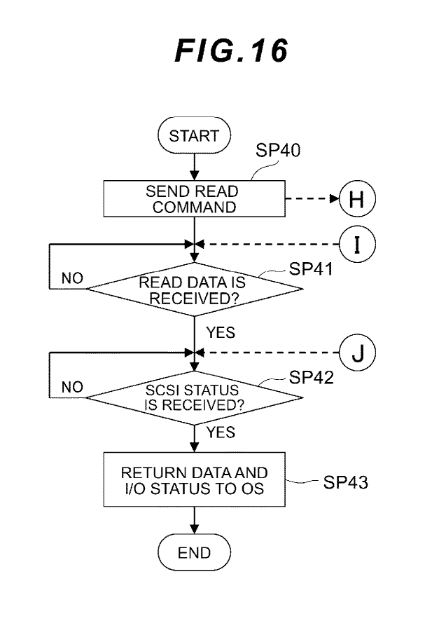

FIG. 16 to FIG. 18 show a processing sequence for read processing executed respectively by the SCSI driver 26 (FIG. 3), the FC driver 27 (FIG. 3), and the CNA controller 21 (to be specific, the FCM protocol processing unit 21D (FIG. 3)) in the host system 2 when the host system 2 reads data from the storage apparatus 4.

Among the above-mentioned drawings, FIG. 16 shows a processing sequence for read processing executed by the SCSI driver 26 (hereinafter referred to as the SCSI-driver-side read processing). After receiving a read request from the OS 24 (FIG. 3), the SCSI driver 26 starts this SCSI-driver-side read processing and firstly sends a SCSI READ command to the FC driver 27 in response to the read request (SP40). Then, the SCSI driver 26 then waits for the reception of a response to the read processing (read data and the SCSI status) (SP41, SP42).

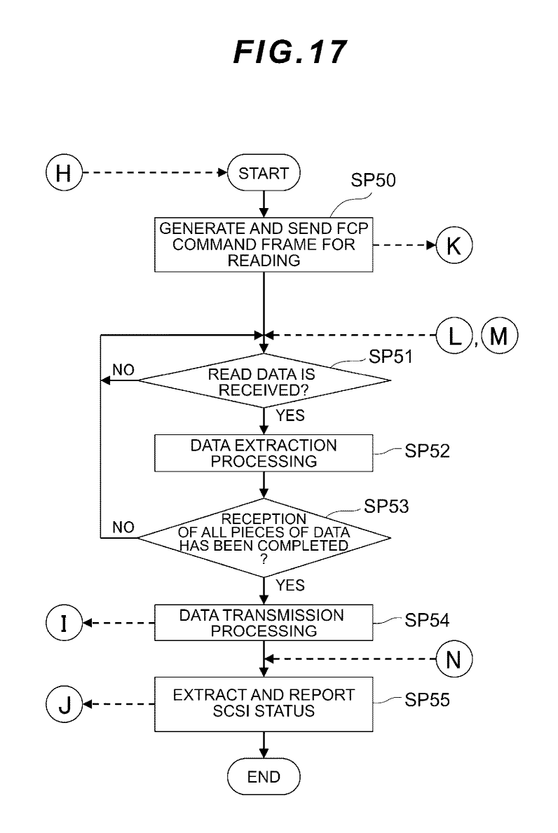

Then, when receiving the read data, which has been read from the storage apparatus 4, and the SCSI status indicating the result of the read processing from the FC driver 27 (see step SP54 and step SP55 in FIG. 17), the SCSI driver 26 sends the execution result (I/O status and the read data) of the aforementioned read request to the OS 24 (SP43) and then terminates this SCSI-driver-side read processing.

On the other hand, FIG. 17 shows a processing sequence for read processing executed by the FC driver 27 (hereinafter referred to as the FC-driver-side read processing). After receiving the SCSI READ command which was sent from the SCSI driver 26 in step SP40 in FIG. 16, the FC driver 27 starts this FC-driver-side read processing and firstly generates an FCP command frame, in which the relevant SCSI READ command is comprised, and sends the generated FCP command frame to the CNA 12 (SP50). Furthermore, the FC driver 27 then waits for receiving FCP data frames, in which the read data sent from the storage apparatus 4 are comprised, to be sent from the CNA 12 (SP51).

Then, when the FCP data frames in which the read data sent from the storage apparatus 4 are comprised are transferred from the CNA 12, the FC driver 27 extracts the read data from the FCP data frames (SP52) and then judges whether the reception of all pieces of the read data has been completed or not (SP53).

If the FC driver 27 obtains a negative judgment result for this judgment, it returns to step SP51 and then repeats the processing from step SP51 to step SP53. If the FC driver 27 eventually obtains an affirmative judgment result in step SP53 by finishing receiving all the pieces of the read data, it sends the received read data to the SCSI driver 26 (SP54).

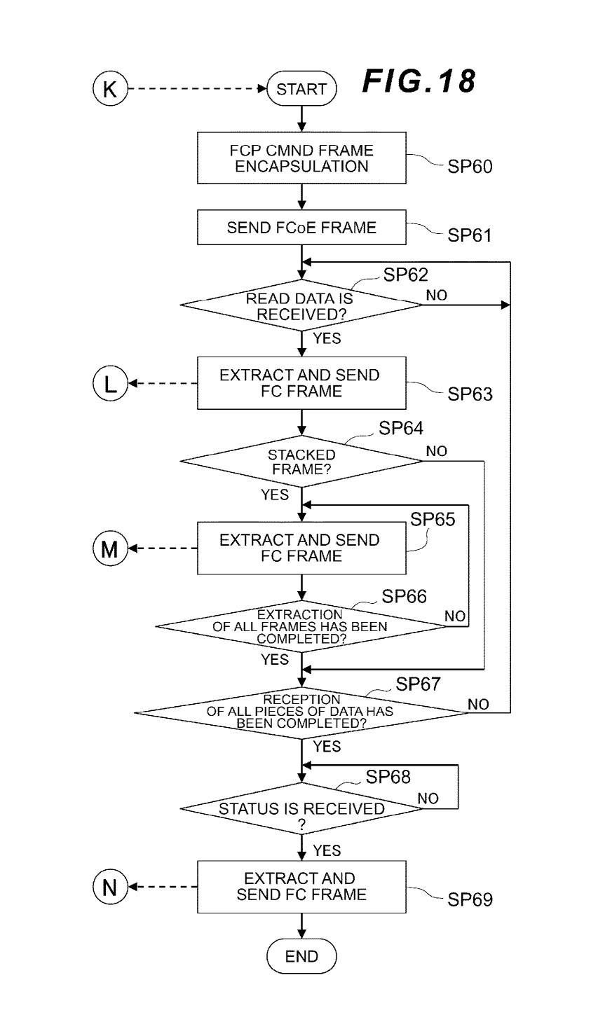

Subsequently, the FC driver 27 waits for receiving an FCP response frame, in which the SCSI status indicating the result of the read processing is comprised, to be sent from the CNA 12 (see step SP69 in FIG. 18). After receiving this FCP response frame, the FC driver 27 extracts the SCSI status from this FC frame and transfers the extracted SCSI status to the SCSI driver 26 (SP55). Subsequently, the FC driver 27 terminates this FC-driver-side read processing.

Meanwhile, FIG. 18 shows a processing sequence for read processing executed by the CNA controller 21 for the CNA 12 (hereinafter referred to as the CNA-side read processing). After receiving the FCP command frame which was sent from the FC driver 27 in step SP50 in FIG. 17, the CNA controller 21 starts this CNA-side read processing; and the FCM protocol processing unit 21D (FIG. 3) for the CNA controller 21 firstly adds the FCoE frame header to the top of the received FCP command frame and adds the FCS for the Ethernet to its end, thereby encapsulating the relevant FCP command frame in an FCoE frame in the normal format (see FIG. 9) (SP60).

Subsequently, the CEE protocol processing unit 21A for the CNA controller 21 sends the FCoE frame in the normal format, which was obtained by means of encapsulation, to the storage apparatus 4 via the optical transceiver 20 according to the protocol in conformity with the CEE standards (SP61). Furthermore, the CNA controller 21 then waits for receiving the FCoE frame(s), in which the read data is comprised, to be sent from the storage apparatus 4 (SP62).

After the CEE protocol processing unit 21A receives that FCoE frame via the optical transceiver 20, the CNA controller 21 extracts one FC frame from this FCoE frame and sends the extracted FC frame to the FC driver 27 (SP63). Incidentally, the processing of this step SP63 is executed by the FCM protocol processing unit 21D in the CNA controller 21 by using the memory 22 (FIG. 3).

Next, the CNA controller 21 judges whether the received FCoE frame is a stacked (multiple FC frames encapsulated) FCoE frame or not (SP64). Regarding that FCoE frame, the frame counter field 62F (FIG. 10) associated with the FC frame extracted in step SP63 is provided; and the above judgment is performed by judging whether the remaining frame counter value stored in that frame counter field 62F is a value other than “0” or not.

If the CNA controller 21 obtains a negative judgment result for this judgment, it proceeds to step SP67; and if the CNA controller 21 obtains an affirmative judgment result for this judgment, it extracts the next FC frame from the relevant FCoE frame and sends the extracted FC frame to the FC driver 27 (SP65). Incidentally, the processing of this step SP65 is executed by the FCM protocol processing unit 21D in the CNA controller 21 by using the memory 22 (FIG. 3).

Subsequently, the CNA controller 21 judges whether extraction of all the FC frames stored in the relevant FCoE frame has been completed or not (SP66). This judgment is performed by judging whether the remaining frame counter value stored in the frame counter field 62F corresponding to the FC frame extracted in step SP63 is a value other than “0” or not.

If the CNA controller 21 obtains a negative judgment result for this judgment, it returns to step SP65 and then repeats a loop from step SP65 to step SP66 and then back to step SP65. Then, if the CNA controller 21 eventually obtains an affirmative judgment result in step SP66 by finishing extracting all the FC frames comprised in the relevant FCoE frame, it judges whether the reception of all the pieces of the read data has been completed or not (SP67).

If the CNA controller 21 obtains a negative judgment result for this judgment, it returns to step SP62 and then repeats the processing from step SP62 to step SP67. Then, if the CNA controller 21 eventually obtains an affirmative judgment result in step SP67 by finishing receiving all the pieces of the read data, it waits for receiving the FCoE frame, in which the SCSI status indicating the result of the read processing is comprised (FCP RSP frame), to be sent from the storage apparatus 4 (SP68).

Then, after the CEE protocol processing unit 21A for the CNA controller 21 receives that FCoE frame via the optical transceiver 20, the FCM protocol processing unit 21D for the CNA controller 21 extracts the FCP response frame, in which the SCSI status is comprised, from the FCoE frame and transfers the extracted FCP response frame to the FC driver 27 (SP69). Then, the CNA controller 21 terminates this CNA-side read processing.

### (1-2-4) Processing of Storage Apparatus relating to Multiple Frame Encapsulation Function

### (1-2-4-1) Various Settings of Storage Apparatus

Next, the processing content of the storage apparatus 4 relating to the multiple frame encapsulation function will be explained. Firstly, for example, the setting content of various settings that should be set to the storage apparatus 4 in relation to the multiple frame encapsulation function will be explained.

After the activation of the storage apparatus 4, the channel adapter 42A, 42B of the storage apparatus 4 (FIG. 5) exchanges DCB (Data Center Bridging) parameters with the FCoE switch 38 (FIG. 1) connected to the relevant storage apparatus 4 according to a DCBX (Data Center Bridging capabilities eXchange) protocol. Under this circumstance, the channel adapter 42A, 42B also exchanges parameters relating to the priority groups and parameters relating to the protocol for applications to be supported (such as iSCSI), together with the DCB parameters, with the FCoE switch 38.

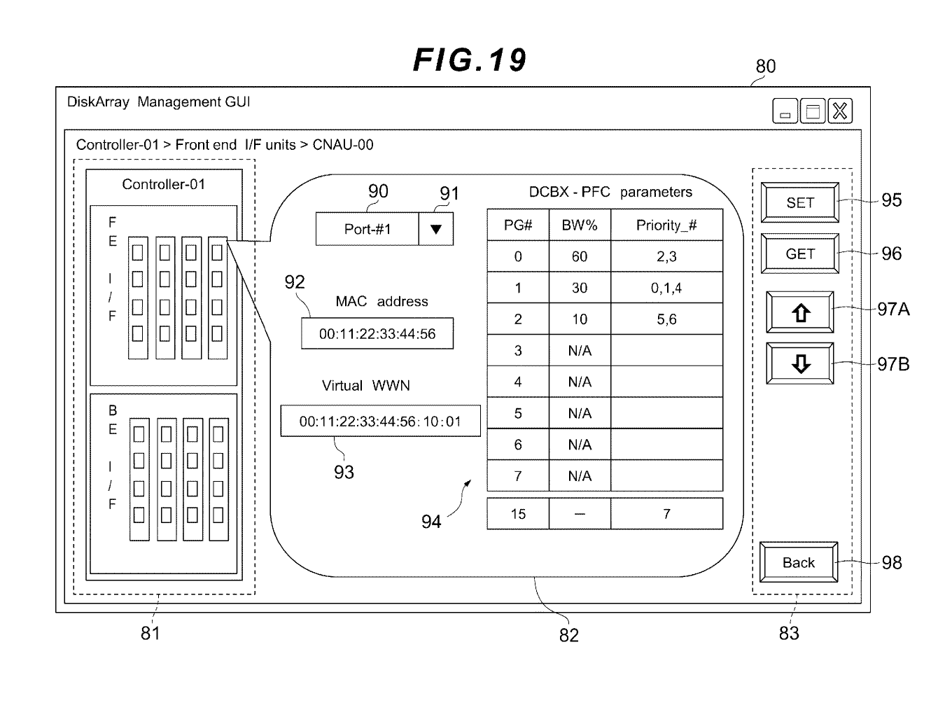

With the storage apparatus 4 according to this embodiment, the DCB parameters and other information collected by the channel adapter 42A, 42B as described above can be displayed on, for example, a display screen (hereinafter referred to as the DCBX parameter display screen) 80 as shown in FIG. 19 by operating the management terminal 49A, 49B (FIG. 5).

This DCBX parameter display screen 80 is a GUI (Graphical User Interface) screen used to view various settings, which are set to each port in the system-0 controller 40A and system-1 controller 40B with respect to the ETS, or to update such settings. As is apparent from FIG. 19, the DCBX parameter display screen 80 is constituted from a port display field 81 provided on the left side of the screen, a parameter display field 82 provided in the central part of the screen, an operation field 83 which is provided on the right side of the screen and in which an operation button group is placed. Then, the port display field 81 displays a diagrammatic illustration schematically showing port groups included in the system-0 controller 40A and system-1 controller 40B.

Furthermore, the parameter display field 82 displays, for example, the DCB parameters which the storage apparatus 4 exchanged with the FCoE switch 38. In fact, the parameter display field 82 is provided with a port number display field 90, a MAC address display field 92, a virtual WWN (World Wide Name) display field 93, and a DCBX-PFC parameter list 94.

A pull-down button 91 is provided to the right of the port number display field 90; and a pull-down menu (not shown) in which all the port numbers of the respective ports of each channel adapter 42A, 42B and each disk adapter 48A, 48B are listed is displayed by clicking this pull-down button 91.

Thus, the system administrator can select the port number by clicking the port number of a desired port among the port numbers listed in this pull-down menu. The port number then selected is displayed in the port number display field 90 and the MAC address assigned to the port with that port number is displayed in the MAC address display field 92. Furthermore, the virtual WWN (World Wide Name) which is set to the port with that port number is displayed in the virtual WWN display field 93; and the rate of maximum bandwidth (“BW %”) for each priority group (“PG#”), which is set in advance for the relevant port, and the priority number (“Priority_#”) of each priority belonging to the relevant priority group are displayed in the DCBX-PFC parameter list 94. Incidentally, FIG. 19 corresponds to the settings in FIG. 6 and “N/A” in the drawing represents that no parameter is set.

The operation field 83 displays a “SET” button 95, a “GET” button 96, cursor movement buttons 97A, 97B, and a back button 98. Among these buttons, the “GET” button 96 is a button to make the DCBX-PFC parameters set to the port, whose port number is displayed in the port number display field 90, displayed in the DCBX-PFC parameter list 94. The maximum bandwidth of each priority group which is set to the relevant port and the priority number of each priority belonging to the relevant priority group can be displayed in the DCBX-PFC parameter list 94 by clicking this “GET” button 96.

Furthermore, the “SET” button 95 is a button to update and set the parameters displayed in the DCBX-PFC parameter list 94. The maximum bandwidth of each priority group displayed in the DCBX-PFC parameter list 94 and the priority number of each priority belonging to the relevant priority group can be freely changed by using, for example, a keyboard; and after making such a change, each DCBX-PFC parameter can be updated and set to the changed value by clicking the “SET” button 95.

The cursor movement button 97A, 97B is a button to move a cursor (not shown in the drawing) displayed on the DCBX-PFC parameter list 94 in an upward direction or a downward direction. When updating and setting the parameters displayed in the DCBX-PFC parameter list 94 as described above, this cursor movement button 97A, 97B is operated to position the cursor on the DCBX-PFC parameter list 94 to an update target line, so that the PFC parameter on that line can be freely changed by using, for example, the keyboard. Furthermore, the back button 98 is a button to switch the current display screen to the previous screen (not shown).

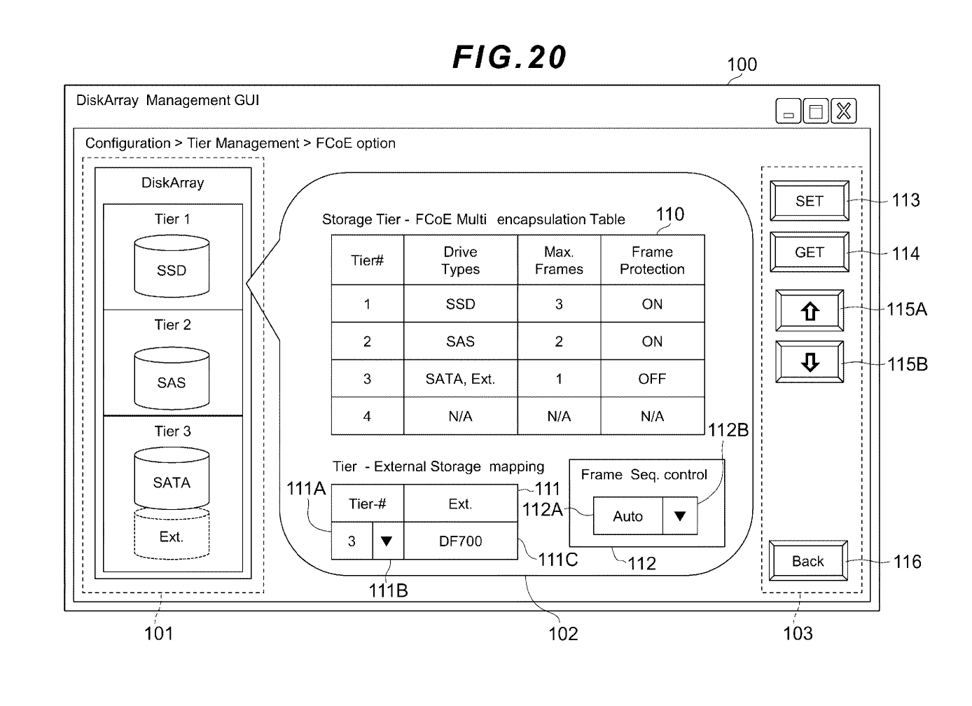

On the other hand, FIG. 20 shows a configuration example for a setting screen (hereinafter referred to as the number-of-stacking-frames-setting screen) 100 for setting the number of stacking frames for each storage tier or each logical unit at the time of read processing or write processing on a logical unit belonging to each storage tier.

This number-of-stacking-frames-setting screen 100 is a GUI screen that can be displayed on the management terminal 49A, 49B by operating the management terminal 49A, 49B (FIG. 5) of each controller 40A, 40B (FIG. 5) for the storage apparatus 4 and is constituted from a storage tier selection field 101 on the left side of the screen, a tier information setting field 102 provided in the central part of the screen, and an operation field 103, in which an operation button group is placed, provided on the right side of the screen.

Then, the storage tier selection field 101 displays a conceptual diagram schematically showing each storage tier defined in the storage apparatus 4 (a first tier (Tier 1) to a third tier (Tier 3) in the example in FIG. 20).

Furthermore, the tier information setting field 102 displays various setting values for each storage tier related to the multiple frame encapsulation function. In fact, the tier information setting field 102 is constituted from a storage tier information list 110, a storage tier—external storage mapping setting field 111, and a frame transmission order priority control setting field 112.

Then, the storage tier information list 110 may configures, for each storage tier, the types of the storage devices 33A (FIG. 5) providing storage areas of logical units belonging to the relevant storage tier (“Drive Types”), the number of stacking frames set to the relevant storage tier (“Max. Frames”), and frame protection setting information indicating the settings of the frame protection function to the relevant storage tier, by associating them with each other. Incidentally, the frame protection function is a function sending a data guarantee frame to enhance the reliability of the FCoE frame and restoring data based on the received data guarantee frame. The details of this frame protection function will be explained later with respect to a fifth embodiment.

Therefore, FIG. 20 shows that regarding the storage tier to which the storage tier number (“Tier#”) “1” is assigned, the type of the storage devices 33A providing storage areas of logical units belonging to the relevant storage tier is “SSD,” the maximum number of stacking frames when reading/writing data to the logical units belonging to the relevant storage tier is “3,” and the frame protection function is set to “ON” with respect to the relevant storage tier.

Furthermore, the storage tier-external storage mapping setting field 111 is a setting field to set which storage tier a logical unit provided by a connected external storage apparatus (hereinafter referred to as the external logical unit) should be placed; and is constituted from a setting tier display area 111A, a pull-down button 111B, and an external storage device type name display area 111C.

Then, with the storage tier-external storage mapping setting field 111, a pull-down menu (not shown) in which the storage tier numbers of all storage tiers then defined in the storage apparatus 4 can be displayed by clicking the pull-down button 111B.

Thus, the system administrator can select the storage tier to which the external logical unit should belong, by clicking the storage tier number of a desired storage tier from among the storage tier numbers listed in the pull-down menu. Then, the then selected storage tier number is displayed in the setting tier display area 111A.

Furthermore, the external storage device type name display area 111C displays the device name of the external storage apparatus obtained by discovery processing executed in advance.

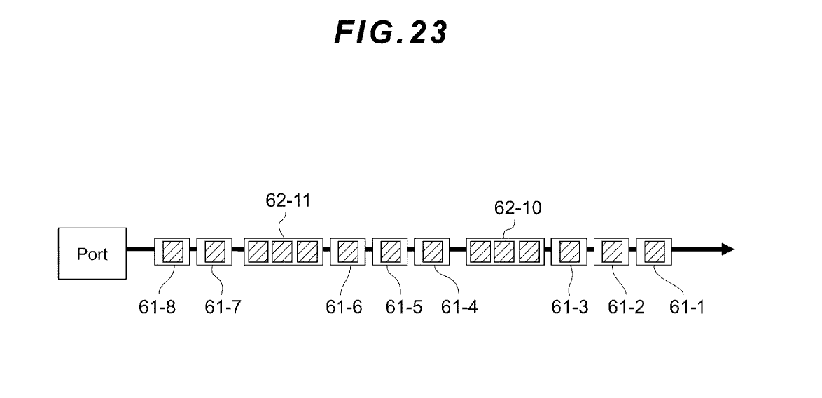

A frame transmission order priority control setting field 112 is a setting field for setting a mode for frame transmission order priority control described later with reference to FIG. 23 to FIG. 25; and is constituted from a mode display area 112A and a pull-down button 112B.

Then, the frame transmission order priority control setting field 112 can display a pull-down menu (not shown), in which character strings “ON,” “OFF,” and “Auto” are displayed, by clicking the pull-down button 112B. Among these character strings, “ON” is an option for a case where the setting is made to execute the frame transmission order priority control; and “OFF” is an option for a case where the setting is made to not execute the frame transmission order priority control. Furthermore, “Auto” is an option for a case where the setting is made to execute the frame transmission order priority control if the used bandwidth of the port is equal to or more than a threshold value.

Thus, the system administrator can select the option by clicking a desired option from among the options listed in this pull-down menu. Then, the then selected option is set as a priority control mode and that option is displayed in the mode display area 112A.

Meanwhile, the operation field 103 displays a “SET” button 113, a “GET” button 114, cursor movement buttons 115A, 115B, and a back button 116. Among these buttons, the “GET” button 114 is a button to make the above-mentioned various information relating to each storage tier, which is then defined in that storage apparatus 4, displayed in the tier information setting field 102. By clicking this “GET” button 114, the corresponding information can be read from the configuration information of the storage apparatus 4 stored in the shared memory 47A, 47B and can be displayed in each of the storage tier information list 110, the storage tier-external storage mapping setting field 111, and the frame transmission order priority control setting field 112.

Furthermore, the “SET” button 113 is a button to update and set the parameters displayed in each of the storage tier information list 110, the storage tier-external storage mapping setting field 111, and the frame transmission order priority control setting field 112 in the tier information setting field 102. On the number-of-stacking-frames-setting screen 100, the various settings displayed in the storage tier information list 110 can be freely changed by using, for example, a keyboard. Furthermore, the storage tier, to which the external logical unit displayed in the storage tier-external storage mapping setting field 111 belongs, and the settings of the frame transmission order priority control displayed in the frame transmission order priority control setting field 112 can be freely changed by using, for example, a mouse. Then, after making such a change, each of the aforementioned various settings can be updated and set to the changed value by clicking the “SET” button 113. When this happens, the corresponding information among the configuration information of the storage apparatus 4 stored in the shared memory 47A, 47B will be updated in the same manner.

The cursor movement button 115A, 115B is a button to move a cursor (not shown in the drawing) displayed on the storage tier information list 110 in an upward direction or a downward direction. When updating and setting the settings displayed in the storage tier information list 110 as described above, this cursor movement button 115A, 115B is operated to position the cursor to an update target line in the storage tier information list 110, so that the setting on that line can be freely changed by using, for example, the keyboard. Furthermore, the back button 116 is a button to switch the current display screen to the previous screen.

### (1-2-4-2) Write Processing at Storage Apparatus

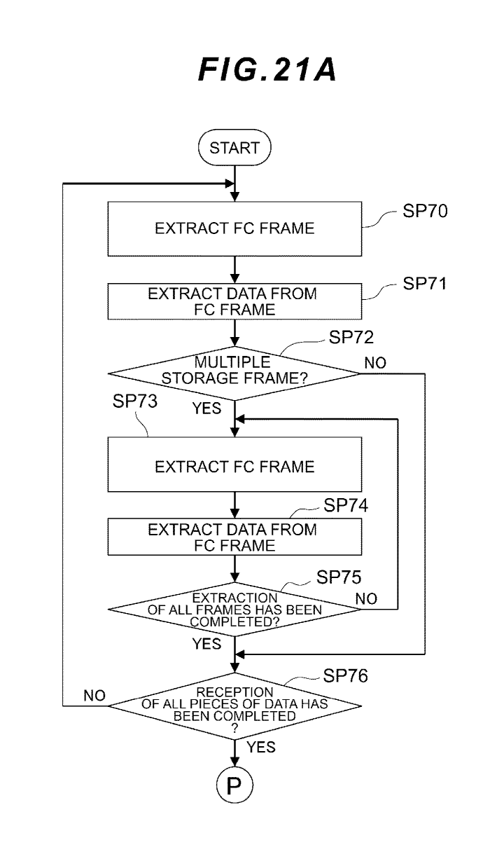

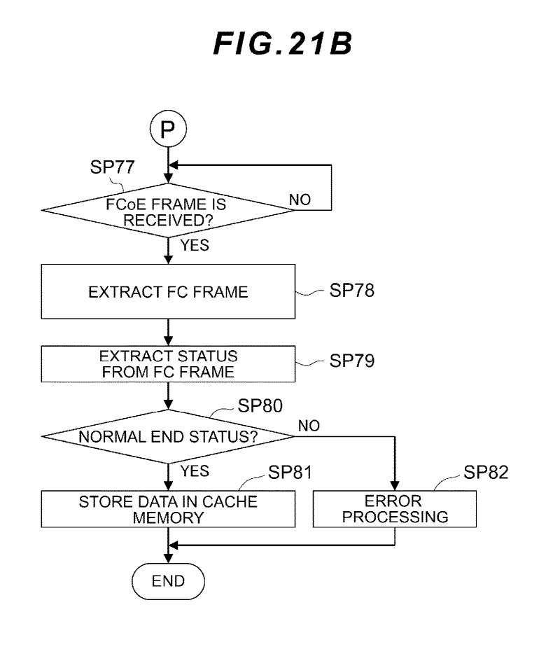

FIG. 21A and FIG. 21B show a processing sequence for write processing executed respectively by the channel adapter 42A, 42B in the storage apparatus 4 which has received an FCoE frame in which an FCP command frame for a write command is stored and which is sent from the host system 2. After receiving the FCoE frame, the channel adapter 42A, 42B writes write data to the cache memory 46A, 46B in accordance with the processing sequence shown in FIG. 21A and FIG. 21B.

Specifically speaking, after receiving the FCoE frame, the channel adapter 42A, 42B starts the write processing shown in FIG. 21A and FIG. 21B and firstly extracts one FCP data frame from an FCoE frame, which is sent after the above-mentioned FCoE frame and in which write data is comprised (SP70), and further extracts the write data from that FCP data frame (SP71).

Subsequently, the channel adapter 42A, 42B judges whether the relevant FCoE frame is a stacked (multiple FC frames encapsulated) FCoE frame or not (SP72). This judgment is performed by referring to a word included in the EOF 62E (FIG. 10) added immediately after the relevant FCP data frame in that FCoE frame, referring to the frame counter field 62F (FIG. 10) in that word, and judging whether the remaining frame counter value stored in that frame counter field 62F is a value other “0” or not.

If the channel adapter 42A, 42B obtains an affirmative judgment result for this judgment, it extracts the next FCP data frame from that FCoE frame (SP73) and further extracts the write data from that FCP data frame (SP74).

Subsequently, the channel adapter 42A, 42B judges whether the extraction of all the FCP data frames stored in the relevant FCoE frame has been completed or not (SP75). This judgment is performed by referring to a word included in the EOF 62E added immediately after the FCP data frame extracted from the FCoE frame in step SP 73 and judging whether the remaining frame counter value stored in that frame counter field 62F provided in that word is a value other “0” or not.

If the channel adapter 42A, 42B obtains a negative judgment result for this judgment, it returns to step SP73 and then repeats the processing from step SP73 to step SP75. Then, if the channel adapter 42A, 42B eventually obtains an affirmative judgment result in step SP75 by finishing extracting all the FCP data frames stored in the relevant FCoE frame, it judges whether the reception of all pieces of the write data has been completed or not (SP76).

If the channel adapter 42A, 42B obtains a negative judgment result for this judgment, it returns to step SP70 and then repeats the processing from step SP70 to step SP76. Then, if the channel adapter 42A, 42B eventually obtains an affirmative judgment result in step SP76 by finishing receiving all the pieces of the write data, it waits to receive an FCoE frame in which an FCP response frame storing the SCSI status, that is, the result of the write processing sent from the host system 2, is stored (SP77).

Then, after receiving that FCoE frame, the channel adapter 42A, 42B extracts the FCP response frame from the FCoE frame (SP78), further extracts the aforementioned SCSI status comprised in that FC frame (SP79), and then judges whether or not the extracted SCSI status is the status indicating normal end (SP80).

If the channel adapter 42A, 42B obtains an affirmative judgment result for this judgment, it stores the write data received by the processing from step SP70 to step SP76 in the cache memory 46A, 46B (SP81) and then terminates this write processing. Furthermore, if the channel adapter 42A, 42B obtains a negative judgment result in step SP80, it executes specified error processing (SP82) and then terminates this write processing.

Incidentally, the write data stored in the cache memory is written by the disk adapter 48A, 48B to the corresponding storage device 33A at later appropriate timing.

### (1-2-4-3) Read Processing at Storage Apparatus

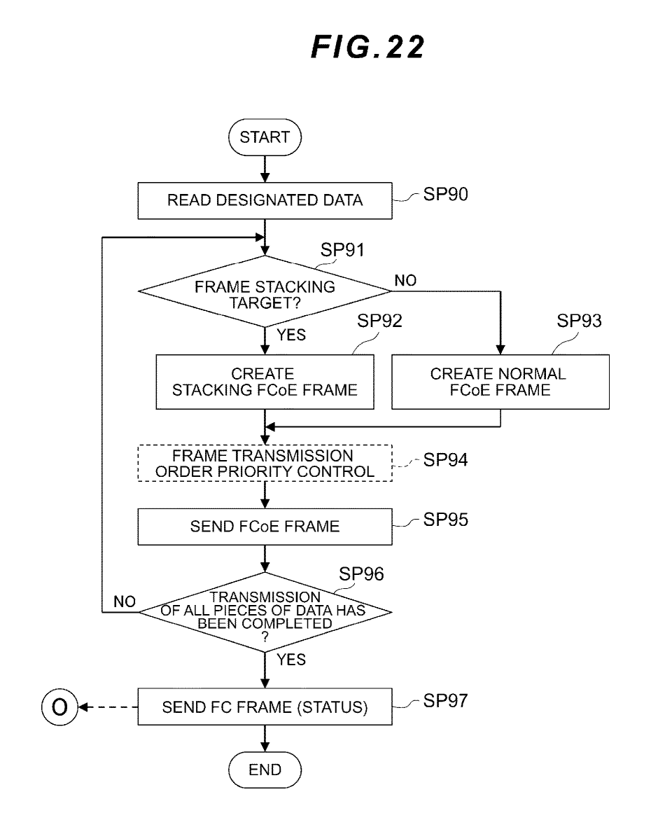

On the other hand, FIG. 22 shows a processing sequence for read data transfer processing executed by the channel adapter 42A, 42B in the storage apparatus 4 which has received an FCoE frame in which an FCP command frame for a read command sent from the host system 2 is stored. After receiving such an FCoE frame, the channel adapter 42A, 42B has the CPU 43A, 43B and the disk adapter 48A, 48B in the controller 40A, 40B transfer the designated data read from the corresponding storage device 33A to the host system 2 in accordance with the processing sequence shown in FIG. 22.

Specifically speaking, after receiving that FCoE frame, the channel adapter 42A, 42B starts the read processing shown in FIG. 22 and firstly notifies the CPU 43A, 43B that it should read the data from a storage area designated by the FCP command frame in a logical unit designated by the FCP command frame comprised in that FCoE frame; and the CPU 43A, 43B controls the disk adapter 48A, 48B. The read data is once stored in the cache memory 46A, 46B for reading data (not shown). Then, the channel adapter 42A, 42B reads the data designated in the aforementioned FCP command frame from the cache memory 46A, 46B (SP90).

Subsequently, the channel adapter 42A, 42B judges, based on the configuration information of the storage apparatus 4 stored in the shared memory 47A, 47B, whether or not the logical unit from which the data was read in step SP90 is a logical unit belonging to a storage tier to which the read data should be transferred using a stacked (multiple FC frames encapsulated) FCoE frame (SP91).

If the channel adapter 42A, 42B obtains an affirmative judgment result for this judgment, it generates FCP data frames, in which the read data read in step SP90 is stored, as many as the number of stacking frames which is set in advance for the storage tier to which the relevant logical unit belongs; and creates a stacked FCoE frame in which all those generated FCP data frames are comprised (SP72).

On the other hand, if the channel adapter 42A, 42B obtains a negative judgment result in step SP91, it generates one FCP data frame, in which the read data read in step SP90 is comprised, and creates an FCoE frame in the normal format, in which the one generated FCP data frame is stored, described earlier with reference to FIG. 9 (hereinafter referred to as the normal FCoE frame as appropriate) (SP93).

Next, while executing frame transmission order priority control as necessary (SP94), the channel adapter 42A, 42B sends the stacked FCoE frame created in step SP92 or the normal FCoE frame created in step SP93 to the host system 2 which is a transmission source of the read command.

Subsequently, the channel adapter 42A, 42B judges whether the transmission of all pieces of the read data read in step SP90 to the host system 2 has been completed or not (SP96). If the channel adapter 42A, 42B obtains a negative judgment result, it returns to step SP91. Then, the channel adapter 42A, 42B repeats the processing from step SP91 to step SP96.

Then, if the channel adapter 42A, 42B eventually obtains an affirmative judgment result in step SP96 by finishing sending all the pieces of the read data read in step SP90 to the host system 2, it creates an FCP response frame (FCP RSP), in which the SCSI status indicating the termination of transmission of the read data is comprised, creates an FCoE frame which encapsulates only this FCP response frame, and sends the created FCoE frame to the host system 2 (SP97). Then, the channel adapter 42A, 42B terminates this read processing.

### (1-2-5) Frame Transmission Order Priority Control

Next, the aforementioned frame transmission order priority control will be explained with reference to FIG. 20. The frame transmission order priority control is to control arbitration of the order to transmit stacked FCoE frames and normal FCoE frames when competing transmission requests are issued from the same port of the CNA 12 for the host system 2 (FIG. 3) and the channel adapter 42A, 42B of the storage apparatus 4 (FIG. 3) to transmit the stacked FCoE frames and the normal FCoE frames.

If such arbitration is not performed, the number of frames transferred per unit time with respect to the normal FCoE frames becomes larger than that of the stacked FCoE frames. In a worst-case situation as shown in FIG. 23, the number of FC frames transferred by normal FCoE frames 61-1 to 61-8 becomes the same as the number of FC frames transferred by stacked FCoE frames 62-10, 62-11 and, therefore, there is a possibility that the object of the present invention to assign as more bandwidth to data of greater importance may not be achieved.

So, in the case of the computer system 1 according to this embodiment, the channel adapter 42A, 42B of the storage apparatus 4 controls the transmission order of the stacked FCoE frames and the normal FCoE frames according to the following algorithm. The CNA controller 21 (to be specific, the CEE protocol processing unit 21A (FIG. 3)) of the CNA 12 for the host system 2 may be controlled in the same manner; however, unlike the storage apparatus 4 accessed by a multiplicity of host systems 21 in parallel, the configuration is often used so that one host system 2 will not access logical units in different tiers. In that case, the above-described control is not necessary. However, if accesses to the logical units in different tiers can be assumed in the environment where a plurality of virtual machines operate on one host system, the above-described control may be applied.

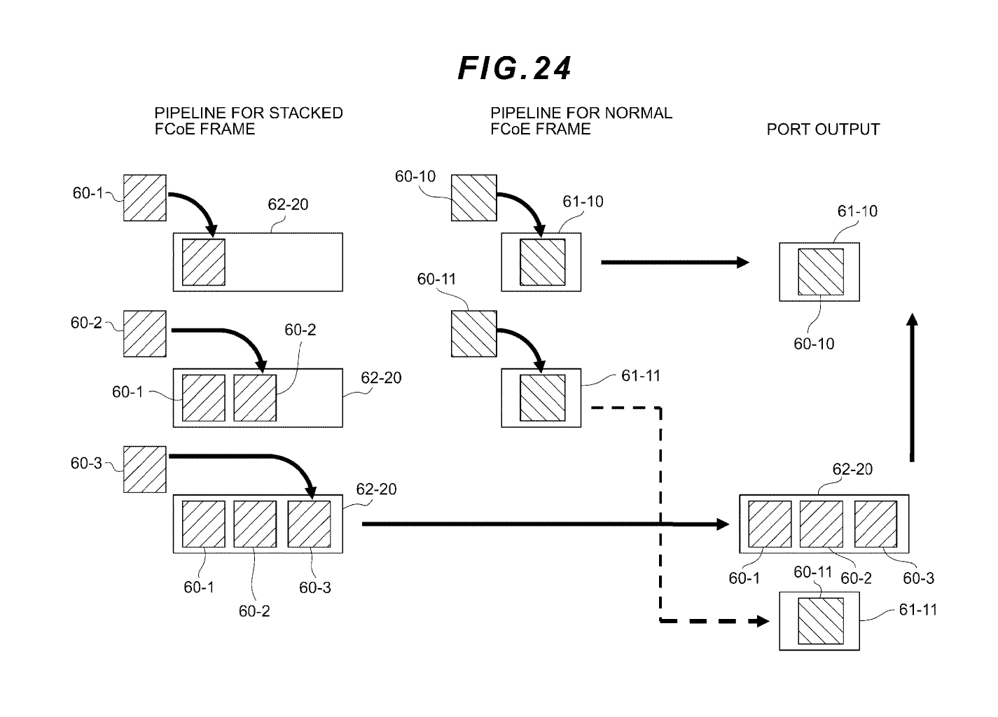

Specifically speaking, if the CEE protocol processing unit 21A and the channel adapter 42A, 42B receive an FC frame 60-10, which should be encapsulated in a normal FCoE frame 61-10, while receiving a first FC frame 60-1 among stacking target FC frames 60-1 to 60-3 as shown in FIG. 24, they may encapsulate only the FC frame 60-10, which should be encapsulated in the normal FCoE frame 61-10, in an FCoE frame and send it. However, if the CEE protocol processing unit 21A and the channel adapter 42A, 42B receive an FC frame 60-11, which should be stored in a normal FCoE frame 61-11, while receiving the FC frames 60-2, 60-3 other than the first one among the stacking target FC frames 60-1 to 60-3, transmission of the normal FCoE frame 61-11 generated by encapsulating only the FC frame 60-11 in an FCoE frame is inhibited until storage of all the stacking target FC frames 60-1 to 60-3 in the aforementioned stacked FCoE frame 62-20 is completed and transmission of the stacked FCoE frame 62-20 is completed.

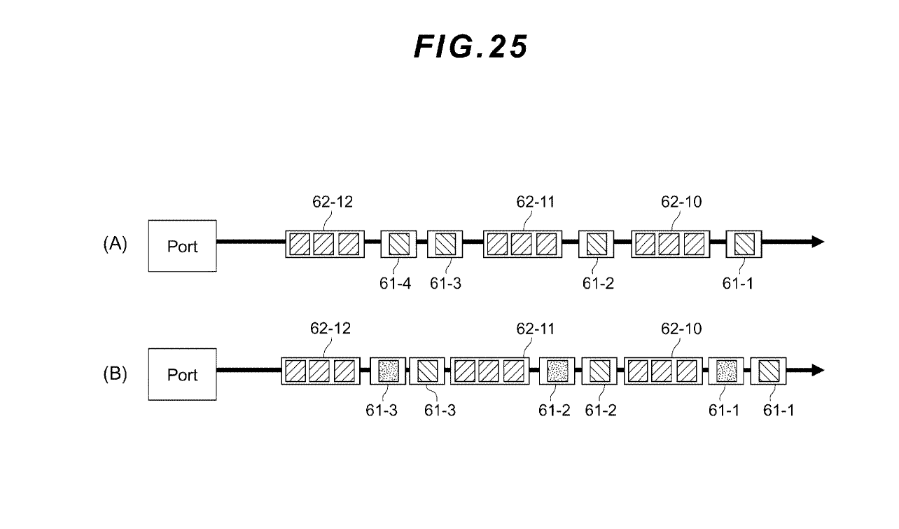

If the above-described frame transmission order priority control is performed in this case, for example, a plurality of normal FCoE frames 61-3, 61-4 may sometimes be sent while sending two stacked FCoE frames 62-11, 62-12, depending on the timing, as shown in FIG. 25(A). However, that happens only locally; and a larger data amount of the stacked FCoE frames is transferred as generally, there will be no particular problem.

Incidentally, if a plurality of FC frames whose transmission destinations are different exist on a pipeline for creating normal FCoE frames, the frame transmission may be controlled to mitigate transmission inhibiting conditions by, for example, inhibiting transmission of the normal FCoE frames only during processing of the last FC frame which should be encapsulated in the stacked FCoE frame as shown in FIG. 25. The frame transmission state when performing such control will be as shown in, for example, FIG. 25(B).

### (1-2-6) Points to Consider

When executing the multiple frame encapsulation processing described above, it is necessary to consider the relationship with a buffer capacity that is set on a PFC (Priority-based Flow Control) priority basis.

The PFC operation is designed to send a PAUSE primitive, for example, when the buffer with the priority number assigned to the FCoE does not have a buffer capacity enabling processing of frames including frames currently in a state of “in-flight.” However, if too many FC frame are comprised in one FCoE frame, there is a possibility that the buffer may be saturated even if the other end of the link seems to have a sufficient buffer capacity.

Therefore, when executing the multiple frame encapsulation processing according to this embodiment, it is necessary to set the size of the entire FCoE frame (stacked FCoE frame), in which multiple FC frames are encapsulated, to become equal to or smaller than the MTU (Maximum Transmission Unit) size of network equipment such as the FCoE switch. Furthermore, as other indications, the size of the entire FCoE frame may be set in the same manner by a method of setting a maximum value (Data Segment Length) of transmission units (segments) of iSCSI parameters for transferring jumbo frames as an upper limit or be calculated to find out what fraction of a PDU (Protocol Data Unit) size, which is a data unit handled by protocols, the size of the entire FCoE frame would be.

### (1-2-7) Relationship with Virtual Logical Unit

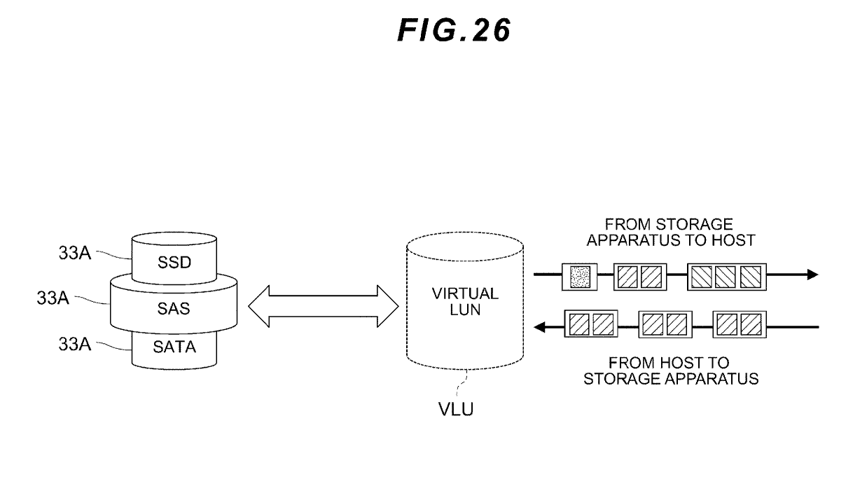

Besides the above-mentioned case where the storage tiers and the logical units can be associated with each other, there may be a case as shown in FIG. 26 where data stored in a virtual logical unit (hereinafter referred to as the virtual logical unit) VLU provided by a virtualization function (thin provisioning function) of the storage apparatus 4 is stored in the storage devices 33A in an appropriate storage tier based on characteristics (such as access frequency) of the data.

Even if the same virtual logical unit VLU is accessed from the storage apparatus 4 in the above-described case, multiple FC frames as many as the number of stacking frames corresponding to the storage tier where the data is stored can be encapsulated and sent in one FCoE frame. However, it is difficult for the CNA 12 for the host system 2 and the FCoE switch 38 (FIG. 4A) to associate with the granularity less than a logical unit. So, if the virtual logical unit receives an inquiry command from the host system 2 in the above-described case, the storage apparatus 4 may respond the tier number of the most frequently used storage tier and the number of stacking frames corresponding to that storage tier.

### (1-3) Advantageous Effects of this Embodiment

With the computer system 1 according to this embodiment described above, a plurality of FC frames as many as the number of frames determined in advance for each storage tier are encapsulated in one FCoE frame. So, the data transfer amount of data read from, or written to, a logical unit belonging to the relevant storage tier can be controlled on a storage tier basis. As a result, a computer system capable of data transfer bandwidth control on the logical unit basis or according to the relevant storage tier in the storage apparatus 4 can be realized.

### (1-4) Application Examples of First Embodiment

### (1-4-1) First Application Example

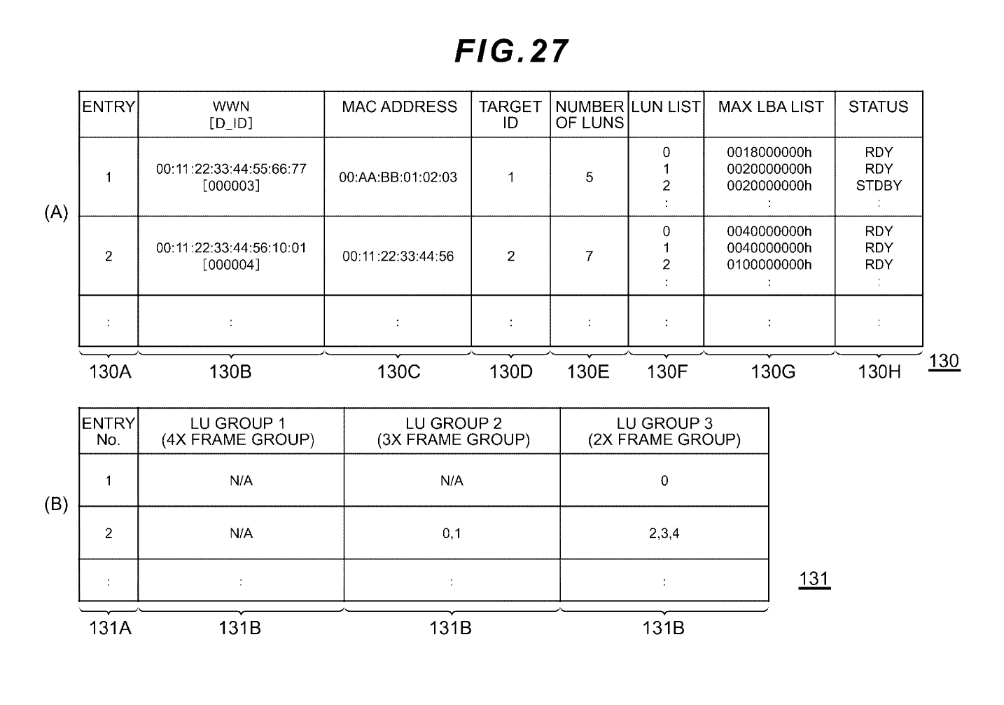

Incidentally, the aforementioned first embodiment has described the case where the host system 2 retains and manages the configuration information of the storage apparatus 4 including the obtained logical unit-storage tier association information by using the logical unit and tier association management table 70 explained earlier with reference to FIG. 11; however, the configuration information of the storage apparatus 4 may be retained and managed by two management tables 130, 131 shown in FIG. 27(A) and FIG. 27(B).

Among these two management tables 130, 131, the management table (hereinafter referred to as the target logical unit management table) 130 shown in FIG. 27(A) is a table for managing logical units that are targets for the host system 2 to read/write data; and is constituted from an entry number column 130A, a WWN column 130B, a MAC address column 130C, a target ID column 130D, an LUN column 130E, a LUN list column 130F, a MAX LBA list column 130G, and a status column 130H.

Then, the entry number column 130A, the WWN column 130B, the MAC address column 130C, the LUN column 130E, the LUN list column 130F, the MAX LBA list column 130G, and the status column 130H store the same information which are stored respectively in the entry number column 70A, the WWN column 70B, the MAC address column 70C, the LUN column 70E, the LUN list column 70F, the MAX LBA list column 70G, and the status column 70H of the logical unit and storage tier association management table 70 described earlier with reference to FIG. 11. Furthermore, the target ID column 130D stores an identifier (target ID) assigned by the host system 2 to the corresponding storage apparatus 4.

Meanwhile, the management table (hereinafter referred to as the logical unit group management table) 131 shown in FIG. 27(B) is a table for managing logical unit groups (hereinafter referred to as the logical unit groups), each of which is set corresponding to each storage tier provided in each storage apparatus 4; and is constituted from an entry number column 131A and a plurality of logical unit group columns 131B as shown in FIG. 27(B).

Then, the entry number column 131A stores the entry number assigned to the corresponding storage apparatus 4. Incidentally, regarding the same storage apparatus 4, the same entry number stored in the corresponding entry number column 130A in the target logical unit management table 130 in FIG. 27(A) is used as this entry number.

Furthermore, each logical unit group column 131B is provided corresponding to each logical unit group that will be set in each storage apparatus 4. The logical unit group herein used is a set of logical units, whose number of FC frames to be encapsulated in one FCoE frame is the same, when transferring data, which has been read from a logical unit belonging the relevant logical unit group, to the host system 2. For example, in the example shown in FIG. 27(B), a logical unit group called “LU group 1” is a group regarding which four multiple FC frames should be encapsulated in one FCoE frame; a logical unit group called “LU group 2” is a group regarding which three multiple FC frames should be encapsulated in one FCoE frame; and a logical unit group called “LU group 3” is a group regarding which two multiple FC frames should be encapsulated in one FCoE frame.

Then, each logical unit group column 131B stores the LUNs of logical units belonging to the relevant logical unit group. For example, in the case of the example shown in FIG. 27(B), regarding the storage apparatus 4 to which the entry number “2” is assigned, logical units with the LUNs “0” and “1” are set to the logical unit group called “LU group 2” and logical units with the LUNs “2” to “4” are set to the logical unit group called “LU group 3.” Therefore, when read/writing data from/to the logical unit whose LUN is “0” or “1,” read data or write data will be sent/received between the host system 2 and the storage apparatus 4 by using the stacked FCoE frame comprising three FC frames; and when read/writing data from/to the logical unit whose LUN is “2” to “4,” read data or write data will be sent/received between the host system 2 and the storage apparatus 4 by using the stacked FCoE frame comprising two FC frames.

Incidentally, “N/A” in FIG. 27(B) means that no logical unit assigned to the relevant logical unit group exists. Therefore, regarding a logical unit whose LUN is not stored in any logical unit group column, an FC frame in which data read from that logical unit is comprised is not the target of the multiple frame encapsulation processing and one FC frame is encapsulated and sent in one FCoE frame by normal packet processing.

### (1-4-2) Second Application Example

Furthermore, the aforementioned first embodiment has described the case where the FCM protocol processing unit 21D (FIG. 3) of the CNA 12 for the host system 2 sequentially obtains the number of FC frames to be encapsulated in one FCoE frame (the number of stacking frames) from the logical unit and storage tier association management table 70 described earlier with reference to FIG. 11; however, for example, the number of stacking frames for each logical unit may be set to the CNA 12 or the FC driver 27 (FIG. 3) may issue an instruction to the FCM protocol processing unit 21D of the CNA controller 21 every time the number of stacking frames is needed.

### (1-4-3) Third Application Example

Furthermore, the aforementioned first embodiment has described the case where the host system 2 obtains the number of stacking frames for each logical unit of each storage apparatus 4 by issuing a SCSI command such as an INQUIRY command to each storage apparatus 4; however, for example, when read data is sent from the storage apparatus 4, the host system 2 may obtain the number of stacking frames by learning how many FC frames are encapsulated in one FCoE frame with respect to each logical unit.

### (1-4-4) Fourth Application Example

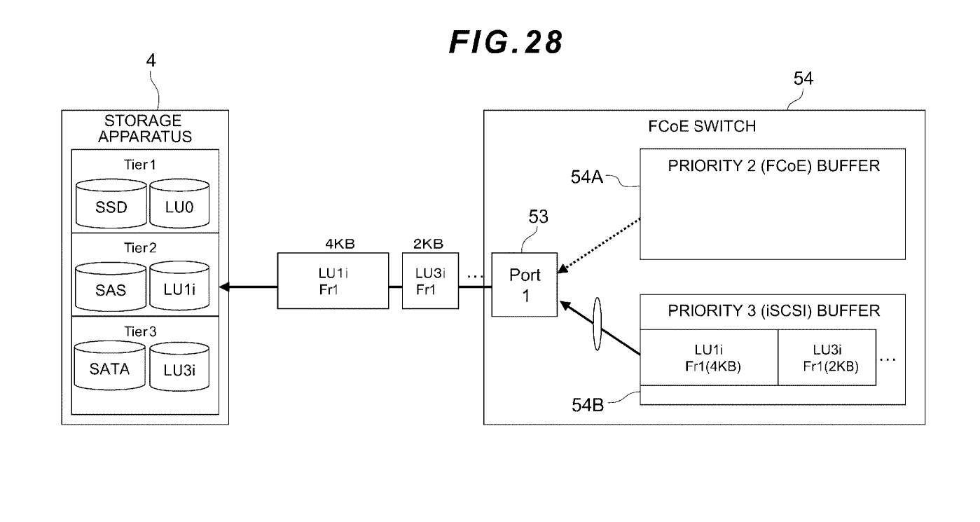

Furthermore, the aforementioned first embodiment has described the case where the number of FC frames to be encapsulated in an FCoE frame (the number of stacking frames) is variable; however, for example, also regarding the iSCSI, the data segment size of the PDU may be changed according to the storage tier to which an access target logical unit belongs as shown in FIG. 28. Therefore, as a result, the same advantageous effect as that of the multiple frame encapsulation function according to this embodiment can be obtained.

### (2) Second Embodiment

### (2-1) Configuration of Computer System according to this Embodiment

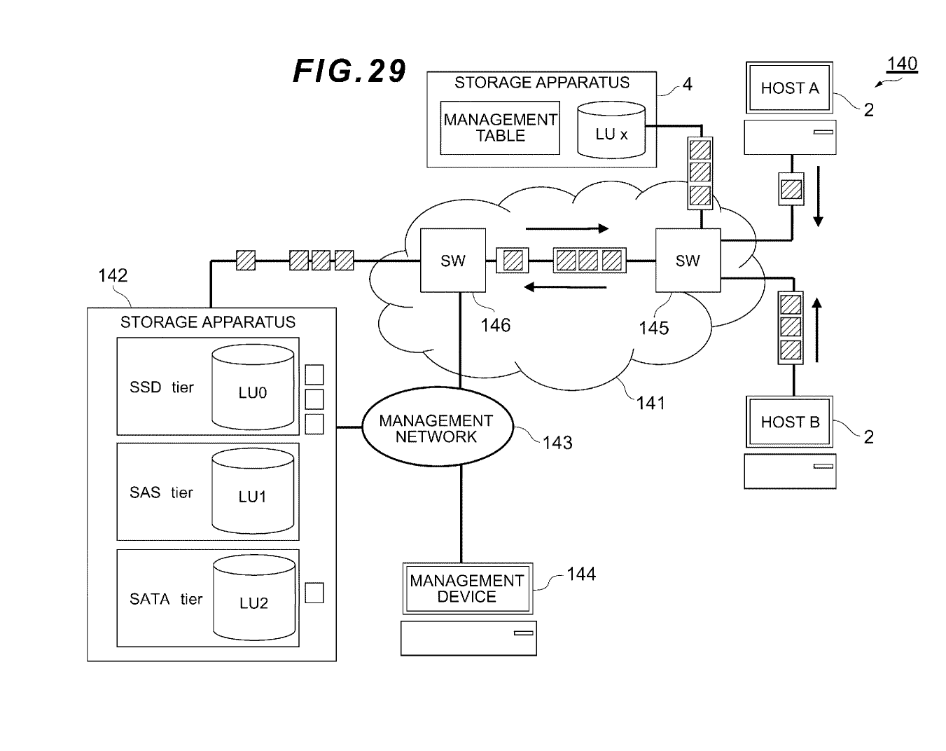

FIG. 29 in which the same reference numerals as those used in FIG. 1 are given to the parts corresponding to those in FIG. 1 shows a computer system 140 according to a second embodiment. This computer system 140 includes nodes such as a plurality of host systems 2 and a plurality of storage apparatuses 4, 142, a storage apparatus 142 described later according to this embodiment, and an FCoE switch 146 described later according to this embodiment, which are connected via a network 141; and is configured so that a management device 144 is connected via a management network 143 to the storage apparatus 142 and the FCoE switch 146.

The network 141 is composed of, for example, DCE (Data Center Ethernet) fabric and includes a plurality of FCoE switches 145, 146 as shown in FIG. 29. Among those switches, the FCoE switch 145 connected to the host system 2 and the storage apparatus 4 according to the first embodiment described earlier with reference to FIG. 1 analyzes a MAC address of a transmission destination of a received FCoE frame and transfers that FCoE frame to the host system 2 or the storage apparatus 4, 142 which is the transmission destination.

Furthermore, the FCoE switch (corresponding to the FCoE switch 38 in FIG. 3 and hereinafter referred to as the storage-side FCoE switch) 146 directly connected to the storage apparatus 142 according to this embodiment extracts FC frames from an FCoE frame, which is sent from the host system 2 to the relevant storage apparatus 142, and transfers them to the storage apparatus 142. On the other hand, the FCoE switch 146 encapsulates FC frames, which are sent from the storage apparatus 142 as described later, in an FCoE frame and sends them to the host system 2 which is the transmission destination.

The management device 144 is a computer device equipped with information processing resources such as a CPU and a memory and is composed of, for example, a personal computer, a workstation, or a mainframe. The management device 144 is equipped with management software for managing the storage apparatus 142 and collect various information about logical units and storage tiers for each storage apparatus 142 by using this management software. Furthermore, the management device 144 displays the collected various information in response to a request from the system administrator.

The storage apparatus 142 is configured in the same manner as the storage apparatus 4 according to the first embodiment, except that a channel adapter 148A, 148B for each system-0 controller 147A or system-1 controller 147B is composed of an FC interface as shown in FIG. 5. Then, the storage apparatus 142 communicates with the storage-side FCoE switch 146 by a communication method according to the FC protocol.

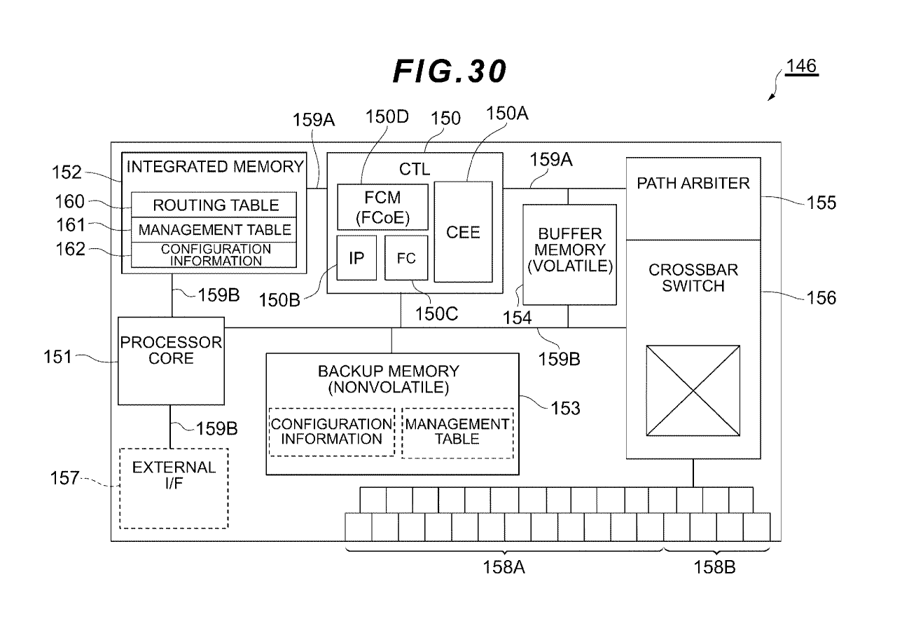

FIG. 30 shows a schematic configuration of the storage-side FCoE switch 146 according to this embodiment. As is apparent from this FIG. 30, the storage-side FCoE switch 146 is configured by including a CNA controller 150, a processor core 151, an integrated memory 152, a backup memory 153, a buffer memory 154, a path arbiter 155, a crossbar switch 156, an external interface 157, and a plurality of FCoE interface ports 158A and FC interface ports 158B.

The CNA controller 150 is connected to the integrated memory 152, the buffer memory 154, and the path arbiter 155 via a first bus 159A. This CNA controller 150 includes a plurality of protocol processing units 150A to 150C, each of which processes a main protocol such as CEE, IP, or FC, and an FCM protocol processing unit 150D for encapsulating/de-encapsulating FC frames in/from an FCoE frame. Since each protocol processing unit 150A to 150C has the same configuration and function as those of the corresponding protocol processing unit 21A to 21C of the CNA 12 described earlier with reference to FIG. 3, their explanation has been omitted here. Furthermore, the FCM protocol processing unit 150D also has the same configuration as that of the FCM protocol processing unit 21D of the CNA 12 described earlier with reference to FIG. 3 and has a multiple frame encapsulation function encapsulating a plurality of FC frames in one FCoE frame as the need arises.

The processor core 151 is connected to the integrated memory 152, the external interface 157, the backup memory 153, the CNA controller 150, the buffer memory 154, and the crossbar switch 156 via a second bus 159B and controls these devices in accordance with various programs stored in the integrated memory 152.

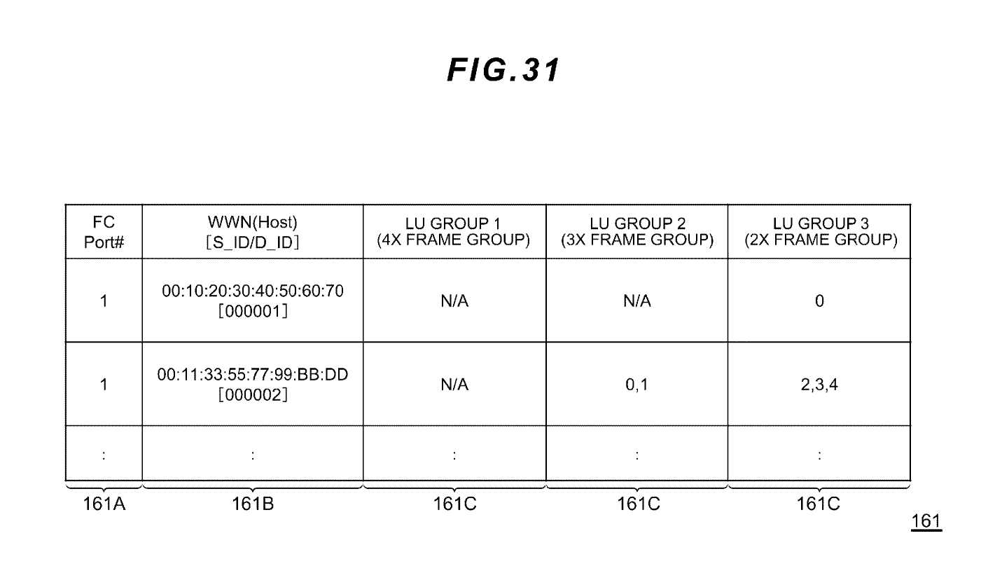

The integrated memory 152 is composed of a volatile memory and used to retain various parameters and a routing table 160. Furthermore, the integrated memory 152 also stores: a logical unit group management table 161 (FIG. 31) described later which is used when the FCM protocol processing unit 150D of the CNA controller 150 executes the multiple frame encapsulation processing; and configuration information (hereinafter referred to as the storage configuration information) 162 of the relevant storage apparatus 142 including information about the storage tiers defined in the storage apparatus 142 connected to its own switch.

The backup memory 153 is composed of a nonvolatile memory and is used to back up the aforementioned logical unit group management table 161 and storage configuration information 162 stored in the integrated memory 152. Furthermore, the buffer memory 154 temporarily stores routing target FCoE frames, which are externally provided, and is also used when the CNA controller 150 encapsulates or decapsulates FC frames in/from an FCoE frame.

The path arbiter 155 performs, for example, arbitration and crossbar switch switching when there are competing frame data read/write requests for the buffer memory 154. Furthermore, the crossbar switch 156 is a switch for switching connections between the ports and the buffer memory 154 when the FCoE interface ports 158A or the FC interface ports 158B and the buffer memory 154 exchange the FC frames and the FCoE frames.

The external interface 157 is an interface for direct access to set the storage-side FCoE switch 140.

The FCoE interface port 158A is a physical port in conformity with the CEE standards and is connected to other FCoE switches 145, 146 constituting the network 141 (FIG. 29) and other network nodes equipped with the FCoE interface ports. Furthermore, the FC interface port 158B is a physical port in conformity with the FC standards and is connected to the channel adapters 148A, 148B (FIG. 5) for the storage apparatus 142 according to this embodiment. Incidentally, for example, a freely attachable or detachable optical transceiver is used as the FC interface port 158B.

Next, the characteristics of this computer system 140 will be explained. This computer system 140 is characterized in that the storage-side FCoE switch 146 has a multiple frame encapsulation function encapsulating a plurality of FC frames in a stacked FCoE frame and decapsulating the plurality of FC frames from the stacked FCoE frame.

In fact, in the case of this embodiment, when the storage-side FCoE switch 146 receives an FCoE frame which is sent from the host system 2 and whose transmission destination is a storage apparatus to which the storage-side FCoE switch 146 itself is connected (hereinafter referred to as the connection destination storage apparatus as appropriate) 142, it extracts an FC frame from the FCoE frame and sends the extracted FC frame to the connection destination storage apparatus 142. Under this circumstance, if a plurality of FC frames are encapsulated in the FCoE frame, the storage-side FCoE switch 146 extracts all the FC frames from that FCoE frame and sends all the extracted FC frames to the connection destination storage apparatus 142.

Furthermore, when the storage-side FCoE switch 146 receives an FC frame sent from the connection destination storage apparatus 142, it encapsulates the FC frame in the FCoE frame and sends it to the corresponding host system 2. Under this circumstance, if the storage-side FCoE switch 146 is to encapsulate a plurality of FC frames in one FCoE frame (if read data stored in the FC frames has been read from a frame-stacking-target logical unit), it executes the multiple frame encapsulation processing, thereby storing the multiple FC frames as many as the number of stacking frames, which is determined in advance, in one FCoE frame and sending the thus-obtained stacked FCoE frame to the FCoE switch 145 existing on a transmission path to the host system 2 which is the transmission destination.

In this case, when the storage-side FCoE switch 146 generates the stacked FCoE frame by the multiple frame encapsulation processing as described above, it is necessary for the storage-side FCoE switch 146 to recognize which and how many FC frames should be encapsulated for multiple frames encapsulation processing. So, in the case of this embodiment, the storage-side FCoE switch 146 retains the logical unit group management table 161, in which such information is stored, in the integrated memory 152 (FIG. 30).

This logical unit group management table 161 is a table for managing logical unit groups, each of which is set in association with each storage tier to be defined in the connection destination storage apparatus 142; and is constituted from an FC port number column 161A and a host WWN column 161B as shown in FIG. 31.

Then, the FC port number column 161A stores the port number of each FC interface port 158B (FIG. 29) of the storage-side FCoE switch 146 connected to the connection destination storage apparatus 142; and the host WWN column 161B stores the WWN of the host system 2 accessing the FC interface port with the corresponding port number and the identifier assigned to that host system 2 within the FCoE switch 146.

Furthermore, the logical unit group management table 161 is provided with a plurality of logical unit group columns 161C associated with the plurality of logical unit groups, respectively. The logical unit group is a set of logical units, whose number of stacking frames to be encapsulated in one FCoE frame is the same, when transferring data, which has been read from a logical unit belonging to the relevant logical unit group, to the host system 2. For example, in the example shown in FIG. 31, a logical unit group called “LU group 1” is a group regarding which four multiple FC frames should be encapsulated in one FCoE frame; a logical unit group called “LU group 2” is a group regarding which three multiple FC frames should be encapsulated in one FCoE frame; and a logical unit group called “LU group 3” is a group regarding which two multiple FC frames should be encapsulated in one FCoE frame.

Then, each logical unit group column 161C stores the LUN of logical units belonging to the relevant logical unit group. For example, in the case of the example shown in FIG. 31, regarding the host system 2 which accesses the storage apparatus 142 connected to the FC interface port 158B with the port number “1” of the FCoE switch 146 and whose WWN (virtual WWN) is “00:11:33:55:77:99:BB:DD” (or whose S_ID of the FC frame header identified in the FCoE frame is “000002” or DID of the FC frame header sent from the storage apparatus is “000002”), it is specified that three multiple FC frames should be encapsulated in one FCoE frame with respect to the FC frames comprising read data which has been read from the logical unit whose LUN is “0” or “1”; and two multiple FC frames should be encapsulated in one FCoE frame with respect to the FC frames storing read data which has been read from the logical unit whose LUN is “2,” “3,” or “4.”

Incidentally, “N/A” in FIG. 31 means that no logical unit assigned to the relevant logical unit group exists. Therefore, regarding a logical unit whose LUN is not stored in any logical unit group column 161C, an FC frame in which data read from that logical unit is stored is not the target of the multiple frame encapsulation processing and one FC frame is encapsulated and sent in one FCoE frame by normal packet processing.

The content of this logical unit group management table 161 can be set by using a specified GUI screen (hereinafter referred to as the management table setting screen) displayed on the management device 144 (FIG. 29) by operating that management device 144. When setting the content of this logical unit group management table 161, the content which was set on the management table setting screen is reported as table setting information via the management network 143 to the storage-side FCoE switch 146 and the logical unit group management table 161 stored in the integrated memory 152 (FIG. 30) of the storage-side FCoE switch 146 is updated based on this table setting information.

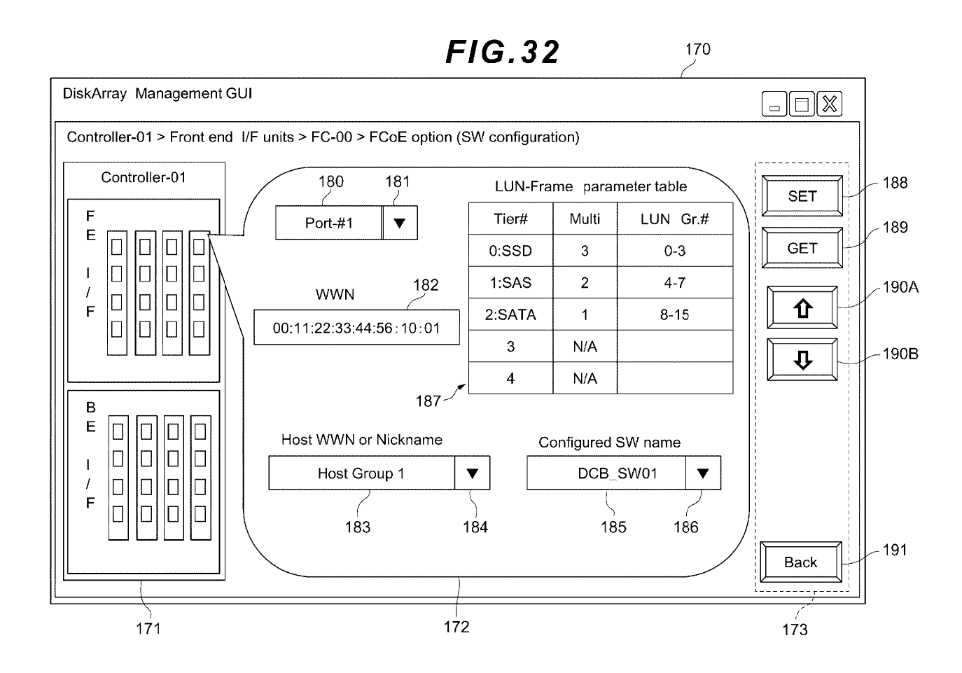

FIG. 32 shows a structure example for the management table setting screen 170. As is apparent from FIG. 32, the management table setting screen 170 is constituted from a port display field 171 provided on the left side of the screen, a parameter setting field 172 provided in the central part of the screen, and an operation field 173 which is provided on the right side of the screen and in which an operation button group is placed. Then, the port display field 171 displays a diagrammatic illustration schematically showing port groups included in the storage apparatus 142.

Furthermore, the parameter setting field 172 displays various information relating to the multiple frame encapsulation function for each port of the storage apparatus 142. In fact, the parameter setting field 172 is provided with a port number display field 180, a WWN display field 182, a host WWN or nickname display field 183, a configuration switch name field 185 indicating the name of a setting target switch connected to the relevant port, and a logical unit-frame parameter table field 187.

A pull-down button 181 is provided to the right of the port number display field 180; and a pull-down menu (not shown) in which all the port numbers of the respective ports of the storage apparatus 142 are listed is displayed by clicking this pull-down button 181.

Thus, the system administrator can select the port number by clicking the port number of a desired port among the port numbers displayed in this pull-down menu. The port number then selected is displayed in the port number display field 180. Furthermore, when this happens, the WWN display field 182 displays the WWN assigned to that port and the host WWN or nickname display field 183 displays, a nickname or the like assigned to a group of host systems 2 (hereinafter referred to as the host group) to which the relevant host system 2 belongs. Specifically speaking, the host group is to remove the burden of setting every detail of LUN mapping information set for each individual host system 2 and the corresponding status of the storage tiers; and by grouping the host systems 2 for which the same number of stacking frames is set to each storage tier, batched settings can be made to entries of all the host systems belonging to the relevant group in the logical unit group management table 161 based on the configuration information from the storage apparatus (the settings are made for each entry of the individual host systems 2 to the logical unit group management table 161 in the setting target switch).

Furthermore, a pull-down button 186 is provided to the right of the configuration switch name field 185; and a pull-down menu (not shown), in which all names of the storage-side FCoE switches 146 connected along the path to the port with the port number displayed in the port number display field 180 are listed, is displayed by clicking this pull-down button 186.

Thus, the system administrator can select the storage connection FCoE 146, whose settings are to be changed at that time, by clicking the name of a desired storage-side FCoE switch 146 among the names listed in this pull-down menu. Then, the name of the then-selected storage connection FCoE 146 is displayed in the configuration switch name field 185.

Furthermore, the logical unit—frame parameter table field 187 displays information about, for example, the LUNs of logical units belonging to each storage tier among logical units in the storage apparatus 142 connected to the port whose port number is displayed in the port number display field 180. In fact, the logical unit-frame parameter table field 187 may configures, for each storage tier, the tier number of the relevant storage tier, the type of storage devices providing storage areas of logical units belonging to the relevant storage tier, the number of FC frames to be encapsulated in one FCoE frame, and the LUN of each logical unit belonging to the relevant storage tier.

Therefore, for example, the example in FIG. 32 shows that regarding the storage apparatus 142, the WWN of the port to which the port number “1 (Port#1)” is assigned is “00:11:22:33:44:56:10:01”; the identifier of a host group accessing that port is “Host Group 1”; and the switch name of the currently selected storage-side FCoE switch 146 among the storage-side FCoE switches 146 connected to that port is “DCB_SW01.”

Furthermore, the example in this FIG. 32 shows that among the logical units connected to the port, to which the port number “1” is assigned, of the then target storage apparatus 142, logical units with the LUNs “0-3” belong to a storage tier whose tier number is “0” and whose storage area is provided by “SSD,” logical units with the LUNs “4-7” belong to a storage tier whose tier number is “1” and whose storage area is provided by “SAS,” and logical units with the LUNs “8-15” belong to a storage tier whose tier number is “2” and whose storage area is provided by “SATA.”

Furthermore, the example in this FIG. 32 shows that the number of frames, that is, the number of multiple FC frames to be encapsulated in one FCoE frame when reading/writing data from/to the logical units belonging to the storage tier with the tier number “0” is “3”; the number of frames, that is, the number of multiple FC frames to be encapsulated in one FCoE frame when reading/writing data from/to the logical units belonging to the storage tier with the tier number “1” is “2”; and the number of frames, that is, the number of multiple FC frames to be encapsulated in one FCoE frame when reading/writing data from/to the logical units belonging to the storage tier with the tier number “2” is “1.”

The operation field 173 displays a “SET” button 188, a “GET” button 189, cursor movement buttons 190A, 190B, and a back button 191. Among these buttons, the “GET” button 189 is a button to make various information collected and internally retained by the management device 144 from the storage apparatus 142 with respect the port, whose port number is then displayed in the port number display field 180, displayed in the logical unit-frame parameter table field 187 in the parameter setting field 172.

Furthermore, the “SET” button 188 is a button to update and set various parameters displayed in, for example, the logical unit-frame parameter table field 187 in the parameter setting field 172. Specifically speaking, in the case of this embodiment, the various parameters displayed in the logical unit-frame parameter table field 187 in the parameter setting field 172 can be freely changed by using, for example, a mouse and a keyboard; and by clicking the “SET” button 188 after making such a change, these parameters can be sent as the aforementioned table setting information to the storage-side FCoE switch 146 and the content of the logical unit group management table 161, which is stored in the integrated memory 152 in that storage-side FCoE switch 146, can be updated and set to the changed content based on the relevant table setting information.

The cursor movement button 190A, 190B is a button to move a cursor (not shown in the drawing) displayed on the logical unit—frame parameter table field 187 in an upward direction or a downward direction. When updating and setting the parameters displayed in the logical unit—frame parameter table field 187 as described above, this cursor movement button 190A, 190B is operated to position the cursor in the logical unit-frame parameter table field 187 to an update target line, so that the parameter on that line can be freely changed by using, for example, the keyboard. Furthermore, the back button 191 is a button to switch the current display screen to the previous screen (not shown).

### (2-2) Processing of FCoE Switch relating to Multiple Frame Encapsulation Function

Next, the processing content of various processing executed by the storage-side FCoE switch 146 with respect to the multiple frame encapsulation function will be explained. When doing so, firstly, the configuration of a frame header of a general FC frame (hereinafter referred to as the FC frame header as appropriate) and the configuration of payload of a general FCP command frame (hereinafter referred to as the FCP command frame payload as appropriate) will be explained.

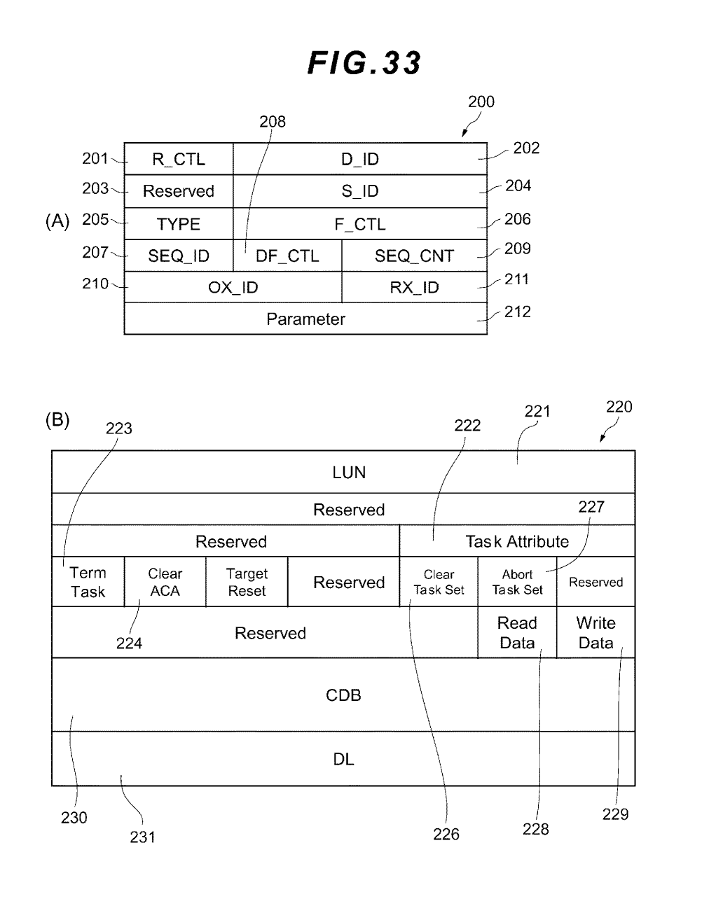

FIG. 33(A) shows a schematic configuration (DWORD ordered basis) of a general FC frame header 200. As shown in this FIG. 33(A), the FC frame header 200 is configured by including various information such as routing control information (R_CTL) 201, transmission destination address (D_ID) 202, transmission source address (S_ID) 204, a type (TYPE) 205, frame control information (F_CTL) 206, sequence number (SEQ_ID) 207, data field control information (DF_CTL) 208, sequence count information (SEQ_CNT) 209, a first exchange number (OX_ID) 210, and a second exchange number (RX_ID) 211.

Among these pieces of information, the routing control information (R_CTL) 201 is information indicating the type of that frame and attributes of data in relation to other fields. Furthermore, the transmission destination address (D_ID) 202 indicates the address of a transmission destination of the relevant FC frame; and the transmission source address (S_ID) 204 indicates the address of a transmission source of the relevant FC frame.

Furthermore, the type (TYPE) 205 is information indicating the type of a data structure showing what type of data is to be transmitted in relation to the routing control information (R_CTL) 201; and the frame control information (F_CTL) 206 is information indicating attributes of a sequence and exchange.

Furthermore, the sequence number (SEQ_ID) 207 indicates a unique number assigned to the sequence; and the data field control information (DF_CTL) 208 indicates the data length of an optional header when the optional header is used.

Furthermore, the sequence count information (SEQ_CNT) 209 is information indicating the order of the relevant FC frame in one sequence; and the first exchange number (OX_ID) 210 and the second exchange number (RX_ID) 211 indicate an exchange number issued by an originator and an exchange number issued by a responder, respectively.

Furthermore, FIG. 33(B) shows a schematic configuration (BYTE ordered basis) of payload of a general FCP command frame (FCP CMND frame) (hereinafter referred to as the FCP command frame payload as appropriate) 220. As shown in this FIG. 33(B), the FCP command frame payload 220 is configured by including various information such as an LUN (LUN) 221, task attribute information (Task Attribute) 222, task termination information (Term Task) 223, clear ACA information (Clear ACA) 224, target reset information (Target Reset) 225, clear task set information (Clear Task Set) 226, abort task set information (Abort Task Set) 226, direction of data transfer by reading (Read Data) 227, direction of data transfer by writing (Write Data) 228, CDB (CDB) 229, and data length (DL) 230.

Among these pieces of information, the LUN (LUN) 221 indicates the LUN of an access target logical unit; and the task attribute information (Task Attribute) 222 indicates the designation of a queue type of a command queue management request.

Furthermore, the task termination information (Term Task) 223 indicates a forced task termination instruction; and the clear ACA (Clear ACA) 224 indicates a clear instruction in an ACA (Auto Contingent Allegiance) state. Furthermore, the target reset information (Target Reset) 225 indicates a target reset instruction; and the clear task set information (Clear Task Set) 226 indicates an instruction to clear all queued commands. Furthermore, the abort task set information (Abort Task Set) 227 indicates an instruction to clear a queued specific command.

Moreover, the Read Data 227 and the Write Data 229 are used to specify a data transfer direction; and, for example, if the Read Data 227 is set, it means that the data will be transferred from the target to the initiator; and if the Write Data 229 is set, it means that the data will be transferred in an opposite direction.

Furthermore, the CDB (Command Descriptor Block) 230 is a body of a SCSI command (e.g. READ command or WRITE command) stored in the relevant FCP command frame; and the data length (DL) 231 indicates the data length of read data or write data to be transferred by read processing or write processing in accordance with such a SCSI command.

When transferring FC frames comprised in an FCoE frame, which has been sent from the host system 2, to the connection destination storage apparatus 142 based on the above-described premise, the storage-side FCoE switch 146 continually monitors the routing control information (R_CTL) 201 of the FC frame header 200 of the relevant FC frame.

Then, if the routing control information (R_CTL) 201 is a value (06h) indicating an FCP command frame and the transmission source address (S_ID) 204 of the FC frame header 200 exists in any of the WWN column 161B (FIG. 31) in the logical unit group management table 161 (FIG. 31), the storage-side FCoE switch 146 obtains the LUN (LUN) 221 of the access-target logical unit, a SCSI command (CDB (CDB) 230) whose target is the relevant logical unit, and the data length (DL) 231 of then accessed data from the FCP command frame payload 220 (FIG. 33(B)) of the relevant FC frame.

Furthermore, the storage-side FCoE switch 146 judges, based on the LUN obtained from the FCP command frame payload 220 obtained above and the logical unit group management table 161 described earlier with reference to FIG. 31, whether the access-target logical unit is a frame-stacking-target logical unit or not.

Then, if the logical unit is a frame-stacking-target logical unit, the storage-side FCoE switch 146 judges whether or not the SCSI command at that time is a read command and the data length of read data exceeds one payload length (2112 [Bytes]). If the storage-side FCoE switch 146 obtains an affirmative judgment result for this judgment, it monitors the FC frame header 200 (FIG. 33(A)) of each FC frame sent in response to the relevant FCP command frame from the connection destination storage apparatus 142 which is the transmission source of the relevant FCP command frame.

Then, if the value of the routing control information (R_CTL) 201 of the FC frame header 200 is a value (01h) indicating an FCP data frame and the relevant transmission destination address (D_ID) 202 is identical to the transmission source address (S_ID) 204 of the previous FCP command frame and the first exchange number (OX_ID) 210 is determined to be a response for the previous FCP command frame which is the target of the multiple frame encapsulation processing, the storage-side FCoE switch 146 executes the multiple frame encapsulation processing for encapsulating those multiple FC frames as many as a specified number of frames in one FCoE frame and sends the obtained stacked FCoE frame to the corresponding host system 2.

### (2-3) Read Processing at Host System

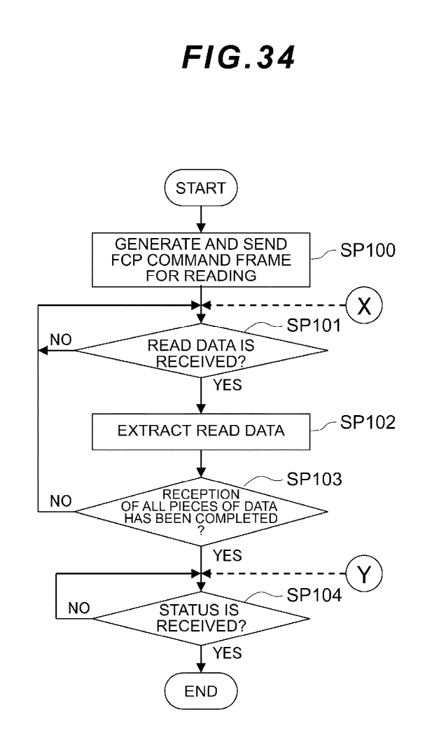

FIG. 34 shows a processing sequence for read processing executed by the host system 2 when the host system 2 reads data from the storage apparatus 142 (hereinafter referred to as the host-side read processing). Incidentally, since the host system 2 according to this embodiment has the same configuration as that of the host system 2 according to the first embodiment, the details of processing executed by the CNA 12 (FIG. 3) and the FC driver 27 (FIG. 3) and the SCSI driver 26 (FIG. 3) in the host system 2 are the same as those of the processing described earlier with reference to FIG. 16 to FIG. 18; and FIG. 34 shows the processing sequence for the read processing by the host system 2 as a whole in a simplified manner by summarizing FIG. 16 to FIG. 18.

Specifically speaking, for example, when the need arises to read data stored in the storage apparatus 142 in response to the operation by the user or a request from applications, the host system 2 starts this host-side read processing shown in FIG. 34; and firstly generates an FCP command frame for a read command, encapsulates the generated FCP command frame, and then sends the thus obtained FCoE frames to the storage apparatus 142 (SP100).

Subsequently, the host system 2 waits for the corresponding read data to be sent from the storage apparatus 142 as a response result of the read command stored in the aforementioned FCP command frame (SP101). When eventually receiving the FCoE frame comprising the read data, the host system 2 extracts the FC frames (FCP DATA frames) form the relevant FCoE frame and extracts the read data from the FC frames (SP102).

Subsequently, the host system 2 judges whether the reception of all pieces of the read data has been completed or not (SP103); and if it obtains a negative judgment result, it returns to step SP101. Furthermore, the host system 2 then repeats a loop from step SP101 to step SP103 and back to step SP101 until it finishes receiving the read data.

Then, if the host system 2 obtains an affirmative judgment result in step SP103 by finishing receiving all the pieces of the read data, it waits for an FCoE frame, in which an FCP response frame (FCP RSP frame) storing the SCSI status indicating the completion of the read processing is encapsulated, to be sent from the storage apparatus 142 (SP104). Then, when the host system 2 eventually receives the SCSI status, it terminates this host-side read processing.

### (2-4) Frame Reception Processing at Storage-side FCoE Switch

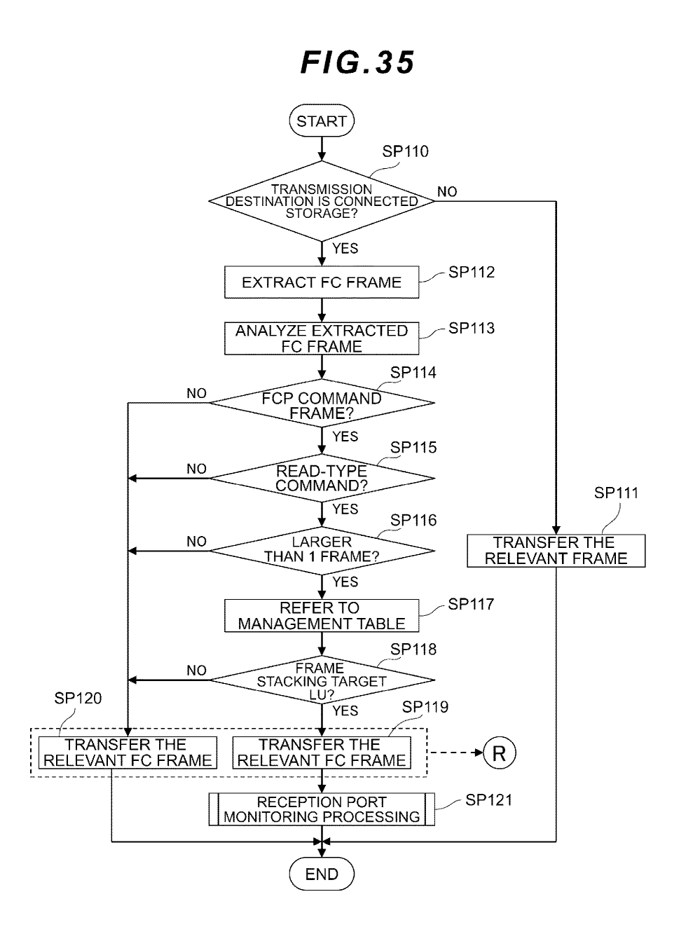

Now, FIG. 35 shows a processing sequence for frame reception processing executed by the FCM protocol processing unit 150D (FIG. 30) of the CNA controller 150 for the storage-side FCoE switch 146, which has received the FCoE frame from the host system 2.

After receiving the FCoE frame sent from the host system 2, the FCM protocol processing unit 150D starts this frame reception processing and firstly judges whether the transmission destination of the received FCoE frame is the connection destination storage apparatus 142 or not, based on the destination of the FCoE frame (SP110).

If the FCM protocol processing unit 150D obtains a negative judgment result for this judgment, it outputs the relevant FCoE frame from the corresponding FCoE interface port 158A toward the transmission destination of the relevant FCoE frame (SP111) and then terminates this frame reception processing.

On the other hand, if the FCM protocol processing unit 150D obtains an affirmative judgment result in step SP110, it extracts an FC frame from the received FCoE frame (SP112) and analyzes the FC frame header 200 (FIG. 33(A)) and the FCP command frame payload 220 (FIG. 33(B)) of the extracted FC frame (SP113). Then, the FCM protocol processing unit 150D judges, based on the analysis result in step SP113, whether or not the FC frame extracted in step SP112 is an FCP command frame storing a SCSI command (SP114).

If the FCM protocol processing unit 150D obtains a negative judgment result for this judgment, it transfers the FC frame extracted from the FCoE frame in step SP112 to the connection destination storage apparatus 142 (SP120) and then terminates this frame reception processing.

On the other hand, if the FCM protocol processing unit 150D obtains an affirmative judgment result in step SP114, it judges whether the SCSI command is a read-related command requiring data transfer from the storage apparatus 142. (SP115). Then, If the FCM protocol processing unit 150D obtains a negative judgment result for this judgment, it transfers the FC frame extracted from the FCoE frame in step SP112 to the connection destination storage apparatus 142 (SP120) and then terminates this frame reception processing.

On the other hand, if the FCM protocol processing unit 150D obtains an affirmative judgment result in step SP115, it judges whether the data length of the read data to be transferred from the connection destination storage apparatus 142 to the host system 2 is larger than the data length that can be stored in one normal FC frame or not (SP116). This judgment is performed based on the data length (DL) 231 (FIG. 33(B)) read from the FCP command frame payload 220 (FIG. 33(B)) as described above.

A negative judgment result for this judgment means that subsequently the read data to be sent from the connection destination storage apparatus 142 to the host system 2 can be transferred in one FC frame and it is unnecessary to stack a plurality of FC frames in one FCoE frame by means of the multiple frame encapsulation processing. Thus, when such a negative judgment is returned, the FCM protocol processing unit 150D transfers the FC frame, which was extracted from the FCoE frame in step SP112, to the connection destination storage apparatus 142 (SP120) and then terminates this frame reception processing.

On the other hand, an affirmative judgment result in step SP116 means that subsequently, the data to be transferred from the connection destination storage apparatus 142 to the host system 2 cannot be transferred in one FC frame and, therefore, a plurality of FC frames need to be encapsulated in one FCoE frame by means of the multiple frame encapsulation processing as the need arises. Thus, when such an affirmative judgment is returned, the FCM protocol processing unit 150D refers to the logical unit group management table 161 (FIG. 31) (SP117) and then judges whether the logical unit which was designated as a read destination in the read command stored in the FC frame (FCP command frame in this case) extracted from the FCoE frame in step SP112 is a frame-stacking-target logical unit or not (SP118).

If the FCM protocol processing unit 150D obtains a negative judgment result for this judgment, it transfers the relevant FC frame to the connection destination storage apparatus 142, which is the transmission destination (SP120), and then terminates this frame reception processing.

On the other hand, if the FCM protocol processing unit 150D obtains an affirmative judgment result in step SP118, it transfers the relevant FC frame to the connection destination storage apparatus 142, which is the transmission destination (SP119), then sets a mode to execute reception port monitoring processing for monitoring the FC interface port 158B (FIG. 30) connected to the connection destination storage apparatus 142 (SP121), and terminates this frame reception processing.

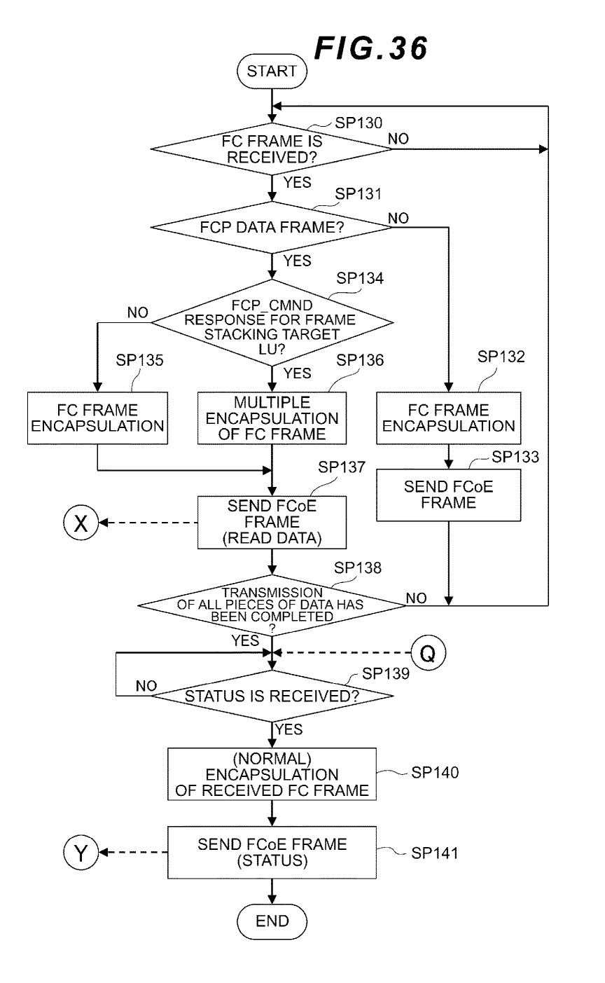

FIG. 36 shows a processing sequence for the reception port monitoring processing executed by the FCM protocol processing unit 150D, which was set in step SP121 of the above-described frame reception processing. Incidentally, in a mode where that monitoring processing is not executed, processing for encapsulating the FC frame, which is sent from the storage apparatus 142, in a normal FCoE frame will be executed.

The FCM protocol processing unit 150D firstly waits for the FC frame (FCP DATA frame) comprising the read data to be delivered to the FC interface port (hereinafter referred to as the monitoring target port) 158B which is a monitoring target connected to the relevant storage apparatus 142 (SP130).

Then, when the FC frame is delivered from the connection destination storage apparatus 142 to the monitoring target port, the FCM protocol processing unit 150D judges whether the relevant FC frame is an FCP data frame or not (SP131). Then, if the FCM protocol processing unit 150D obtains a negative judgment result for this judgment, it encapsulates the relevant FC frame in an FCoE frame (SP132), sends the relevant FCoE frame (SP133), and returns to step SP130.

On the other hand, if the FCM protocol processing unit 150D obtains an affirmative judgment result in step SP131, it judges whether or not the then received FCP data frame is an FCP data frame which is a response for a read command whose read destination is a farme-stacking-target logical unit (SP134).

Specifically speaking, the FCM protocol processing unit 150D judges in this step SP134 whether or not the first exchange number (OX_ID) 210 indicated in the FC header in FIG. 33(A) matches the first exchange number (OX_ID) 210 of the FC header of the FCP command frame which was sent before and was the target of the multiple frame encapsulation processing.

Thus, if the FCM protocol processing unit 150D obtains a negative judgment result in step SP134, it encapsulates the relevant FC frame in an FCoE frame (SP135) and then proceeds to step SP137. Furthermore, if the FCM protocol processing unit 150D obtains an affirmative judgment result in step SP134, it refers to the logical unit group management table 161, encapsulates the FC frames as many as the predefined number of frames in one FCoE frame (SP136) and then proceeds to step SP137.

Subsequently, the FCM protocol processing unit 150D sends the FCoE frame created in step SP135 or step SP136 to the corresponding host system 2 (SP137) and judges whether the transmission of all pieces of the read data to the relevant host system 2 has been completed or not (SP138).

If the FCM protocol processing unit 150D obtains a negative judgment result for this judgment, it returns to step SP130 and then repeats the processing from step SP130 to step SP138. Then, if the FCM protocol processing unit 150D eventually obtains an affirmative judgment result in step SP136 by finishing sending all the pieces of the read data to the host system 2, it waits for an FCP response frame (FCP RSP frame) comprising the SCSI status indicating the read processing to be sent from the connection destination storage apparatus 142 (SP139).

Then, when the FCM protocol processing unit 150D eventually receives such an FC frame (FCP RSP frame), it encapsulates the received FC frame in an FCoE frame (SP140), sends this FCoE frame to the corresponding host system 2 (SP141), and then terminates this reception port monitoring processing (returns to the normal mode).

### (2-5) Read Processing at Storage Apparatus

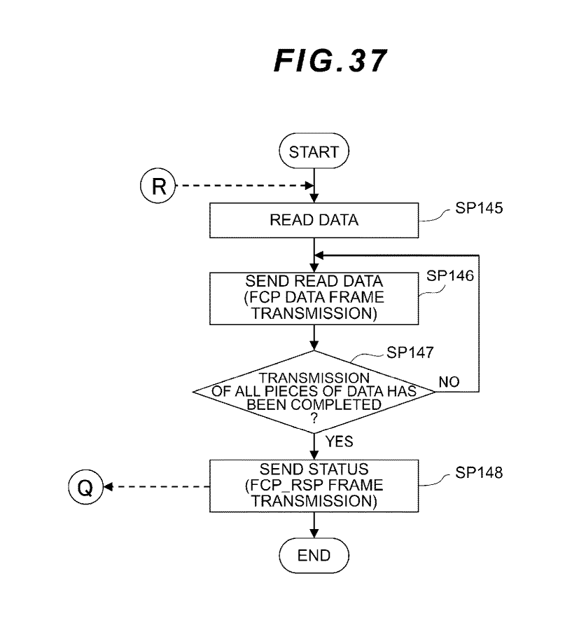

On the other hand, FIG. 37 shows a processing sequence for read processing executed by the channel adapter 148A, 148B for the storage apparatus 142 which has received the FCP command frame storing the read command, which was sent from the storage-side FCoE switch 146 in step SP120 or step SP119 of the frame reception processing described earlier with reference to FIG. 35 (hereinafter referred to as the storage-apparatus-side read processing).

When the channel adapter 148A, 148B receives such an FCP command frame, it starts this storage-apparatus-side read processing and firstly reads data from a storage area corresponding to the logical block designated in the CDB 230 of the relevant FCP command frame payload 220 in the logical unit designated in the FCP command frame payload 220 (FIG. 33(B)) of the relevant FCP command frame (SP145). Then, the channel adapter 148A, 148B stores the read data in an FC frame, whose transmission destination is the corresponding host system 2, and sends it to the storage-side FCoE switch 146 (SP146).

Subsequently, the channel adapter 148A, 148B judges whether the transmission of all pieces of the read target data designated in the CDB 230 of the FCP command frame payload 220 to the host system 2 has been completed or not (SP147). Then, if the channel adapter 148A, 148B obtains a negative judgment result for this judgment, it returns to step SP146 and then repeats a loop from step SP146 to step SP147 and back to step SP146.

Then, when the channel adapter 148A, 148B eventually finishes sending all the pieces of the designated read target data to the host system 2, it sets the SCSI status indicating the result of the relevant read processing in an FCP response frame (FCP RSP frame) and sends it to the host system 2 (SP148), and then terminates this storage-apparatus-side read processing.

### (2-6) Write Processing at Host System, Storage-side FCoE Switch, and Storage Apparatus

Since a processing sequence for write processing at the host system 2 is the same as the first embodiment described earlier with reference to FIG. 13 to FIG. 15, its explanation has been omitted here. Furthermore, since a processing sequence for write processing at the storage apparatus 142 is the same as the write processing executed at a storage apparatus equipped with a normal FC interface port, its explanation has been omitted here.

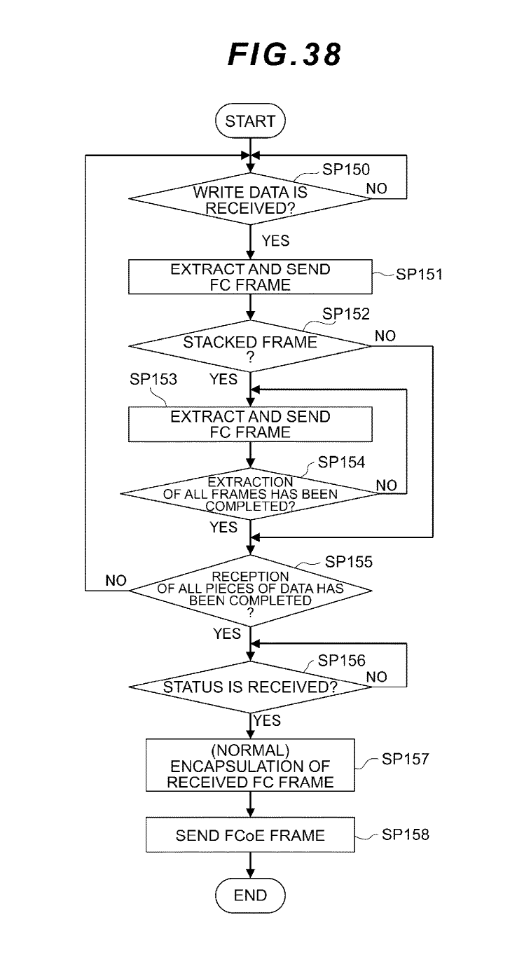

On the other hand, FIG. 38 shows a processing sequence for write processing executed by the FCM protocol processing unit 150D of the CNA controller 150 for the storage-side FCoE switch 146. After the FCM protocol processing unit 150D receives an FCoE frame in which an FCP command frame storing a write command sent from the host system 2 to the connection destination storage apparatus 142 as a write destination is encapsulated, it extracts the FCP command frame from the relevant FCoE frame, sends it to the connection destination storage apparatus 142, starts the write processing (hereinafter referred to as the switch-side write processing) shown in FIG. 38, and firstly waits for receiving an FCoE frame comprising write data (FCP data frame) to be sent from the relevant host system 2 (SP150).

Then, when the FCoE frame comprising the write data is eventually delivered from the host system 2, the FCM protocol processing unit 150D extracts an FC frame (FCP data frame) from the relevant FCoE frame and sends the extracted FC frame to its transmission destination, that is, the connection destination storage apparatus 142 (SP151).

Subsequently, the FCM protocol processing unit 150D judges whether or not a plurality of FC frames are encapsulated in that FCoE frame (SP152). This judgment is performed by judging whether or not a value (other than “0”) is set to the frame counter field 62F (FIG. 10) associated with the FC frame extracted in step SP151 with respect to the relevant FCoE frame.

Then, if the FCM protocol processing unit 150D obtains a negative judgment result for this judgment, it proceeds to step SP155. On the other hand, if the FCM protocol processing unit 150D obtains an affirmative judgment result for this judgment, it extracts the next FC frame from the relevant FCoE frame and sends the extracted FC frame to its transmission destination, that is, the connection destination storage apparatus 142 (SP153).

Subsequently, the FCM protocol processing unit 150D judges whether the extraction of all the FC frames comprised in the relevant FCoE frame has been completed or not (SP154). This judgment is performed by judging whether the remaining frame counter value stored in the frame counter field 62F corresponding to the FC frame extracted in step SP153 is “0” or not.

If the FCM protocol processing unit 150D obtains a negative judgment result for this judgment, it returns to step SP153 and then repeats a loop from step SP153 to step SP154. Then, if the FCM protocol processing unit 150D eventually obtains an affirmative judgment result in step SP154 by finishing extracting and sending all the FC frames comprised in the relevant FCoE frame, it judges whether the reception of all pieces of the write data has been completed or not (SP155).

If the FCM protocol processing unit 150D obtains a negative judgment result for this judgment, it returns to step SP150 and then repeats the processing from step SP150 to step SP155. Then, if the FCM protocol processing unit 150 eventually obtains an affirmative judgment result in step SP155 by finishing sending all the pieces of the received write data, it waits for receiving an FCP response frame (FCP RSP frame) comprising the SCSI status indicating the result of the write processing to be sent from the connection destination storage apparatus 4 (SP156).

Then, when the FCM protocol processing unit 150D eventually receives such an FCP response frame, it encapsulates the relevant FC frame and thus sends the obtained FCoE frame to the corresponding host system 2, and then terminates this switch-side write processing.

### (2-7) Frame Transmission Order Priority Control at Storage Apparatus

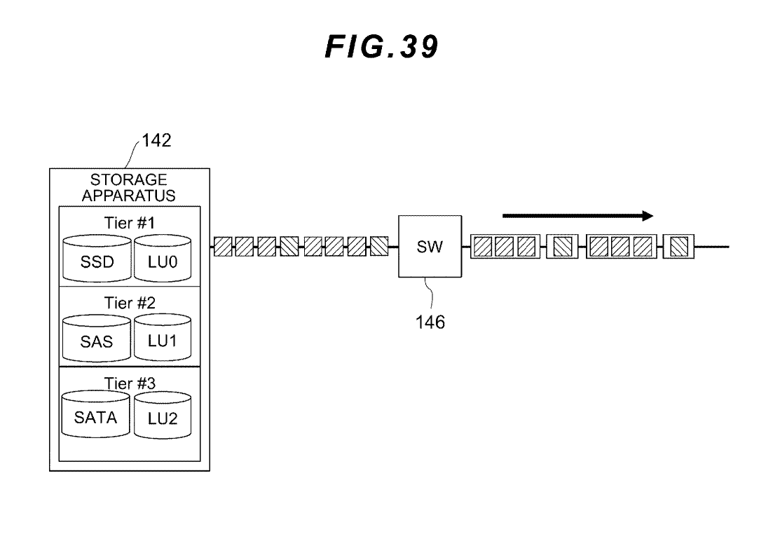

As shown in FIG. 39, the channel adapter (not shown) for the storage apparatus 142 also executes the frame transmission order priority control processing described earlier with reference to FIG. 23 to FIG. 25 in the computer system 140 according to this embodiment. Accordingly, FC frames as many as the number of multiple frames to be encapsulated in one FCoE frame (the number of stacking frames) are continuously output from the storage apparatus 142 and these FC frames are sent to the storage-side FCoE switch 146.

Then, the storage-side FCoE switch 146 refers to the logical unit group management table 161 (FIG. 31) as described above, sequentially received FC frames, which should be subject to multiple frames encapsulation among FC frames sent from the storage apparatus 142, in one FCoE frame in the order sent from the storage apparatus 142, and sends the thus-obtained FCoE frame to its transmission destination, that is, the host system 2.

Because of the above-described configuration, efficiency in the encapsulation of the FC frames in the FCoE frame at the storage-side FCoE switch 146 can be increased and it is also possible to prevent complication of hardware logic for the storage-side FCoE switch 146.

### (2-8) Advantageous Effects of this Embodiment

With the computer system 140 according to this embodiment as described above, the storage-side FCoE switch 146 is equipped with the multiple frame encapsulation function. So, the data transfer amount of data to be read from, or written to, a logical unit belonging to the relevant storage tier can be controlled on a logical unit basis. As a result, a computer system capable of data transfer bandwidth control on a logical unit basis or according to a storage tier of the storage apparatus 142 can be realized.

### (3) Third Embodiment

### (3-1) Outline of Multiple Frame Ensulation Method According to this Embodiment

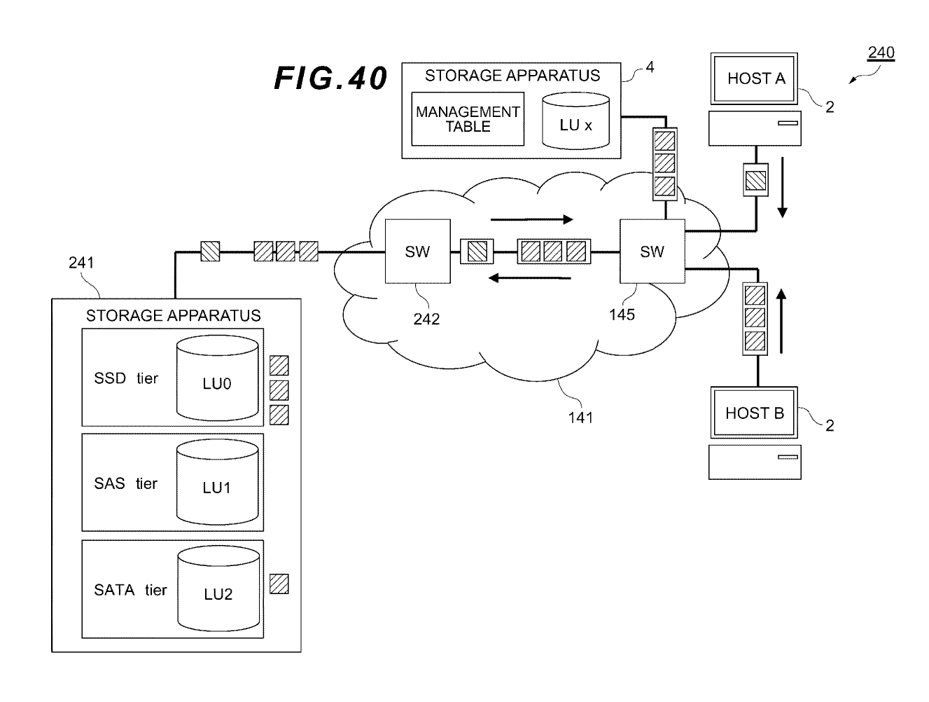

FIG. 40 in which the same reference numerals as those used in FIG. 29 are given to the parts corresponding to those in FIG. 29 shows a computer system 240 according to a third embodiment. This computer system 240 is configured in the same manner as the computer system 140 (FIG. 29) according to the second embodiment, except that the storage apparatus 241 issues an instruction to a storage-side FCoE switch 242 to designate the number of stacking frames, that is, the number of FC frames, and the storage-side FCoE switch 242 encapsulates the FC frames as many as the designated number of stacking frames in one FCoE frame.

Specifically speaking, if the configuration to have the storage-side FCoE switch 146 execute the multiple frame encapsulation processing as necessary is adopted as in the second embodiment and if an access-target logical unit is a substantial logical unit, the storage-side FCoE switch 146 can easily recognize the number of stacking frames for each logical unit by setting logical unit groups and the number of stacking frames for each logical unit group to the storage-side FCoE switch 146 in advance as described above.

However, if the access-target logical unit is a virtual logical unit that is unsubstantial, and if the storage apparatus adopts a tier control method executed as necessary by the storage apparatus for internally switching a storage tier, where data stored in the relevant virtual logical unit is to be stored, according to, for example, access frequency of the relevant data, the sequence of the multiple frame encapsulation processing can be executed only once on the read data which has been read from the relevant virtual logical unit. For example, if the aforementioned second embodiment is set so that the multiple frame encapsulation processing will be executed for the relevant virtual logical unit corresponding to a storage area of the highest-level tier, even if the relevant data is actually stored in a lower-level storage tier, the storage-side FCoE switch 146 cannot recognize it. As a result, the problem is that excessive bandwidth is assigned to access to data which has been migrated to a lower-level storage tier than the level of the storage tier for which the setting is made, or that the intended bandwidth cannot be used for access to data which has been migrated to a higher-level storage tier.

Furthermore, with the computer system 140 according to the second embodiment, the storage-side FCoE switch needs to retain the logical unit group management table 161 described earlier with reference to FIG. 31, so that there is also a problem of disadvantages in terms of management and cost.

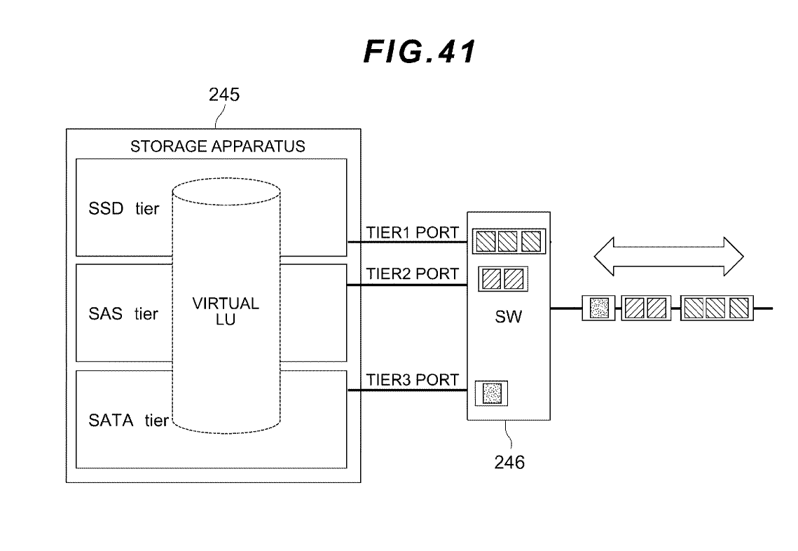

One of possible methods for solving the above-described problems is, for example, a method of associating ports of a storage apparatus 245 with storage tiers in the relevant storage apparatus 245 as shown in FIG. 41 and configuring the storage apparatus 245 and a storage-side FCoE switch 246 so that regarding read data received by the storage-side FCoE switch 246 via their ports, multiple FC frames as many as the number of stacking frames, which is set for the storage tier associated with the relevant port, are always encapsulated in one FCoE frame.

If this method is used, the storage-side FCoE switch 246 does not have to retain the aforementioned logical unit group management table 161 and the method has the advantage that the storage-side FCoE switch 246 can be constructed at less expensive cost. However, this method has a problem of the possibility to easily cause a waste of resources on the storage apparatus 245 side.

So, one of characteristics of the computer system 240 according to this embodiment is that the storage-side FCoE switch 242 executes the multiple frame encapsulation processing as in the second embodiment, but under this circumstance, the storage apparatus 241 sequentially issues an instruction to the storage-side FCoE switch 242 to designate the number of stacking frames.

Specifically speaking, the storage apparatus 241 (to be specific, a channel adapter for the storage apparatus 241) manipulates, for example, a 4th byte of an FC frame header of an FC frame (FCP data frame), in which read data is comprised, thereby issuing a stacking frame instruction to the storage-side FCoE switch 242.

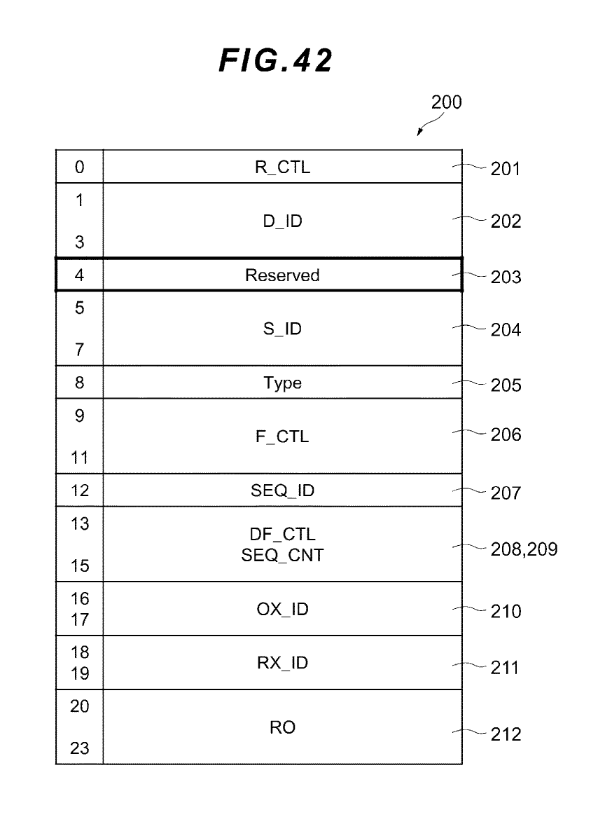

More specifically, as shown in FIG. 42 in which the same reference numerals used in FIG. 33(A) are given to the parts corresponding to those in FIG. 33(A), the 4th byte of the FC frame header 200 of an FC frame is a reserved field 203 that is not used by the storage apparatus, so that the channel adapter (not shown in the drawing) for the storage apparatus 241 sets a count value corresponding to the predefined number of stacking FC frames (hereinafter referred to as the countdown value of the number of stacking frames) for the corresponding storage tier to this reserved field 203. Incidentally, FIG. 42 conceptually shows the configuration of the FC frame header on a byte order basis and FIG. 33(A) conceptually shows the configuration of the FC frame header on a word (32 bits) order basis.

This countdownvalue of the number of stacking frames is decremented for each FC frame (FCP data frame); and when the countdown value of the number of stacking frames becomes “0,” the value is wrap around from the next FC frame (FCP data frame).

For example, if three multiple FC frames are to be stored in one FCoE frame, the 4-th byte reserved field 203 of the first FC frame (FCP data frame) stores “2 (02h)” as the countdown value of the number frames of stacking frames; the 4-th byte reserved field 203 of the next FC frame (FCP data frame) stores “1 (01h)” as the countdown value of the number of stacking frames; and the 4-th byte reserved field 203 of the last FC frame (FCP data frame) stores “0 (00h)” as the countdown value of the number of stacking frames. Furthermore, the same pattern is repeated for every three FC frames with respect to any subsequent FC frames (FCP data frames).

Therefore, in the case of this example, the countdown value of the number of stacking frames stored in the 4-th byte reserved field 203 of the FC frame (FCP data frame) changes in three-frame cycles for each FC frame (FCP data frame) like “02,” “01,” “00,” “02,” “01,” and so on.

In this case, if the number of frames, that is, the number of the remaining FC frames at the end of the read data, does not satisfy the corresponding number of stacking frames, the channel adapter for the storage apparatus 241 stores the countdown value of the number of stacking frames corresponding to the number of frames, that is, the number of the remaining FC frames, in the 4-th byte reserved field 203 of these remaining FC frames.

Incidentally, in the case of this embodiment, if the channel adapter for the storage apparatus 241 is to send an FC frame (FCP data frame) comprising data, to which multiple frames encapsulation does not have to be applied, to the storage-side FCoE switch 242, it does not perform the operation with respect to the 4-th byte reserved field 203 as described above.

Furthermore, when sending the FC frame to the storage-side FCoE switch 242, the channel adapter for the storage apparatus 241 executes the frame transmission order priority control processing described earlier with reference to FIG. 23 to FIG. 25.

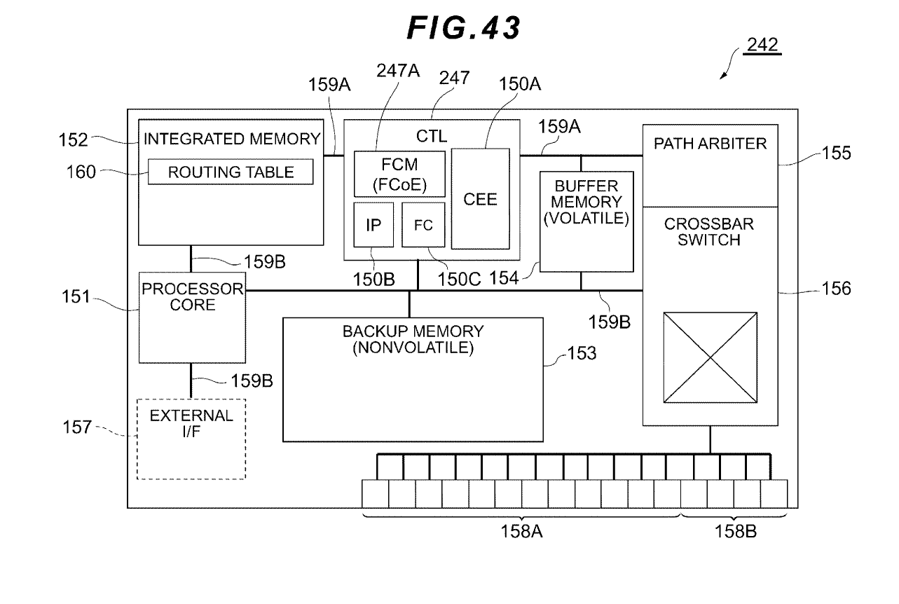

On the other hand, as shown in FIG. 43 in which the same reference numerals as used in FIG. 30 are given to the corresponding parts in FIG. 30, the storage-side FCoE switch 242 has the same configuration as that of the storage-side FCoE switch 146 according to the second embodiment, except an FCM protocol processing unit 247A of a CNA controller 247.

Then, when the FCM protocol processing unit 247A of the CNA controller 247 for the storage-side FCoE switch 242 receives an FC frame (FCP data frame) sent from the storage apparatus 241 and stores it in the buffer memory 154, it reads the 4-th byte reserved field 203 of the relevant FC frame; and if the relevant reserved field 203 stores a value other than “0” as the countdown value of the number of stacking frames, the FCM protocol processing unit 247A executes the multiple frame encapsulation processing for storing all FC frames, starting from the relevant FC frame and including its subsequent FC frames until an FC frame whose countdown value of the number of stacking frames stored in the 4-th byte reserved field 203 is “0,” in the same FCoE frame (stacked FCoE frame).

Under this circumstance, the FCM protocol processing unit 247A rewrites the countdown value of the number of stacking frames, which is stored in the 4-th byte reserved field 203 of each of all the multiple FC frames encapsulated in one FCoE frame, to “0” and stores each countdown value of the number of stacking frames, which is stored in the 4-th byte reserved field 203 of the relevant FC frame, in the corresponding frame counter field 62F in the stacked FCoE frame 62 described earlier with reference to FIG. 10.

Furthermore, after encapsulating the FC frames as many as the designated number of stacking frames as explained earlier in the same FCoE frame, the FCM protocol processing unit 247A sends the relevant FCoE frame via the FCoE interface port 158A to the corresponding host system 2.

### (3-2) Multiple Frame Encapsulation Processing according to this Embodiment

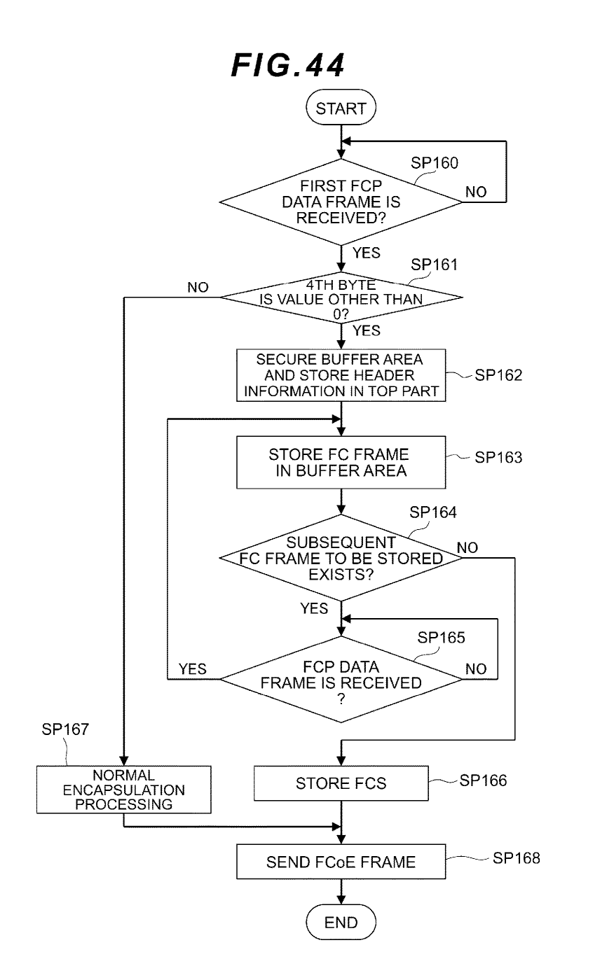

FIG. 44 shows a specific processing sequence for multiple frame encapsulation processing executed by the FCM protocol processing unit 247A of the storage-side FCoE switch 242 according to this embodiment in relation to the multiple frame encapsulation function according to this embodiment described above.

After the FCM protocol processing unit 247A obtains an FC frame (FCP command frame), in which a read command is stored, by decapsulating an FCoE frame, in which the FC frame is encapsulated, from the host system 2, and transfers the FC frame to the connection destination storage apparatus 241, it starts this multiple frame encapsulation processing and firstly waits for receiving a first FC frame (FCP data frame), in which read data is comprised in response to the relevant read command, to be sent from the connection destination storage apparatus 241 (SP160).

Then, when the FCM protocol processing unit 247A eventually receives the first FC frame and stores this first FC frame in the buffer memory 154 (FIG. 43), it reads the countdown value of the number of stacking frames, which is stored in the 4-th byte reserved field 203 of the FC frame header of the relevant FC frame and judges whether the relevant countdown value of the number of stacking frames is a value other than “0” or not (SP161).

If the FCM protocol processing unit 247A obtains a negative judgment result for this judgment, it executes encapsulation processing for encapsulating only the relevant FC frame in an FCoE frame normally (SP167). Furthermore, the FCM protocol processing unit 247A sends the FCoE frame generated by the encapsulation processing to the corresponding host system 2 (SP168) and then terminates this multiple frame encapsulation processing.

On the other hand, if the FCM protocol processing unit 247A obtains an affirmative judgment result in step SP161, it calculates the maximum frame length FCoEMaxLen(B) of the relevant FCoE frame according to the aforementioned formula (I) and secures a buffer area of the same size as the calculated maximum frame length FCoEMaxLen(B), in the buffer memory 154 (FIG. 43). Then, the FCM protocol processing unit 247A stores an FCoE frame header of an FCoE frame to be generated at the top part of the secured buffer area (SP162).

Subsequently, the FCM protocol processing unit 247A stores the FC frame (FCP data frame) received in step SP160 in the corresponding area in the buffer area secured in step SP162. At the same time, the FCM protocol processing unit 247A further stores the countdown value of number of the stacking frames, which is stored in the 4-th byte reserved field 203 of the FC frame header of the FC frame stored in the buffer area, in the frame counter field 62F (FIG. 10) corresponding to the relevant FC frame in the buffer area and also changes the countdown value of the number of stacking frames, which is stored in the 4-th byte reserved field 203 of the FC frame header of the relevant FC frame, to “0” (SP163).

Next, the FCM protocol processing unit 247A judges whether an FC frame which should be encapsulated in the same FCoE frame as the FC frame stored in the buffer area in step SP162 (hereinafter referred to as the subsequent FC frame to be stored as appropriate) exists or not (SP164). This judgment is performed by judging whether the countdown value of the number of stacking frames stored in the aforementioned frame counter field 62F in step SP163 is “0” or not. Specifically speaking, when the countdown value of the number of stacking frames is “0,” the FCM protocol processing unit 247A determines that no subsequent FC frame to be stored exists; and when the countdown value of the number of stacking frames is a value other than “0,” the FCM protocol processing unit 247A determines that a subsequent FC frame to be stored exists.

If the FCM protocol processing unit 247A obtains an affirmative judgment result for this judgment, it waits to receive the next subsequent FC frame to be stored (SP165). Then, when the FCM protocol processing unit 247A eventually receives the subsequent FC frame to be stored, it returns to step SP163 and repeats the processing from step SP163 to step SP165.

Then, if the FCM protocol processing unit 247A eventually obtains a negative judgment result in step SP164 by finishing encapsulating the FC frames as many as the number of stacking frames in one FCoE frame, it calculates the FCS 62C (FIG. 10) for the Ethernet (registered trademark) with respect to the relevant FCoE frame and adds the calculated FCS 62C to the end of the relevant FCoE frame (SP166). Then, the FCM protocol processing unit 247A sends the thus-created FCoE frame via the CEE protocol processing unit 150A (FIG. 43) to the corresponding host system 2 (SP168) and then terminates this multiple frame encapsulation processing.

### (3-3) Relationship with Fibre Channel BB Credit

The storage apparatus 241 performs flow control in accordance with a BB credit exchanged with the storage-side FCoE switch 242 (corresponding to the FCoE switch 38 in FIG. 4A) connected to itself as it has conventionally been performed; however, the storage apparatus 241 does not suspend sending the FC frames, which are the stacked FCoE frame targets, when the BB credit becomes “0” as in the conventional case, but the storage apparatus 241 suspends sending the FC frames, which are the stacked FCoE frame targets, when the remaining number of the BB credit becomes less than the number of stacking frames. Even in this case, a normal FC frame which is not a stacked FCoE frame target can be sent.

Incidentally, the storage apparatus 241 measures a reception interval of a reception ready notification (R_RDY), which will increase the BB credit, in order to prevent the above-mentioned state of inhibiting the transmission of the stacking target FC frames from continuing for long time. If the reception interval of the reception ready notification (R_RDY) is longer than an issuance interval of a normal FC frame sent by the storage apparatus 241 or is equal to or more than a designated threshold value (for example, 80[%]), the storage apparatus 241 also suspends transmitting normal FC frames, which are not stacked FCoE frame targets, and inhibits transmission of the normal FC frames until the BB credit reaches a value capable of generating/sending the stacked FCoE frames.

In this way, the storage apparatus 241 in this computer system 240 performs frame transmission control to use the bandwidth as efficiently as possible.

### (3-4) Advantageous Effects of this Embodiment

The computer system 240 according to this embodiment is designed as described above so that the number of stacking frames during the multiple frame encapsulation processing is reported from the storage apparatus 241 to the storage-side FCoE switch 242. So, in addition to the same advantageous effects as those obtained by the second embodiment, it is possible to obtain the advantageous effects that the storage-side FCoE switch 242 does not have to retain, for example, the logical unit group management table 161 explained earlier with reference to FIG. 31 and the storage-side FCoE switch 242 can be thereby constructed at inexpensive cost.

### (3-5) Application Examples of Third Embodiment

### (3-5-1) First Application Example

Incidentally, the aforementioned third embodiment has described the case where the storage-side FCoE switch 242 executes the multiple frame encapsulation processing only when sending FC frames in which read data is comprised (FCP data frames); however, the FC frame comprising the read data and an FCP response frame comprising the SCSI status (FCP RSP frame) may be encapsulated in the same one FCoE frame and besides this, FC frames of different types may be comprised in one FCoE frame.

### (3-5-2) Second Application Example

Furthermore, the aforementioned third embodiment has described the case where if the number of frames, that is, the number of the remaining FC frames at the end of the read data does not satisfies the corresponding number of stacking frames, the countdown value of the number of stacking frames according to the number of frames, that is, the number of the remaining FC frames is stored in the 4-th byte reserved field 203 of those remaining FC frames; however, in order to avoid changing the number of frames, that is, the number of multiple FC frames to be encapsulated in one FCoE frame, dummy frames generated on the storage apparatus 241 side or the storage-side FCoE switch 242 side may be encapsulated in the last FCoE frame or an FCP response frame comprising the SCSI status (FCP RSP frame) may be encapsulated in the same FCoE frame as the FC frames comprising the data are stored.

For example, if the dummy frames are comprised in the FCoE frame in the above-described case, a redundancy code (ECC set) or the like may be included in the dummy frames in order to enhance reliability.

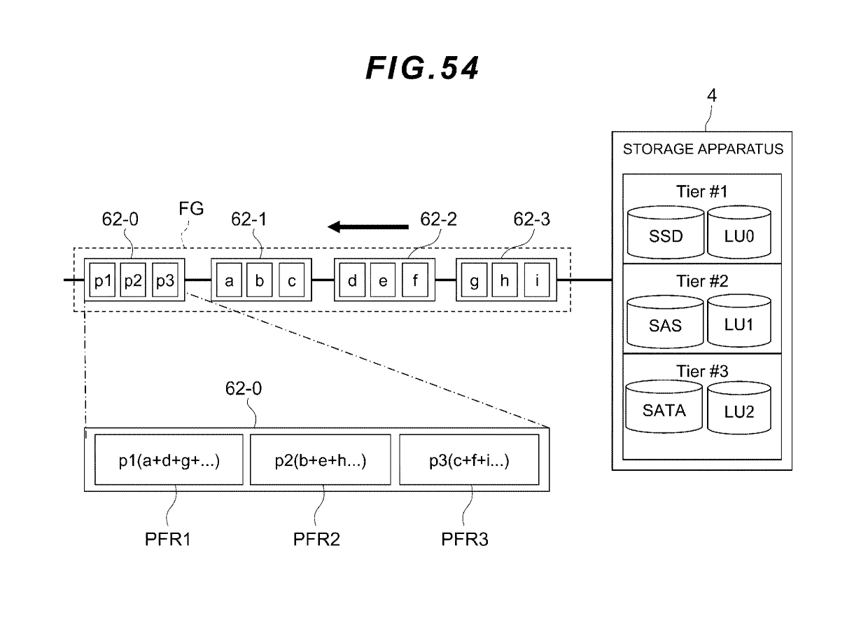

Furthermore, if it is unnecessary to encapsulate a multiplicity of dummy frames in the FCoE frame, only one data guarantee FC frame 62-0, which will be described later with reference to FIG. 54 to FIG. 58, may be encapsulated and sent to the host system 2. Incidentally, this data guarantee FC frame 62-0 may be created by either the storage apparatus 241 or the storage-side FCoE switch 242.

If the data guarantee FC frame 62-0 is sent to the host system 2 as described above, the CNA 12 for the host system 2 (FIG. 3) which has received this data guarantee FC frame 62-0 compares each verification code generated from the data comprised in each FC frame which has already been received, with the ECC at the corresponding position; and if any abnormality is detected, the CNA 12 performs reference numeral correction by means of the ECC. If the correction cannot be performed, the CNA 12 executes a partial retry operation to issue a read command for the data of a broken frame(s) to the storage apparatus 241.

Furthermore, besides the above, the FCoE switch 145 (FIG. 40) directly connected to the host system 2 (the CNA 12) may perform verification and correction and delete the relevant data guarantee frame 62-0. Furthermore, the retry operation at the time of abnormality detection may be performed by the relevant FCoE switch 145.

### (3-5-3) Third Application Example

Furthermore, the aforementioned embodiment has described the case where the countdown value of the number of stacking frames is set to the 4-th byte reserved field 203 of the FC frame header 200 of the relevant FC frame; however, the countdown value of the number of stacking frames may be set to a position other than the reserved field 203.

### (4) Fourth Embodiment

### (4-1) Configuration of Computer System according to this Embodiment

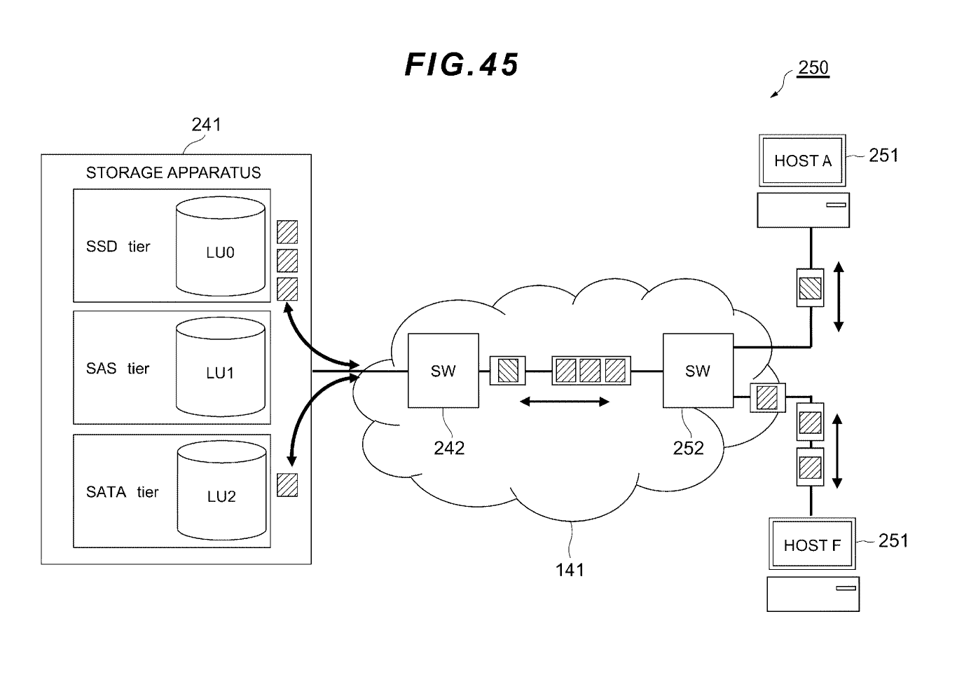

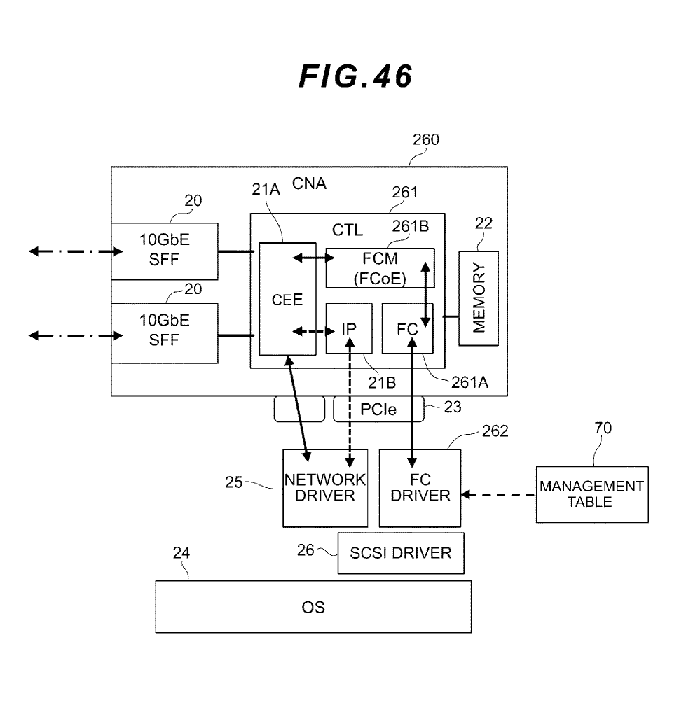

FIG. 45 in which the same reference numerals as those used in FIG. 40 are given to the parts corresponding to those in FIG. 40 shows a computer system 250 corresponding to a fourth embodiment. This computer system 250 is configured in the same manner as the computer system 240 according to the third embodiment, except that a CNA 260 (FIG. 46) for a host system 251 does not have the multiple frame encapsulation function and can respond only to the conventional CEE, and an FCoE switch (hereinafter referred to as the host-side FCoE switch) 252 directly connected to the relevant host system 251 is equipped with the multiple frame encapsulation function.

Specifically speaking, with the computer system 250 according to this embodiment, the host-side FCoE switch 252 extracts an FC frame from a normal FCoE frame output from the host system 251, encapsulates the extracted FC frame in a stacked FCoE frame again, separates and extracts each FC frame encapsulated in the stacked FCoE frame, encapsulates the separated and extracted FC frame in a normal FCoE frame, and sends it to the host system 251.

Now, in order for the host-side FCoE switch 252 to execute the multiple frame encapsulation processing as described above, the host-side FCoE switch 252 needs to recognize the number of stacking frames for each logical unit in the storage apparatus 241.

As possible examples of a method for having the host-side FCoE switch 252 recognize the number of stacking frames for each logical unit in the storage apparatus 241, there are: a first method of having the host-side FCoE switch 252 retain the logical unit group management table 161 described earlier with reference to FIG. 31 in the same manner as in the second embodiment; and a second method executed by the host system 251 issuing an instruction to the host-side FCoE switch 252 to designate the number of stacking frames for each logical unit in the storage apparatus 241 in the same manner as in the third embodiment.

The first method of these methods does not require any change of the processing on the host system 251 side. On the other hand, regarding the second method, the host system 251 needs to add processing for storing the countdown value of the number of stacking frames in the 4-th byte reserved field 203 (FIG. 42) of the FC frame header 200 (FIG. 42) of an FC frame when the need arises.

However, as stated earlier with respect to the third embodiment, this second method has the advantage of superiority in terms of cost for the FCoE switch 252 and a high degree of freedom of bandwidth control on the host system 251 side. So, according to this embodiment, the second method is adopted as the method for having the host-side FCoE switch 252 recognize the number of stacking frames for each logical unit in the storage apparatus 241.

FIG. 46 in which the same reference numerals as those used in FIG. 3 are given to the parts corresponding to those in FIG. 3 shows the configuration of a CNA 260 mounted in the host system 251 according to this embodiment. In the case of this embodiment, when sending write data to the storage apparatus 241, an FC driver 262 and a FC protocol processing unit 261A of a CNA controller 261 in the CNA 260 on the host system 251 side cooperate with each other and store the countdown value of the number of stacking frames in the 4-th byte reserved field 203 of the FC frame header 200 of the relevant FC frame when the need arises.

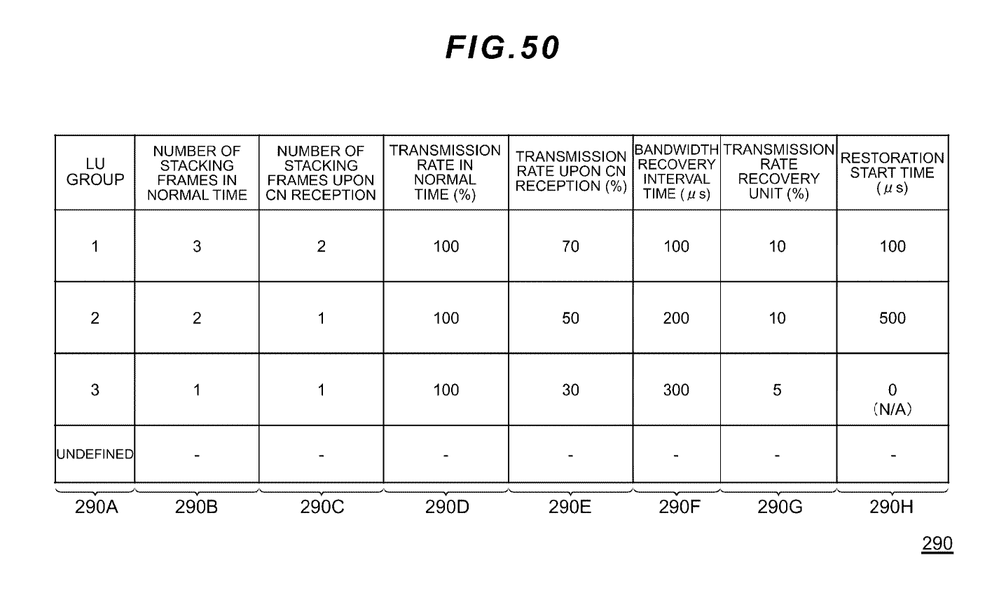

Specifically speaking, at the time of write processing, the FC driver 262 sets write data in an FC frame and sends the obtained FC frame to the FC protocol processing unit 261A. Furthermore, under this circumstance, the FC driver 262 refers to a logical unit and tier association management table 290 described later with reference to FIG. 50 and obtains the number of stacking frames, which is set for a logical unit that is a write destination of the relevant write data. Then, the FC driver 262 reports the obtained number of stacking frames to the FC protocol processing unit 261A of the CNA controller 261.

After the FC protocol processing unit 261A is notified by the FC driver 262 of the write data and the number of stacking frames, it stores the relevant countdown value of the number of stacking frames in the 4-th byte reserved field 203 (FIG. 42) of the FC frame header 200 (FIG. 42) of the relevant FC frame in the same manner as the channel adapter for the storage apparatus 241 does according to the third embodiment explained earlier with reference to FIG. 42. Then, the FC protocol processing unit 261A sends the thus-generated FC frame to the FCM protocol processing unit 261B.

The FCM protocol processing unit 261B is a conventional FCM protocol processing unit that does not have the multiple frame encapsulation function; and it encapsulates FC frames received from the FC protocol processing unit 261A one frame by one frame in one FCoE frame and sequentially sends the obtained FCoE frame to the CEE protocol processing unit 21A. Thus, these FCoE frames are then sent by the CEE protocol processing unit 21A via the optical transceiver 20 to the host-side FCoE switch 252 according to the CEE (FCoE) protocol.

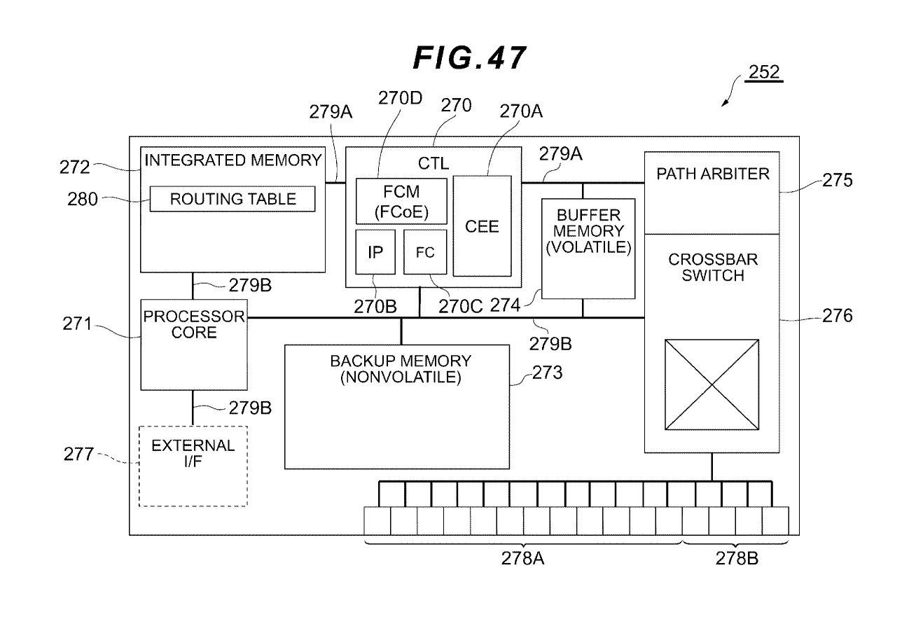

The host-side FCoE switch 252 is constituted from a CNA controller 270, a processor core 271, an integrated memory 272, a backup memory 273, a buffer memory 274, a path arbiter 275, a crossbar switch 276, an external interface 277, and a plurality of FCoE interface ports 278A and FC interface ports 278B as shown in FIG. 47.

Then, the CNA controller 270 is connected via a first bus 279A to the integrated memory 272, the buffer memory 274, and the path arbiter 275; and the processor core 271 is connected via a second bus 279B to the integrated memory 272, the external interface 277, the backup memory 273, the CNA controller 270, the buffer memory 274, and the crossbar switch 276. Furthermore, the integrated memory 272 stores a routing table 280.

Among these components of the host-side FCoE switch 252, the processor core 271, the integrated memory 272, the backup memory 273, the buffer memory 274, the path arbiter 275, the crossbar switch 276, the external interface 277, the plurality of FCoE interface ports 278A and FC interface ports 278B, the first and second buses 279A, 279B, and the routing table 280 have the same configurations and functions as those of the corresponding parts of the storage-side FCoE switch 242 (FIG. 43) according to the third embodiment, so that their explanation has been omitted here.

On the other hand, the CNA controller 270 includes a plurality of protocol processing units 270A to 270C, each of which processes the main protocol such as CEE, IP, or FC, and an FCM protocol processing unit 270D for encapsulating/decapsulating an FC frame in/from an FCoE frame. Since each protocol processing unit 270A to 270C has the same configurations and functions as those of the corresponding parts 150A to 150C of the storage-side FCoE switch 242 (FIG. 43) according to the third embodiment, their explanation has been omitted here.

The difference between the FCM protocol processing unit 270D and the FCM protocol processing unit 150D (FIG. 43) of the storage-side FCoE switch 242 according to the third embodiment is that the FCM protocol processing unit 270D has a function extracting an FC frame from each FCoE frame received from the host system 251, encapsulating one or more extracted FC frames in one FCoE frame, extracting all FC frames from a stacked FCoE frame sent from the storage-side FCoE switch 242, re-encapsulating each extracted FC frame one by one in a normal FCoE frame, and sending it to the host system 251.

In fact, after the FCoE frame sent from the host system 251 is stored in the buffer memory 274, the FCM protocol processing unit 270D sequentially extracts the FC frame from the FCoE frame. Furthermore, the FCM protocol processing unit 270 encapsulates one or more FC frames, which it has obtained by the above-described processing, in one FCoE frame. Then, the FCM protocol processing unit 270D sends the thus-obtained FCoE frame to the storage apparatus 241.

Furthermore, after the stacked FCoE frame from the storage-side FCoE switch 242 is stored in the buffer memory 274, the FCM protocol processing unit 270D extracts all the FC frames comprised in the relevant stacked FCoE frame. Then, the FCM protocol processing unit 270D re-encapsulates each extracted FC frame one by one in a normal FCoE frame, and send the thus-obtained FCoE frames to the corresponding host system 251.

### (4-2) Multiple Frame Encapsulation Processing according to this Embodiment

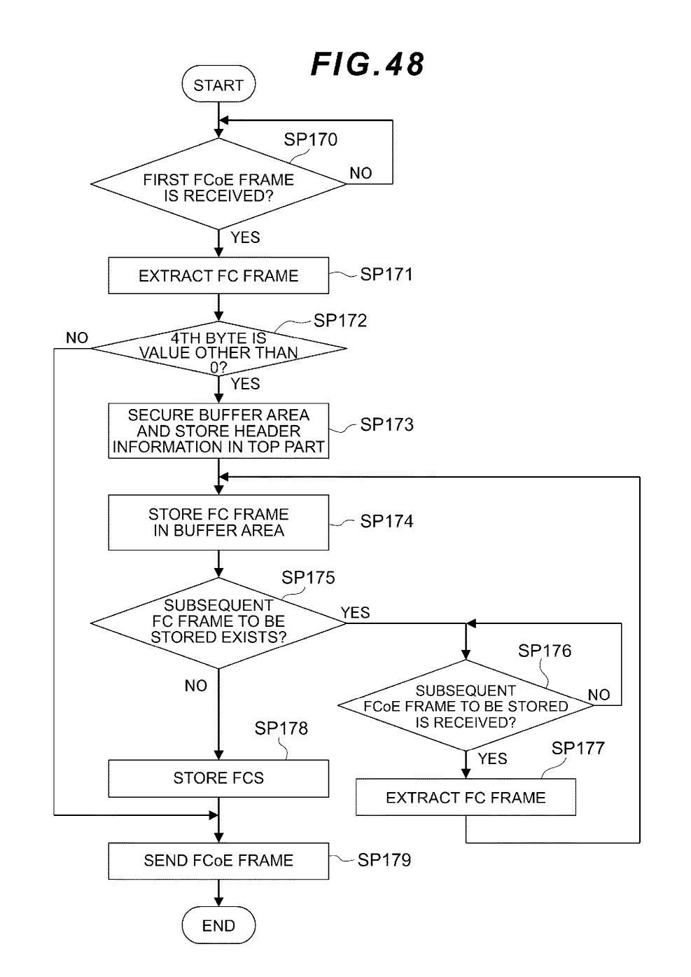

FIG. 48 shows a specific processing sequence for multiple frame encapsulation processing executed by the FCM protocol processing unit 270D of the host-side FCoE switch 252 in relation to the multiple frame encapsulation function according to this embodiment.

When the FCM protocol processing unit 270D receives an FCoE frame, in which an FC frame comprising a write command (FCP command frame) is encapsulated, from the host system 2 and transfers it to the corresponding storage apparatus 241, it starts this multiple frame encapsulation processing and firstly waits for receiving a first FCoE frame, in which write data according to the relevant write command is comprised, to be sent from the host system 251 (SP170).

Then, when the FCM protocol processing unit 270D eventually receives the first FCoE frame, it extracts an FCP data frame encapsulated in the relevant FCoE frame (SP171). Furthermore, the FCM protocol processing unit 270D reads the countdown value of the number of stacking frames, which is stored in the 4-th byte reserved field 203 (FIG. 42) of the FC frame header 200 (FIG. 42) of the extracted FCP data frame, and judges whether the relevant countdown value of the number of stacking frames is a value other than “0” or not (SP172). Incidentally, this countdown value of the number of stacking frames is stored by the CNA controller 261 in accordance with an instruction given by the FC driver 262 for the host system 251.

If the FCM protocol processing unit 270D obtains a negative judgment result for this judgment, it sends the (original) FCoE frame received in step SP170 to the corresponding storage apparatus 241 (SP179) and then terminates this multiple frame encapsulation processing.

On the other hand, if the FCM protocol processing unit 270D obtains an affirmative judgment result in step SP172, it calculates the maximum frame length FCoEMaxLen(B) of the relevant FCoE frame according to the aforementioned formula (I) and secures a buffer area of the same size as the calculated maximum frame length FCoEMaxLen(B), in the buffer memory 274 (FIG. 47). Then, the host-side FCoE switch 252 stores header information of an FCoE frame to be generated at the top part of the secured buffer area (SP173).

Subsequently, the FCM protocol processing unit 270D stores the FC frame extracted from the FCoE frame in step SP171 in the corresponding area in the buffer area secured in step SP173. At the same time, the FCM protocol processing unit 270D further stores the countdown value of the number of stacking frames, which is stored in the 4-th byte reserved field 203 of the FC frame header of the FC frame stored in the buffer area, in the frame counter field 62F (FIG. 10) corresponding to the relevant FC frame in the buffer area and also changes the count value of the number of stacking frames, which is stored in the 4-th byte reserved field 203 of the FC frame header of the relevant FC frame, to “0” (SP174).

Next, the FCM protocol processing unit 270D judges whether a subsequent FC frame to be stored which should be encapsulated in the same FCoE frame as the FC frame stored in the buffer area in step SP174 exists or not (SP175). This judgment is performed by judging whether the countdown value of the number of stacking frames stored in the aforementioned frame counter field 62F in step SP174 is “0” or not. Specifically speaking, when the countdown value of the number of stacking frames is “0,” the FCM protocol processing unit 270D determines that no subsequent FC frame to be stored exists; and when the countdown value of the number of stacking frames is a value other than “0,” the FCM protocol processing unit 270D determines that a subsequent FC frame to be stored exists.

If the FCM protocol processing unit 270D obtains an affirmative judgment result for this judgment, it waits to receive the next subsequent FC frame to be stored (SP176). Then, when the FCM protocol processing unit 270D eventually receives an FCoE frame comprising the subsequent FC frame to be stored, it extracts the subsequent FC frame to be stored from the relevant FCoE frame and then returns to step SP174 and repeats the processing from step SP174 to step SP177.

Then, if the FCM protocol processing unit 270D eventually obtains a negative judgment result in step SP175 by finishing storing the FC frames as many as the number of stacking frames in one FCoE frame, it calculates the FCS 62C (FIG. 10) for the Ethernet (registered trademark) with respect to the relevant FCoE frame and adds the calculated FCS 62C to the end of the relevant FCoE frame (SP178). Then, the FCM protocol processing unit 270D sends the thus-created stacked FCoE frame to the corresponding storage apparatus 241 and then terminates this multiple frame encapsulation processing.

### (4-3) Congestion Suppression Method according to this Embodiment

Meanwhile, the multiple frame encapsulation processing by the FCM protocol processing unit 270D as described above is effective as the operation of the relevant host-side FCoE switch 252 when the host-side FCoE switch 252 receives congestion notification (CN: Congestion Notification). In this case, the host-side FCoE switch 252 also executes the frame transmission order priority control describe earlier with reference to FIG. 23 to FIG. 25.

Now, a conventional congestion suppression method executed on the FCoE network will be briefly explained below in order to understand the congestion suppression method according to this embodiment.

By the conventional congestion suppression method, a reception port (Congestion Point) monitors a reception queue; and when congestion occurs, this is reported to a transmission port (Reaction Point). Then, traffic shaping is performed with respect to the transmission port which has received such notification (hereinafter referred to as the congestion notification (CN: Congestion Notification)), thereby adjusting a frame transmission amount to avoid the occurrence of frame loss.

There are three examples of the above-described congestion suppression method: BCN (Backward Congestion Notification) for sending the congestion notification in a direction opposite to the traffic travelling direction; QCN (Quantized Congestion Notification) for sending the congestion notification in the traffic travelling direction; and ECN (Explicit Congestion Notification) for transferring the frames by adding information indicating that the congestion has occurred, to the frames.

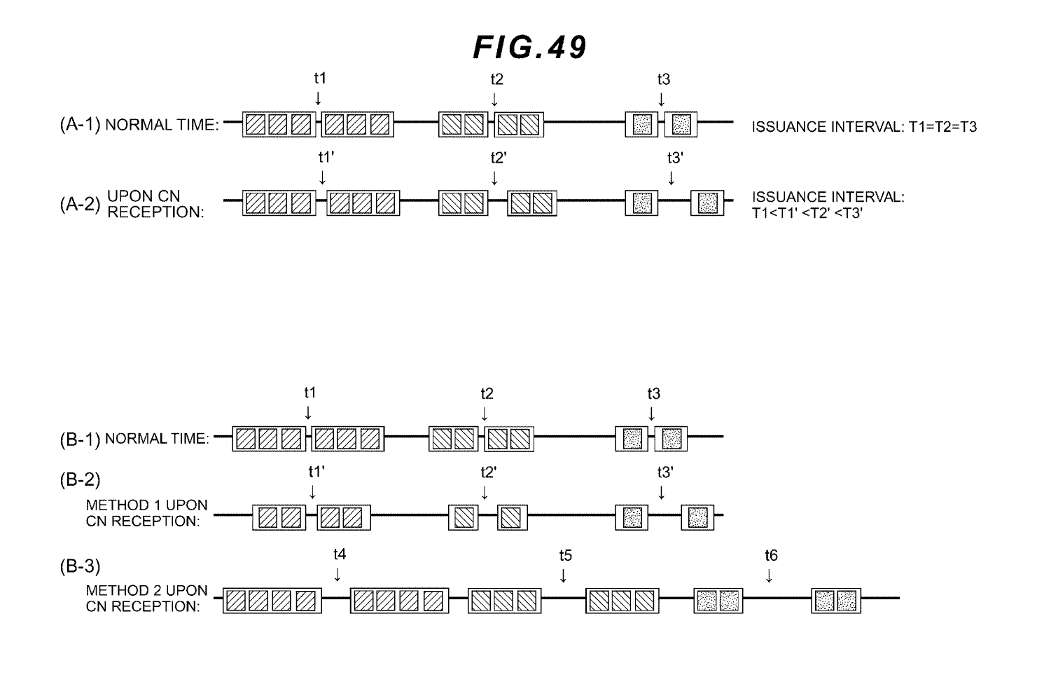

For example, by the BCN method among the above-listed methods, a frame transmission source (host system) which has received the congestion notification controls and reduces the transmission amount to a specified transmission rate. Specifically speaking, the host system controls to extend a frame issuance interval as shown in FIG. 49(A-1) and FIG. 49(A-2).

In this case according to this embodiment, a plurality of specified transmission rates are set as the settings upon reception of the congestion notification so that an issuance interval becomes longer for data transmission to a logical unit in a lower-level tier as shown in FIG. 49(B-1) to FIG. 49(B-3); and as a result of such control, bandwidth control can be performed according to the importance of data.

Furthermore, in the case of this embodiment, the host system 251 executes control to reduce the number of frames, that is, the number of FC frames to be encapsulated in one staked FCoE frame (the number of stacking frames) in addition to the method for extending the frame issuance interval as the means of reducing the transmission amount as describe above during transmission of stacking frames. On the contrary, the host system 251 executes control to increase the number of stacking frames, thereby much more extending the issuance interval shown in FIG. 49 (B-2) (FIG. 49 (B-3)). In the latter case, the number of issued FCoE frames will become less than the former case, so that the bandwidth which will be consumed by data such as the CEE header or the FCS can be sometimes reduced.

With this computer system 250 as described above, the data transmission amount can be suppressed sensitively by a combination of extension of the frame issuance interval and changes of the number of stacking frames with respect to the stacked FCoE frames.

As a means for realizing the congestion suppression method according this embodiment as described above, the shared memories 47A, 47B (FIG. 5) of the system-0 controller 40A and system-1 controller 40B (FIG. 5) for the host system 251 stores a frame control management table 290 shown in FIG. 50.

The frame control management table 290 is a table in which the number of stacking frames for each logical unit group in normal time and at the time of the occurrence of congestion as well as various information about transmission control of FCoE frames such as transmission rates of FCoE frames are stored, and is created for each storage apparatus 241.

This frame control management table 290 is constituted from a logical unit group number column 290A, a number-of-stacking-FC-frames (in normal time) column 290B, a number-of-stacking-FC-frames (upon CN reception) column 290C, an FCoE frame transmission rate (in normal time) column 290D, an FCoE frame transmission rate (upon CN reception) column 290E, a bandwidth recovery interval time column 290F, a transmission rate recovery unit column 290G, and a restoration start time column 290H.

Then, the logical unit group number column 290A stores the logical unit group number assigned to each logical unit group defined in the corresponding storage apparatus 241. Furthermore, the number-of-stacking-FC-frames (in normal time) column 290B stores the number of stacking frames defined for the corresponding logical unit group in normal time; and the number-of-stacking-FC-frames (upon CN reception) column 290C stores the number of stacking frames set for the corresponding logical unit group at the time of reception of the congestion notification.

Furthermore, the FCoE frame transmission rate (in normal time) column 290D stores a ratio of an FCoE frame transmission rate (transmission rate of FCoE frames output from the host system 251) in normal time to the maximum value of the then applicable transmission rate that is set for the corresponding logical unit group (transmission rate of FCoE frames output from the host system 251). Since the FCoE frame transmission rate in normal time is the maximum value of the then applicable transmission rate according to this embodiment, each FCoE frame transmission rate (in normal time) column 290D stores “100%.”

On the other hand, the FCoE frame transmission rate (upon CN reception) column 290E stores a ratio of an FCoE frame transmission rate (transmission rate of FCoE frames output from the host system 251) at the time of the reception of the congestion notification to the maximum value of the then applicable transmission rate that is set for the corresponding logical unit group (transmission rate of FCoE frames output from the host system 251).

Furthermore, according to this embodiment, if the host system 251 receives the congestion notification and changes the transmission rate of the FCoE frames output from the host system 251 from the transmission rate in normal time to the transmission rate at the time of the reception of the congestion notification, the host system 251 controls to increase the FCoE frame transmission rate to make it return to the transmission rate in normal time at a constant issuance interval between the FCoE frames output from the host system 251 (hereinafter referred to as the bandwidth recovery interval time) by a constant rate (hereinafter referred to as the transmission rate recovery unit). When this control is performed, the bandwidth recovery interval time and the transmission rate recovery unit are stored in the bandwidth recovery interval time column 290F and the transmission rate recovery unit column 290G, respectively.

Furthermore, according to this embodiment, if the host system 251 receives the congestion notification and changes the transmission rate of the FCoE frames output from the host system 251 from the transmission rate in normal time to the transmission rate at the time of the reception of the congestion notification, the host system 251 controls to firstly make the FCoE frame transmission rate return to the transmission rate in normal time and then make the number of stacking frames return to the number of stacking frames in normal time; and when the above-described control is performed, time required to make the number of stacking frames return to the number of stacking frames in normal time after making the transmission rate return to the transmission rate in normal time is stored in the restoration start time column 290H.

Therefore, the example in FIG. 50 shows that in a case of a logical unit group whose logical unit group number is “1,” the number of stacking frames in normal time is set to “3” and the FCoE frame transmission rate in normal time is set to “100” [%] of the applicable transmission rate, respectively, while the number of stacking frames at the time of the reception of the congestion notification is set to “2” and the FCoE frame transmission rate at the time of the reception of the congestion notification is set to “70” [%] of that in normal time, respectively. Furthermore, the example in FIG. 50 shows that in the case of the logical unit group whose logical unit group number is “1,” the FCoE frame transmission rate is changed to the FCoE frame transmission rate at the time of the reception of the congestion notification and then the FCoE frame transmission rate is made to recover to the transmission rate in normal time by “10” [%] every “100” [micro S]; and “100” [micro S after the FCoE frame transmission rate returns to the transmission rate in normal time, the number of stacking frames should be also returned to the number of stacking frames in normal time.

### (4-4) Frame Control Processing

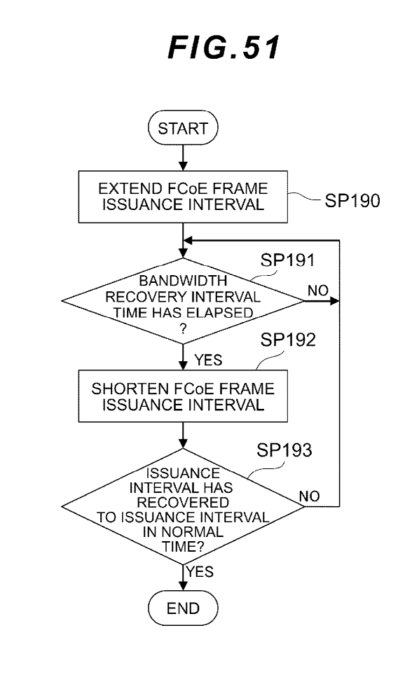

FIG. 51 shows a processing sequence for first frame control processing executed by the CNA controller 261 of the CNA 260 for each individual logical unit group with respect to the corresponding each logical unit group when the CNA 260 (FIG. 46) for the host system 251 receives the congestion notification from, for example, the storage apparatus 241 while the host-side FCoE switch 252 executes the multiple frame encapsulation processing.

After the CNA controller 261 receives the congestion notification, it starts first frame processing shown in this FIG. 51; and firstly refers to the frame control management table 290 (FIG. 50) and extends an issuance interval for an FCoE frame, which is currently being transmitted, in the corresponding logical unit group to an issuance interval according to a storage tier to which a logical unit, that is, a storage destination of write data comprised in the relevant FCoE frame belongs (SP190). Furthermore, the CNA controller 261 then notifies the FC driver 262 (FIG. 46) of the reception of the congestion notification.

Subsequently, the CNA controller 261 extends the FCoE frame issuance interval in step SP190 or recovers the FCoE frame issuance interval by the transmission rate recovery unit in step SP192 described later, and then judges whether the bandwidth recovery interval time 290F specified in the frame control management table 290 has elapsed or not (SP191).

If the CNA controller 261 obtains a negative judgment result for this judgment, it waits for the bandwidth recovery interval time to elapse for the corresponding logical unit group; and if the CNA controller 261 eventually obtains an affirmative judgment result in step SP191 as the bandwidth recovery interval time has elapsed from any of the logical unit groups, it shortens the FCoE frame issuance interval for the relevant logical unit group by the amount corresponding to the transmission rate recovery unit 290G specified in the frame control management table 290 (SP192).

The CNA controller 261 then judges whether the FCoE frame issuance interval for the relevant logical unit group has recovered to the issuance interval in normal time or not (SP193); and if the CNA controller 261 obtains a negative judgment result, it returns to step SP191 and then repeats the processing from step SP191 to step SP193.

Then, if the CNA controller 261 obtains an affirmative judgment result in step SP193 when the FCoE frame issuance interval eventually recovers to the issuance interval in normal time, it terminates this first frame control processing.

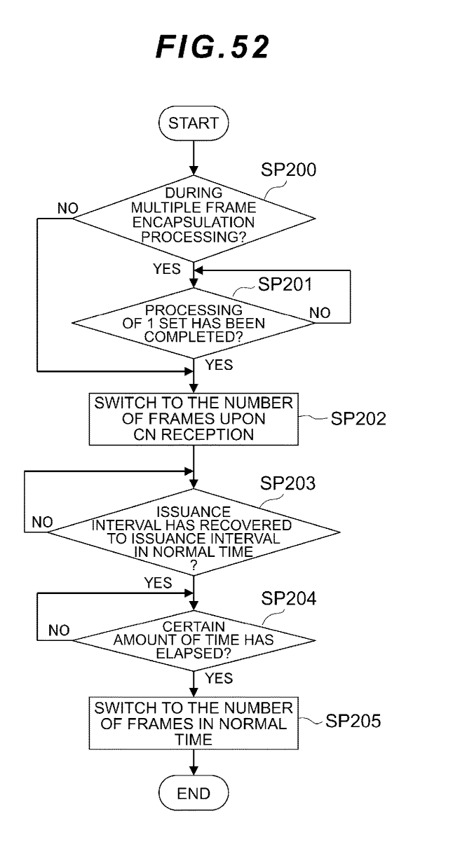

On the other hand, FIG. 52 shows a processing sequence for second frame control processing executed by the FC driver 262 which has received notification from the CNA controller 261 which received the congestion notification. The FC driver 262 controls the number of frames, that is, the number of multiple FC frames to be encapsulated in one FCoE frame (the number of stacking frames) in accordance with the processing sequence shown in this FIG. 52 during the multiple frame encapsulation processing executed at the host-side FCoE switch 252.

Specifically speaking, after receiving the notification from the CNA controller 261, the FC driver 262 starts the second frame control processing shown in this FIG. 52. However, if the multiple frame encapsulation processing is currently being executed, it is necessary to complete the processing once. So, the FC driver 262 judges whether the multiple frame encapsulation processing is being executed or not (SP200).

Then, if the FC driver 262 obtains a negative judgment result for this judgment, it proceeds to step SP202. On the other hand, if the FC driver 262 obtains an affirmative judgment result in step SP200, it continues FC frame creation processing until it becomes possible to generate one stacked FCoE frame which was being generated when receiving the congestion notification (until the number of stacking frames reaches the number of frames constituting one set) (SP201).

Then, after the host-side FCoE switch 252 confirms that generation of one set of FC frames which makes it possible to generate the relevant stacked FCoE frame has been completed, the FC driver 262 refers to the frame control management table 290 (FIG. 50) and switches the countdown value of the number of stacking frames to be stored in the 4-th byte reserved field 203 of the FC frame header 200 of the relevant FC frame to a value according to the number of stacking frames 290C at the time of the reception of the congestion notification (SP202).

Subsequently, the FC driver 262 waits for the issuance interval for the FCoE frames output from the host system 251 to recover to the issuance interval in normal time (SP203). Then, when the FCoE frame issuance interval has recovered to the issuance interval in normal time, the FC driver 262 further waits for the aforementioned restoration start time 290H specified in the frame control management table 290 to elapse (SP204). Incidentally, while the FC driver 262 waits in step SP203 and step SP204, the FC frames are generated and transmitted to the CNA 260.

Then, when the restoration start time has elapsed, the FC driver 262 refers to the frame control management table 290 and switches the countdown value of the number of stacking frames to be stored in the 4-th byte reserved field 203 of the FC frame header 200 of the relevant FC frame to a value according to the number of stacking frames in normal time (SP205) and then terminates this second frame control processing.

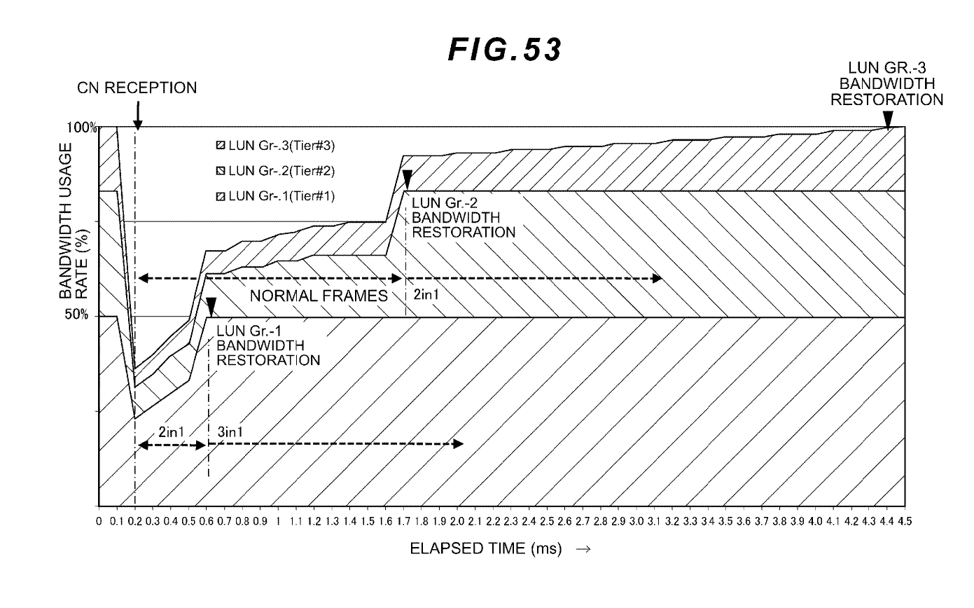

Incidentally, FIG. 53 shows the state of changes of a bandwidth usage rate for each storage tier when the above-described first and second frame control processing is executed in accordance with the content of the frame control management table 290 illustrated in FIG. 50.

### (4-5) Advantageous Effects of this Embodiment

With the computer system 250 according to this embodiment as described above, the host-side FCoE switch 252 is equipped with the multiple frame encapsulation function. So, like the third embodiment, this embodiment has the special advantageous effect of being capable of data transfer bandwidth control on a logical unit basis or according to the relevant storage tier. Furthermore, the data transfer bandwidth control on the logical unit basis or according to the storage tier can be performed depending on the situation, for example, where congestion has occurred.

### (4-6) Application Examples of Fourth Embodiment

### (4-6-1) First Application Example

Incidentally, the aforementioned fourth embodiment has described the case where the countdown value of the number of stacking frames is set to the 4-th byte reserved field 203 of the FC frame header 200 of the relevant FC frame in the same manner as in the third embodiment; however, the countdown value of the number of stacking frames may be set at a position other than the reserved field 203.

### (4-6-2) Second Application Example

Furthermore, the aforementioned fourth embodiment has described the case where the congestion suppression method according to this embodiment described with reference to FIG. 49 to FIG. 53 is applied to the computer system 250 according to this embodiment (FIG. 45) shown in FIG. 45; however, the present invention is not limited to this example and the congestion suppression method according to this embodiment can be applied to, for example, the computer system 1 (FIG. 1) according to the first embodiment.

### (5) Fifth Embodiment

In addition to the first to fourth embodiments described above, this embodiment will describe an additional function to the stacked FCoE frames (frame protection function) to enhance the strength against frame and data loss. Incidentally, a case where the computer system 1 according to the first embodiment is equipped with the frame protection function is taken as an example in the following explanation.

### (5-1) Outline of Frame Protection Function

Firstly, the frame protection function described earlier with reference to FIG. 20 will be explained. The frame protection function is a function sending a guarantee frame to enhance reliability of FCoE frames as mentioned above and restoring lost or destroyed data based on the received data guarantee frame. However, the frame protection function requires transmission of redundant data, so it has the disadvantage in terms of the bandwidth. However, if an intermittent failure of, for example, network equipment or software error occurs, the conventional technique requires retransmission of entire data. Therefore, the frame protection function is effective, for example, in a case where performance needs to be maintained even if certain bandwidth is sacrificed for logical units or the like located in, for example, a high-level storage tier.

For example, if the frame protection function is set to “ON” on the number-of-stacking-frames-setting screen 100 described earlier with reference to, for example, FIG. 20, the channel adapter 42A, 42B of the storage apparatus 4 sets a specified number of stacked FCoE frames 62-1 to 62-3 as one frame group FG as shown in FIG. 54 and generates parity based on data (read data) stored in each FC frame at the same position in each stacked FCoE frame 62-1 to 62-3 constituting the relevant frame group FG.

Then, the channel adapter 42A, 42B stores each parity, which has been thus generated, in FC frames (such FC frames will be hereinafter referred to as the FCP parity frames) PFR1 to PFR3 and generates a data guarantee frame 62-0 in which each of these FCP parity frames PFR1 to PFR3 is stored at the same position as the corresponding read data in one FCoE frame. Then, the channel adapter 42A, 42B sends the thus-generated data guarantee frame 62-0 to the host system 2 before sending each stacked FCoE frame 62-1 to 62-3 of the corresponding frame group FG.

For example, if the three stacked FCoE frames 62-1 to 62-3 are formed into one frame group FG as shown in FIG. 54, the channel adapter 42A, 42B generates parity “p1” based on read data “a” stored in a first FCP data frame in a stacked FCoE frame (hereinafter referred to as the first stacked FCoE frame) 62-1, in which three FCP data frames respectively storing read data “a” to “c” are encapsulated, read data “d” stored in a first FCP data frame in a stacked FCoE frame (hereinafter referred to as the second stacked FCoE frame) 62-2, in which three FCP data frames respectively storing read data “d” to “f” are encapsulated, and read data “g” stored in a first FCP data frame in a stacked FCoE frame (hereinafter referred to as the third stacked FCoE frame) 62-3, in which three FCP data frames respectively storing read data “g” to “i” are encapsulated. An exclusive OR of this parity and two pieces of the read data among “a,” “d,” and “g” is sequentially calculated, thereby making it possible to restore the remaining one piece of data.

Similarly, the channel adapter 42A, 42B generates parity “p2” based on read data “b” stored in the next FCP data frame in the first stacked FCoE frame 62-1, read data “e” stored in the next FCP data frame in the second stacked FCoE frame 62-2, and read data “h” stored in the next FCP data frame in the third stacked FCoE frame 62-3. An exclusive OR of this parity and two pieces of the read data among “b,” “e,” and “h” is sequentially calculated, thereby making it possible to restore the remaining one piece of data.

Furthermore, the channel adapter 42A, 42B generates parity “p3” based on read data “c” stored in the last FCP data frame in the first stacked FCoE frame 62-1, read data “f” stored in the last FCP data frame in the second stacked FCoE frame 62-2, and read data “i” stored in the last FCP data frame in the third stacked FCoE frame 62-3. An exclusive OR of this parity and two pieces of the read data among “c,” “f,” and “i” is sequentially calculated, thereby making it possible to restore the remaining one piece of data.

Then, the channel adapter 42A, 42B stores the thus-generated three pieces of parity “p1” to “p3” in FC frames, respectively, and stores the thus-obtained three FCP parity frames PFR1 to PFR3 in one FCoE frame in this order, thereby generating the data guarantee frame 62-0. Furthermore, the channel adapter 42A, 42B sends the thus-generated data guarantee frame 62-0 to the host system 2 before sending the first to third stacked FCoE frames 62-1 to 62-3.

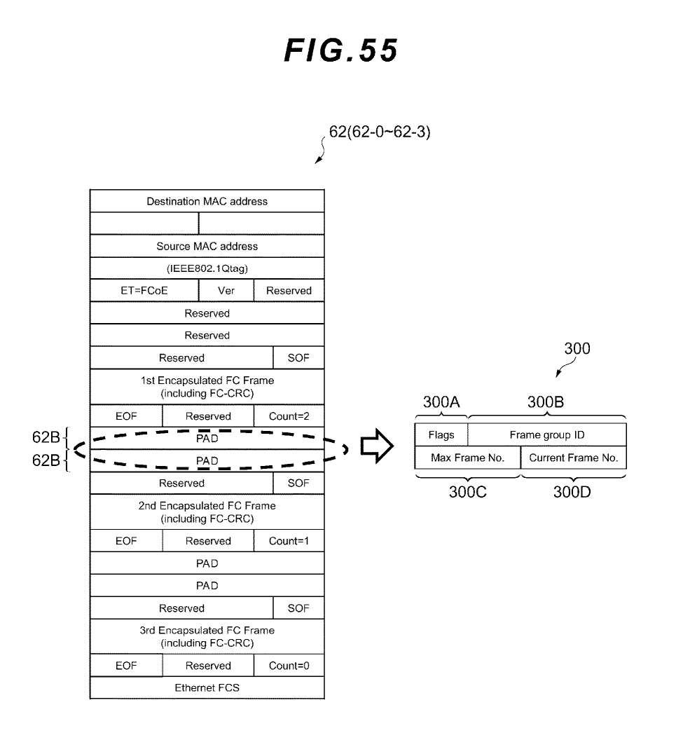

Under this circumstance, the channel adapter 42A, 42B stores specified information (hereinafter referred to as the frame protection information) 300 in a two-word field where the first pad data 62B is stored in the data guarantee frame 62-0 and each stacked FCoE frame 62-1 to 62-3 (hereinafter referred to as the pad data field) as shown in FIG. 55.

This frame protection information 300 is constituted from: a frame type flag 300A indicating that the relevant FCoE frame is any one type of the data guarantee frame 62-0 or the stacked FCoE frames 62-1 to 62-3; an identifier (frame group ID) 300B assigned to a frame group FG to which the relevant data guarantee frame 62-0 or the relevant stacked FCoE frame 62-1 to 62-3 belongs; the number of member frames 300C that is set to the stacked FCoE frames 62-1 to 62-3 constituting the relevant frame group FG; and a current frame number 300D indicating the rank order of the relevant stacked FCoE frame MFG1 to MFG3 in the relevant frame group FG. Incidentally, the current frame number 300D of the data guarantee frame 62-0 is set and fixed to “0.”

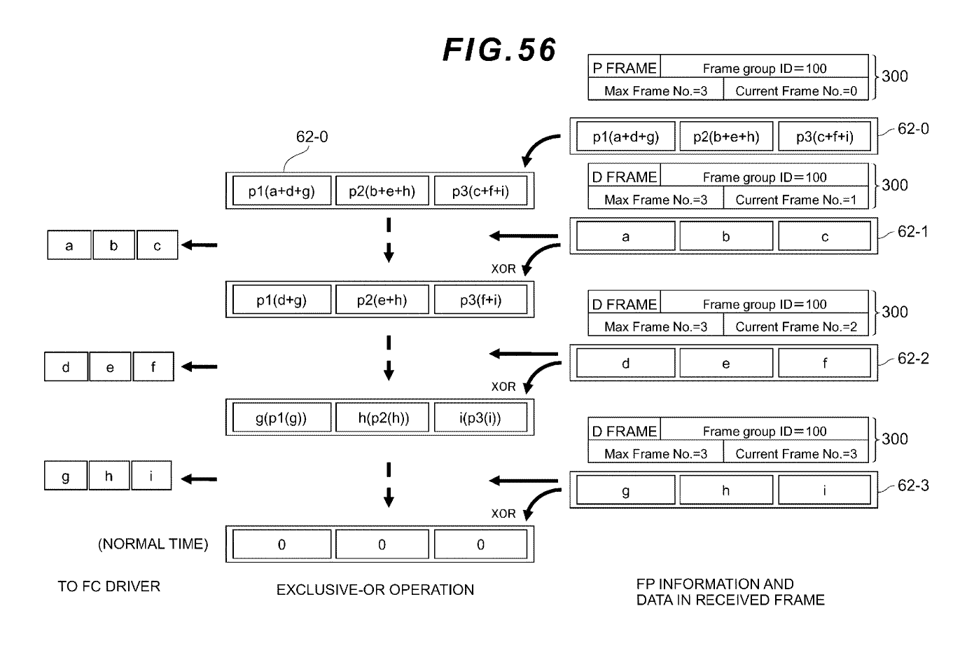

Therefore, if the frame group ID of the frame group FG is “100” in the example shown in FIG. 54, the frame protection information 300 of the data guarantee frame 62-0 as shown in the highest row in the right column in FIG. 56 is set so that the frame type flag 300A is set to a value representing the data guarantee frame 62-0 (for example, “1”), the frame group ID 300B is set to “100,” the number of member frames 300C is set to “3,” and the current frame number 300D is set to “0,” respectively; and the frame protection information 300 of the stacked FCoE frames 62-1 to 62-3 constituting the relevant frame group FG is set so that the frame type flag 300A is set to a value representing the stacked FCoE frame 62-1 to 62-3 (for example, “0”), the frame group ID 300B is set to “100,” the number of stacked frames 300C is set to “3,” and the current frame number 300D is set to a value corresponding to “1” to “3.”

On the other hand, when the CNA controller 21 (FIG. 3) for the host system 2 receives the stacked FCoE frame sent from the storage apparatus 4, it checks information stored in the first two-word pad data field in the relevant stacked FCoE frame. Then, if the pad data 62B is stored in that pad data field, the CNA controller 21 executes the processing in step SP62 and its subsequent steps of the CNA-side read processing described earlier with reference to FIG. 18.

On the other hand, if the frame protection information described above with reference to FIG. 55 is stored in the first two-word pad data field of each received stacked FCoE frame, the CNA controller 21 searches the then received stacked FCoE frames for the data guarantee frame 62-0 based on the frame type flag 300A among the frame protection information.

Then, if the CNA controller 21 detects the data guarantee frame 62-0 as a result of the search, it waits to receive the first stacked FCoE frame 62-1 belonging to the same frame group FG among the stacked FCoE frames 62-1 to 62-3 to receive following the relevant data guarantee frame 62-0. Incidentally, whether the then received stacked FCoE frame 62-1 to 62-3 belongs to the same frame group FG as the aforementioned data guarantee frame 62-0 is judged based on the frame group ID 300B of the frame protection information 300 stored in the relevant stacked FCoE frame 62-1 to 62-3; and what number of stacked FCoE frames the relevant stacked FCoE frame 62-1 to 62-3 is in the relevant frame group FG is judged based on the current frame number 300D of the frame protection information 300.

Then, when the CNA controller 21 receives the first stacked FCoE frame 62-1 belonging to the same frame group FG as the data guarantee frame 62-0, it extracts each FCP data frame stored in the relevant stacked FCoE frame 62-1 as shown in FIG. 56 and sends each read data (“a,” “b,” and “c” in FIG. 56), which is stored in these extracted FCP data frames, to the FC driver 27 (FIG. 3). Meanwhile, the CNA controller 21 calculates the exclusive OR of each of these pieces of read data and the parity stored in each corresponding FCP parity frame PFR1 to PFR3 in the aforementioned data guarantee frame 62-0 (“p1 (a+d+g),” “p2 (b+e+h),” “p3 (c+f+i)” in the central column of FIG. 56). Specifically speaking, referring to FIG. 56, the CNA controller 21 calculates the exclusive OR of the data “a” and the parity “p1 (a+d+g),” calculates the exclusive OR of the data “b” and the parity “p2 (b+e+h),” and calculates the exclusive OR of the data “c” and the parity “p3 (c+f+i).”

Furthermore, the CNA controller 21 then waits to receive the next stacked FCoE frame 62-2 which belongs to the same frame group FG as the data guarantee frame 62-0. When the CNA controller 21 receives the stacked FCoE frame 62-2, it extracts each FCP data frame stored in the relevant stacked FCoE frame 62-2 and sends each read data (“d,” “e,” and “f” in FIG. 56), which is stored in these extracted FCP data frames, to the FC driver 27 (FIG. 3). Meanwhile, the CNA controller 21 calculates the exclusive OR of each of these pieces of read data and the corresponding parity among the parity obtained by the above-described calculation of the exclusive OR which was executed immediately before (“p1 (d+g),” “p2 (e+h),” “p3 (f+i)” in the central column of FIG. 56). Specifically speaking, referring to FIG. 56, the CNA controller 21 calculates the exclusive OR of the read data “d” and the parity “p1 (d+g),” calculates the exclusive OR of the read data “e” and the parity “p2 (e+h),” and calculates the exclusive OR of the read data “f” and the parity “p3 (f+i).”

Then, the CNA controller 21 repeats the same processing on another stacked FCoE frame 62-3 belonging to the same frame group FG as the data guarantee frame 62-0 in the ascending order of the current frame number 300D of the frame protection information 300.

For example, in the example shown in FIG. 56, the CNA controller 21 waits to receive the next stacked FCoE frame 62-3 which belongs to the same frame group FG as the data guarantee frame 62-0. When the CNA controller 21 receives the stacked FCoE frame 62-3, it extracts each FCP data frame stored in the relevant stacked FCoE frame 62-3 and sends each read data (“g,” “h,” and “i” in FIG. 56), which is stored in these extracted FCP data frames, to the FC driver 27 (FIG. 3). Meanwhile, the CNA controller 21 calculates the exclusive OR of each of these pieces of read data and the corresponding parity among the parity obtained by the above-described calculation of the exclusive OR which was executed immediately before (“p1 (g),” “p2 (h),” “p3 (i)” in the central column of FIG. 56). Specifically speaking, referring to FIG. 56, the CNA controller 21 calculates the exclusive OR of the read data “g” and the parity “p1 (g),” calculates the exclusive OR of the read data “h” and the parity “p2 (h),” and calculates the exclusive OR of the read data “i” and the parity “p3 (i).”

As a result, if no discrepancy such as data loss has occurred during data transfer from the storage apparatus 4 to the host system 2, each calculation result of the exclusive OR of each parity and each corresponding read data becomes “0” as shown in the bottom row of the central column in FIG. 56. Thus, in this case, the CNA 12 terminates the reception processing on the relevant frame group FG without executing any error processing.

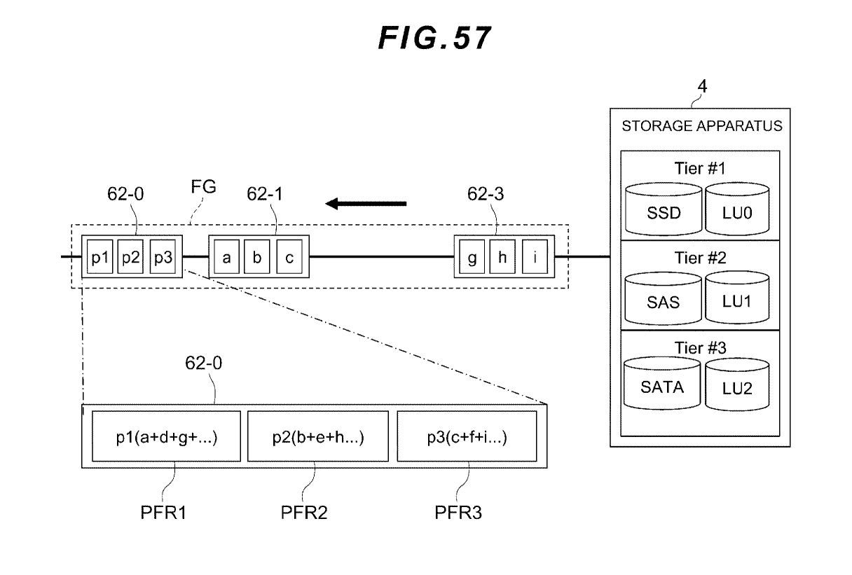

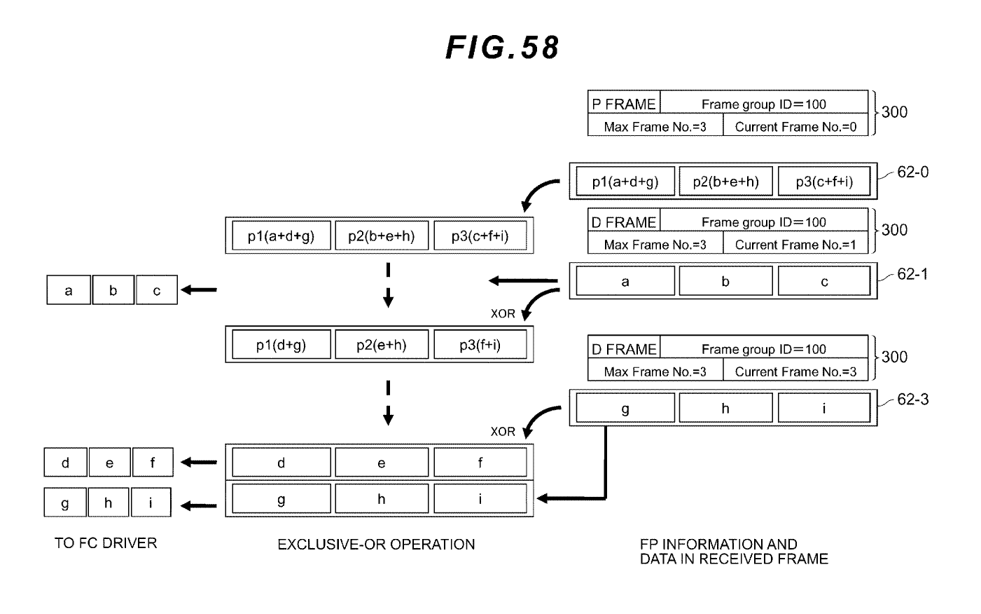

On the other hand, for example, if at least one stacked FCoE frame 62-1 to 62-3 (the stacked FCoE frame 62-2 in FIG. 57) among the data guarantee frame 62-0 and the plurality of the stacked FCoE frames 62-1 to 62-3 constituting the same frame group FG becomes lost during data transfer from the storage apparatus 4 to the host system 2 as shown in FIG. 57, the read data (“d,” “e,” and “f” in FIG. 58) stored in the lost stacked FCoE frame 62-2 is restored as shown in FIG. 58. Thus, in this case, the CNA 12 sends the data (“d,” “e,” and “f” in FIG. 58), which has been restored by the aforementioned parity check processing, together with other read data to the FC driver 27 (FIG. 3).

Then, the CNA controller 21 terminates the reception processing on the relevant frame group FG without executing any error processing.

Incidentally, the CNA controller 21 (FIG. 3) for the host system 2 is also equipped with the above-described frame protection function. Therefore, when the channel adapter 42A, 42B of the storage apparatus 4 receives the data guarantee frame 62-0 from the host system 2 during the write processing, it judges whether any abnormality of write data or frame loss exists or not, by executing the same parity check processing as the processing described above with reference to FIG. 56 to FIG. 58; and if the channel adapter 42A, 42B detects frame loss, it restores the relevant frames including the lost write data by using the parity; and if any data abnormality is detected or if the restoration cannot be performed due to loss of a plurality of frames, the channel adapter 42A, 42B requests that the host system 2 send the frames of only the relevant frame group FG again.

Furthermore, the host system 2 or the storage apparatus 4 may also apply the above-described frame protection function to normal FCoE frames; and if inconsistency of continuity is detected by monitoring the sequence count information (SEQ_CNT) of the encapsulated FC frames, the same processing as described above may be executed or information about the frame group to which the relevant FCoE frame belongs may be stored in any of the reserved fields of the FCoE frame header and such information may be monitored. In this case, only the frame group in which the inconsistency of continuity was detected should be sent again and it is unnecessary to send the data guarantee frame 62-0, so that there is the advantage of not producing load, which would be caused by such transmission, on the bandwidth.

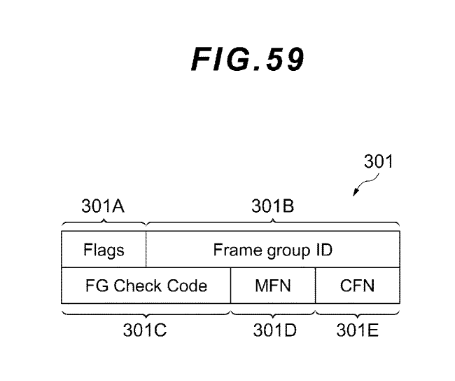

Furthermore, instead of sending the data guarantee frame 62-0, for example, the field where the pad data 62B (FIG. 10) is stored may be extended to provide a frame group check code field 301 in a stacked FCoE frame as shown in FIG. 59 and store the parity, which should be stored in the data guarantee frame 62-0, as a frame check code 301C in the relevant frame group check code field 301. Incidentally, referring to FIG. 59, a frame type flag 301A, a frame group ID 301B, the number of stacking frames 301D, and a current frame number 301E are the same as those in the frame protection information 300 described earlier with reference to FIG. 55.

### INDUSTRIAL APPLICABILITY

The present invention can be applied to not only computer systems, which adopt the CEE method as a frame transfer method, but also a wide variety of computer systems which adopt other frame transfer methods.

### REFERENCE SIGNS LIST

1, 140, 240, 250 Computer systems
2, 251 Host systems
4, 142, 241 Storage apparatuses
10 CPU
12 CNA
21, 150, 247, 270 CNA controllers
21D, 150D, 247A, 270D FCM protocol processing units
33A Storage device
38, 54, 145, 146, 242, 252 FCoE switches
40A, 40B Controllers
42A, 42B Channel adapters
61 FCoE frame
60 FC frame
62 Multiple storage FCoE frame
62F Frame counter field
70 Logical unit and tier association management table
100 Number-of-stacking-frames setting screen
300 Frame protection information
144 Management device
161 Logical unit group management table
170 Management table setting screen
200 FC frame header
220 FCP command frame payload
290 Frame control management table
VLU Virtual logical unit

1. A computer system with first and second nodes connected via a network, for sending and/or receiving data to be read and/or written to a logical unit in a storage apparatus between the first and second nodes, the first and second nodes comprising:
an encapsulation unit for encapsulating a first frame, in which transfer target data is stored, in accordance with a first protocol in a second frame in accordance with a second protocol;
a transmitter for sending the second frame, in which the first frame is encapsulated by the encapsulation unit, to the second or first node, which is the other end of a communication link, by a communication method in accordance with the second protocol; and
a decapsulation unit for extracting the first frame from the second frame sent from the second or first node which is the other end of the communication link;
wherein the number of frames, that is, the number of multiple first frames to be comprised in one second frame is determined in advance for each storage tier or logical unit defined in the storage apparatus;
wherein the encapsulation unit encapsulates the multiple first frames as many as the number of frames set in advance to the logical unit, which is a write destination or read destination of the data, or the storage tier to which the logical unit belongs, in the second frame; and
wherein the decapsulation unit extracts all the multiple encapsulated first frames from the second frame when the plurality of the first frames are comprised in the received second frame.

2. The computer system according to claim 1, wherein when encapsulating the plurality of first frames in the second frame, the encapsulation unit stores a value, relating the number of first frames comprised in the second frame; and
wherein the decapsulation unit judges, based on the value stored in the received second frame, whether the plurality of first frames are comprised in the second frame or not, and if the plurality of first frames in the second frame, the decapsulation unit extracts the plurality of first frame from the second frame according to the value.

3. The computer system according to claim 1, wherein at least one of the first and second nodes includes a parity calculation unit for setting a specified number of second frames as a frame group, calculating parity for each frame group based on data stored in each of the first frames stored at the same position in each second frame belonging to that frame group, and storing each calculated parity in the first frame;
wherein the encapsulation unit stores each of the multiple first frames, in which the parity is stored, in the second frame; and
wherein the transmitter sends the second frame storing the multiple first frames, in each of which the parity is stored, to the second or first node which is the other end of the communication link.

4. The computer system according to claim 1, wherein when the plurality of first frames are to be stored in the second frame and if the encapsulation unit receives the first frame, which should be encapsulated solely in the second frame, while receiving a first one of the first frames to be stored in the second frame, the encapsulation unit preferentially sends the second frame, in which the first frame to be encapsulated solely in the second frame is encapsulated, to the transmitter; and
when the plurality of first frames are to be stored in the second frame and if the encapsulation unit receives the first frame, which should be encapsulated solely in the second frame, while receiving the first frame other than the first one to be stored in that second frame, the encapsulation unit preferentially sends the second frame, in which the plurality of first frames are stored, to the transmitter.

5. The computer system according to claim 1, wherein the first node is a host system and the second node is the storage apparatus.

6. The computer system according to claim 1, wherein the first node is a host system;
wherein the second node is a first network switch that is connected to the storage apparatus and constitutes the network;
wherein the storage apparatus stores the transfer target data in the first frame and sends it to the second node and
wherein the encapsulation unit of the second node encapsulates the first frame, which is sent from the storage apparatus, in the second frame; and
wherein the second node includes a transfer unit for transferring the first frame, which is extracted from the second frame by the de-encapsulation unit of the second node, to the storage apparatus.

7. The computer system according to claim 6, wherein the second node stores the number of frames that is the number of the multiple first frames to be stored in one second frame and is determined in advance for each storage tier or logical unit defined in the storage apparatus, as first information; and
wherein the encapsulation unit of the second node stores the multiple first frames as many as the number of frames that is set in advance for the logical unit, which is the write destination or read destination of the data, or the storage tier, to which the logical unit belongs, in the second frame based on the stored first information.

8. The computer system according to claim 6, wherein the storage apparatus reports the number of frames, which is the number of multiple first frames, to be stored in the same second frame to the second node; and
wherein the encapsulation unit of the second node stores the multiple first frames as many as the number of frames that is set in advance for the logical unit, which is the write destination or read destination of the data, or the storage tier, to which the logical unit belongs, in the second frame based on the number of frames reported by the storage apparatus.

9. The computer system according to claim 1, wherein the first node is a second network switch that is connected to a host system and constitutes the network;
wherein the second node is a first network switch that is connected to the storage apparatus and constitutes the network;
wherein the host system stores the transfer target data in the first frames and sends the second frame, in which each of the first frames is encapsulated, to the second network switch;
wherein the encapsulation unit of the first node extracts the first frames from each second frame sent from the host system, generates the second frame storing the extracted first frames as many as the number of frames determined in advance for the logical unit, which is the write destination of the transfer target data, and sends it to the transmitter, while the de-encapsulation unit encapsulates again each of the first frames, which is extracted from the second frame sent from the second node by the de-encapsulation unit of the first node, one by one in the second frame; and
wherein the first node includes a transfer unit for transferring the second frame, which is encapsulated again by the de-encapsulation unit, to the host system.

10. A frame transfer bandwidth optimization method for a computer system with first and second nodes connected via a network, for sending and/or receiving data to be read and/or written to a logical unit in a storage apparatus between the first and second nodes,
the frame transfer bandwidth optimization method comprising:
a first step executed at the first or second node encapsulating a first frame, in which transfer target data is stored, in accordance with a first protocol in a second frame in accordance with a second protocol;
a second step executed at the first or second node sending the second frame, in which the first frame is encapsulated, to the second or first node, which is the other end of a communication link, by a communication method in accordance with the second protocol; and
a third step executed at the first or second node extracting the first frame from the second frame sent from the second or first node which is the other end of the communication link;
wherein the number of frames, that is, the number of multiple first frames to be stored in one second frame, is determined in advance for each storage tier or logical unit defined in the storage apparatus;
wherein in the first step, the first or second node stores the multiple first frames as many as the number of frames set in advance to the logical unit, which is a write destination or read destination of the data, or the storage tier to which the logical unit belongs, in the second frame; and
wherein in the third step, the first or second node extracts all the multiple stored first frames from the second frame when the plurality of the first frames are stored in the second frame.
